(19) United States
(12) Patent Application Publication
(10) Pub. No.: US 2025/0364831 A1
(43) Pub. Date: Nov. 27, 2025

(54) ULTRA-LOW POWER ENERGY HARVESTING ELECTRONIC DEVICES WITH ENERGY EFFICIENT BACKUP CIRCUITS

(71) Applicant: Lightricity Limited, Oxford (GB)

(72) Inventors: Julien Pierre Raymond Campos, Oxford (GB); Mathieu Bellanger, Oxford (GB); Nathan James Smith, Oxford (GB); Matthias Kauer, Oxford (GB)

(21) Appl. No.: 18/877,221

(22) PCT Filed: Jun. 21, 2023
(86) PCT No.: PCT/GB2023/051621

§ 371 Date: Dec. 19, 2024

(30) Foreign Application Priority Data
Jul. 5, 2022 (GB) 2209891.7

(51) Int. Cl. H02J 7/35; H02J 3/28; H02J 3/38; H02J 7/00; H02J 7/34

(52) U.S. Cl. CPC H02J 7/35; H02J 3/28; H02J 3/38; H02J 7/0047; H02J 7/00712; H02J 7/345; H02J 2207/20; H02J 2300/24

(57) ABSTRACT

An electrical-energy storage system for storing electrical energy received from an energy harvesting power supply source and for delivery of stored energy to an application load comprises an input N21 for receiving electrical energy from the energy harvesting power supply source. The system comprises a first electrical-energy storage unit having a first storage capacity and a second electrical-energy storage unit having a second storage capacity, greater than the first storage capacity. It comprises an output N22 for providing electrical energy from the second electrical-energy storage unit to the application load. Control circuitry is configured to determine when a first charging condition is met, and, in response to determining that the first charging condition is met, electrically couple the first electrical-energy storage unit to the input N21, with the first electrical-energy storage unit electrically decoupled from the second electrical-energy storage unit, for passing electrical energy from the input N21 into the first electrical-energy storage unit; and determine when a second charging condition is met, and, in response to determining that second charging condition is met, electrically couple the first electrical-energy storage unit to the second electrical-energy storage unit, with the first electrical-energy storage unit electrically decoupled from the input N21, for passing electrical energy from the first electrical-energy storage unit into the second electrical-energy storage unit.

### TECHNICAL FIELD

This disclosure relates to energy harvesting circuit designs with ultra-low power consumption.

### BACKGROUND OF THE INVENTION

Real-time locating systems (RTLS), also known as real-time tracking systems, are used to automatically identify and track the location of objects or people in real time. Unlike global positioning satellite (GPS) systems, RTLS are usually operated within a building or other contained area. Wireless RTLS tags are attached to physical objects or worn by people. In most RTLS, fixed reference points receive wireless “beacon” signals from tags to determine the location of said tag. RTLS reference points may also transmit information to the tag. The reference points are spaced throughout a building (or similar area of interest) to provide the desired tag coverage. Tag location accuracy is a function of many variables. Examples of real-time locating systems include tracking automobiles through an assembly line, locating pallets of merchandise in a warehouse, or finding medical equipment in a hospital.

RTLS designs that have been previously disclosed use a combination of at least one photovoltaic cell (solar cell) and one battery to power the process of the tag. If the battery becomes discharged, then the tag (and hence the asset it is attached to) becomes temporarily lost until the battery can be charged sufficiently to enable the tag to send a beacon signal. The battery may become discharged if the circuit is not optimised and/or the ambient illuminance levels are too low. A larger battery and/or larger photovoltaic cell will enable regular beacon signals to be transmitted from the tag but such a design has increased cost, increased maintenance (even rechargeable batteries require replacement over time) and increased dimensions. An ideal tag design would therefore be small, low cost and can harvest energy from the surroundings in order to provide a beacon signal at regular intervals regardless of the energy harvesting conditions.

Wireless RTLS tags have been disclosed that use sensors that communicate information detected by the sensor to fixed reference points. Such sensor tags communicate both the location of the tag and at least one physically detected attribute (such temperature, humidity, acceleration etc.). If the tag is attached to an immoveable object, then there the tag may not be required to communicate location information.

Patent applications US20180295466A1 discloses apparatus, systems and articles of manufacture to provide low-power, short-range radio frequency wireless beacons and beacon housings. The tag disclosed by US20180295466A1 uses a battery but does not disclose how to harvest energy from the surroundings to power the tag and does not disclose optimised circuit designs for ultra-low power process. Patent application US20100013639A1 discloses a system which provides asset tracking of a mobile asset but does not disclose optimised circuit designs for ultra-low power process. Patent applications US2019/0354824A1, US20180110012A1, US20210073153A1, US20190028089A1, US20110264293A1, US20130020880A1, U.S. Pat. No. 8,264,194B1, U.S. Pat. No. 8,686,681B2, U.S. Ser. No. 10/211,647B2, EP1751727B1, EP3787148A1, US20190265664A1, WO2011083424A1, EP3264785B1 and WO2016187019A1 disclose various tag devices that are used for sensing purposes and/or locating the tag.

### SUMMARY OF THE INVENTION

The present invention seeks to achieve various electronic devices that harvest energy from ambient illumination to power an associated application load. If there is an excess of harvested energy, the excess harvested energy may be stored in an associated energy backup circuit. If there is a deficit of harvested energy, then energy stored in said energy backup circuit may be used to power an associated application load. Electronic devices disclosed herein are configured to optimise power delivery to an associated application load in order to optimise the amount of useful work performed by the harvested energy in the electronic device. Optimising the amount of useful work performed by the energy harvested lowers overall power consumption of the electronic device.

Electronic devices of the present invention may be tag devices or be included within a tag device. The electronic device may communicate information via a wireless transmitter to a network of wireless receivers. The electronic device may communicate information that enables the electronic device's location to be ascertained and/or the electronic device may communicate information related to data acquired by one or more sensors associated with the electronic device. Some aspects of the invention disclose electronic devices that measure the ambient illuminance level and automatically optimise power delivery to the associated application load accordingly. If the electronic device includes a wireless transmitter, optimised power delivery may enable an optimised transmission rate of data by the wireless transmitter (i.e. the electronic device has optimised circuit efficiency). Optimised power delivery to the application load enables optimised circuit efficiency, which in turn results in the application load optimising the amount of useful work performed for the energy harvested by the electronic device.

Aspects of the present invention seek to optimise power delivery to an application load within an electronic device in order to achieve lower overall power consumption than conventional art, thus enabling an electronic device of reduced size and lower cost while maintaining acceptable circuit efficiency. In other words, for the same amount of energy, electronic devices of the present invention seek to perform more useful work and have higher circuit efficiency than electronic devices of conventional art, thus enabling the advantages of lower cost and reduced size.

Aspects of the present invention disclose novel configurations of ultra-low power energy harvesting electronic devices that have an associated energy backup circuit. Some aspects of the present invention augment previously disclosed ultra-low power energy harvesting electronic devices with novel energy backup circuits. The energy backup circuit enables efficient storage of energy when there is an excess of harvested energy (i.e., the amount of energy wasted during the energy storage process is reduced). The energy backup circuit also enables efficient delivery of stored energy to an application load when there is a deficit of harvested energy (i.e., the amount of energy wasted during the energy delivery process is reduced). Consequently, efficient energy storage and efficient energy delivery optimises the amount of useful work that can be performed by an electronic device.

Aspects of the present invention utilise an energy harvesting unit that may be a photovoltaic unit. Aspects of the present invention utilise smaller photovoltaic units than conventional art thus enabling reduced size, lower cost while maintaining acceptable circuit efficiency. Unlike conventional art, some electronic devices pertaining to the present invention do not utilise a battery or rechargeable battery (i.e., only capacitors and/or supercapacitors are used to store energy), thus enabling a further reduction in size and cost while maintaining an acceptable circuit efficiency. The invention is not limited to energy harvesting devices that are photovoltaic units. An energy harvesting unit of the present invention may harvest energy from, but not limited to, light sources (i.e., a photo voltaic unit), electromagnetic sources, thermal sources, wind sources, salinity gradients, kinetic/vibration sources, or any combination thereof.

Aspects of the present invention disclose energy backup circuits that include a first energy storage unit and a second energy storage unit wherein the second energy storage unit has a larger energy storage capacity than the first energy storage unit. Control circuitry associated with the energy backup circuit enables excess electrical energy that has been harvested by an associated electronic device to be stored in the energy backup circuit using a novel 2-stage energy storage process. During the first stage of the energy storage process, excess harvested energy is initially stored in the first energy storage unit while the second energy storage unit is electrically isolated from the first energy storage unit. During the second stage of the energy storage process, an input of the energy backup circuit is electrically isolated from an associated electronic device while the energy in the first energy storage unit is transferred to the second energy storage unit. After the second stage of the energy storage process is completed, the first stage of the energy storage process may be repeated. The circuit conditions that enable the first stage of the energy storage process may be different to the circuit conditions that enable the second stage of the energy storage process. The novel arrangement of electrical components within the energy backup circuit combined with the novel 2-stage energy storage process was found to be particularly energy efficient for energy storage.

Aspects of the present invention disclose control circuitry associated with the energy backup circuit that enables energy stored in the energy backup circuit to be delivered to an associated application load within the electronic device when there is a deficit of harvested energy. The novel arrangement of electrical components within the energy backup circuit was found to be particularly energy efficient for delivering stored energy to an associated application load when there is a deficit of harvested energy.

Aspects of the present invention disclose energy backup circuits that may perform an energy storage process (i.e., a charging process) for a first set of circuit conditions. Aspects of the present invention disclose energy backup circuits that may perform an energy delivery process (i.e., a discharging process) for a second set of circuit conditions. Aspects of the present invention disclose energy backup circuits that may perform a null process for a third set of circuit conditions (i.e., neither a charging process nor a discharging process). The first set of circuit conditions may be different from both the second and third set of circuit conditions. The second set of circuit conditions may be different from the third set of circuit conditions. The null process occurs when neither a charging process nor a discharging process is performed (i.e., energy is neither stored in an energy backup circuit nor delivered to an application load from an energy backup circuit). In general, all example electronic devices disclosed herein have an associated energy backup circuit wherein said associated energy backup circuit may perform a charging process, discharging process and a null process. In general, all example electronic devices discussed herein may have an associated energy storage unit in addition to the energy backup circuit. In general, all example electronic devices discussed herein may be an ultra-low power energy harvesting device with an energy backup circuit.

An aspect of the present invention provides an electrical-energy storage system for storing electrical energy received from an energy harvesting power supply source and for delivery of stored energy to an application load, the electrical-energy storage system comprising:
an input for receiving electrical energy from an energy harvesting power supply source;
a first electrical-energy storage unit having a first storage capacity;
a second electrical-energy storage unit having a second storage capacity, wherein the second storage capacity is greater than the first storage capacity;
an output for providing electrical energy from the second electrical-energy storage unit to an application load; and
control circuitry,
   wherein the control circuitry is configured to:
determine when a first charging condition is met, and, in response to determining that the first charging condition is met, electrically couple the first electrical-energy storage unit to the input, with the first electrical-energy storage unit electrically decoupled from the second electrical-energy storage unit, for passing electrical energy from the input into the first electrical-energy storage unit; and
determine when a second charging condition is met, and, in response to determining that second charging condition is met, electrically couple the first electrical-energy storage unit to the second electrical-energy storage unit, with the first electrical-energy storage unit electrically decoupled from the input, for passing electrical energy from the first electrical-energy storage unit into the second electrical-energy storage unit.

An electrical-energy storage system of the present invention may be configured so that the first charging condition depends at least in part on a first voltage level at a first point within the electrical-energy storage system and/or the energy harvesting power supply source, and wherein the second charging condition depends at least in part on a second voltage level at a second point within the electrical-energy storage system and/or the energy harvesting power supply source, wherein the first and second points may be a common point or different points.

An electrical-energy storage system of the present invention may be configured so that each of the first and second voltage levels is an input voltage from an energy harvesting power supply source and/or is an output voltage of the first electrical-energy storage unit, and/or is a voltage at a respective point between an input from an energy harvesting power supply source and an output of the first electrical-energy storage unit, and/or is an input voltage to the second electrical-energy storage unit, and/or is a voltage at a respective point between an output of the first electrical-energy storage unit and an input to the second electrical-energy storage unit.

An electrical-energy storage system of the present invention may be configured so that the control circuitry comprises a voltage detector for determining the voltage level at the first point and/or the second point.

An electrical-energy storage system of the present invention may be configured so that the first charging condition comprises the first voltage having a value that is less than or equal to a first threshold, and wherein the second charging condition comprises the voltage at the second point having a value that is greater than or equal to a second threshold.

An electrical-energy storage system of the present invention may be configured so that the second threshold is higher than the first threshold.

An electrical-energy storage system of the present invention may include control circuitry configured to start detecting for the first charging condition after electrically coupling the first electrical-energy storage unit to the second electrical-energy storage unit.

An electrical-energy storage system of the present invention may include control circuitry configured to start detecting for the second charging condition after electrically coupling the first electrical-energy storage unit to the input.

An electrical-energy storage system of the present invention may be configured so that an output voltage level of the second electrical-energy storage unit being greater than the first threshold voltage is indicative of a charging of the second electrical-energy storage unit being complete.

An electrical-energy storage system of the present invention may be configured so that the control circuitry comprises one or more switches for performing the electrical coupling and decoupling of the first electrical-energy storage unit to the input and to the second electrical-energy storage unit.

An electrical-energy storage system of the present invention may be configured so that the control circuitry comprises a first switch between the input and first electrical-energy storage unit, and comprises a second switch between the first electrical-energy storage unit and the second electrical-energy storage unit, and wherein the control circuitry is configured so that, at least during a charging state of the electrical-energy storage system, the first switch and the second switch are always in opposite states.

An electrical-energy storage system of the present invention may be configured so that the electrical-energy storage system is switchable between a charging state in which the first switch is in a first state, being either open or closed, and the second switch is in an opposite state to the first switch, and a discharging state in which the first and second switches are both closed or in which the first switch is closed and the second switch is open.

An electrical-energy storage system of the present invention may be configured so that the first electrical-energy storage unit comprises at least one capacitor.

An electrical-energy storage system of the present invention may be configured so that the second electrical-energy storage unit comprises at least one of a capacitor, a supercapacitor, or a rechargeable cell.

An electrical-energy storage system of the present invention may include a DC-to-DC convertor between the first electrical-energy storage unit and the second electrical-energy storage unit.

An electrical-energy storage system of the present invention may include control circuitry configured to electrically decouple the DC-to-DC convertor from at least one of the first and second electrical-energy storage units in response to determining that the first charging condition is met.

An electrical-energy storage system of the present invention may be configured so that the input and the output of the electrical-energy storage system are provided by a shared conductor.

An electrical-energy storage system of the present invention may include an asymmetric conductance unit between an output of second electrical-energy storage unit and the shared conductor.

An electrical-energy storage system of the present invention may include an input isolation switch for decoupling the first electrical-energy storage unit and/or second electrical-energy storage unit from the input, and/or comprising an output isolation switch for decoupling the first electrical-energy storage unit and/or second electrical-energy storage unit from the output, wherein the first and second isolation switches may be a common switch or different switches.

An electrical-energy storage system of the present invention may include a resistor between the second electrical-energy storage unit and the output for controlling a discharge rate of the second electrical-energy storage unit through the output.

An electrical-energy storage system of the present invention may include a current regulator between a switch associated with the electrical-energy storage system and the energy harvesting power supply source wherein the current regulator is configured to control the rate that energy is received from the energy harvesting power supply source and/or configured to control the rate that energy is delivered from electrical-energy storage system to the application load.

An aspect of the present invention provides an electrical supply system configured to supply electrical power to an application load wherein the electrical supply system comprises the electrical-energy storage system and the energy harvesting power supply source.

The electrical supply system of the present invention may be configured so that the energy harvesting power supply source comprises a photovoltaic unit.

The electrical supply system of the present invention may be configured so that the energy supply source further comprises an energy storage unit, a load switch and a voltage detector.

The electrical supply system of the present invention may comprise control circuitry configured to electrically couple and decouple the application load with an output of the energy harvesting power supply source and/or to electrically couple and decouple the application load with the electrical-energy storage system and/or to electrically couple and decouple an output of the energy harvesting power supply source with the electrical-energy storage system, at least partly in dependence upon a voltage at a point within the electrical supply system.

The electrical supply system of the present invention may comprise control circuitry configured to disconnect the application load from the electrical supply system when the voltage at said point reaches or crosses a disconnection threshold from above, the disconnection threshold being indicative of the second electrical-energy storage unit of the electrical-energy storage system reaching a discharged state.

The electrical supply system of the present invention may comprise control circuitry configured to switch the state of an electrical-energy storage system from one of a charging state, a null state and a discharging state to a different one of a charging state, a null state and a discharging state; wherein said state switching is at least partly dependent upon at least one of: a voltage at a point within the electrical supply system; an output of a timer; or an output of a light meter.

An aspect of the present invention provides a method performed by an electrical-energy storage system to store electrical energy received from an energy harvesting power supply source and deliver stored electrical energy to an application load, wherein the electrical-energy storage system comprises an input for receiving energy from an energy harvesting power supply source, a first electrical-energy storage unit having a first storage capacity, a second electrical-energy storage unit having a second storage capacity that is larger than the first storage capacity, and, control circuitry for performing electrical coupling and decoupling processes;
the method comprising:
determining when a first charging condition is met, and, in response to determining that the first charging condition is met, electrically couple the first electrical-energy storage unit to the input, with the first electrical-energy storage unit electrically decoupled from the second electrical-energy storage unit, for passing electrical energy from the input into the first electrical-energy storage unit;
determining when a second charging condition is met, and, in response to determining that second charging condition is met, electrically couple the first electrical-energy storage unit to the second electrical-energy storage unit, with the first electrical-energy storage unit electrically decoupled from the input, for passing electrical energy from the first electrical-energy storage unit into the second electrical-energy storage unit.

The electrical-energy storage system of the present invention may further comprise an output for delivering stored energy to the application load and the method may further comprise:
determining when a discharging condition is met, and, in response to determining that the discharging condition is met, electrically coupling the first electrical-energy storage unit and/or second electrical-energy storage unit to the output for passing electrical energy from the electrical-energy storage system to the application load.

An aspect of the present invention may provide the electrical supply system disclosed herein, wherein the control circuitry is configured to disconnect the application load from an output of the electrical-energy storage system when a voltage at a point in the electrical supply system reaches or crosses a disconnection threshold from below, the disconnection threshold being indicative that the energy harvesting power supply source is generating sufficient power to fully power the application load.

An aspect of the present invention may provide the electrical supply system disclosed herein, wherein the control circuitry is configured to connect the application load to an output of the electrical-energy storage system and/or to disconnect the application load from the energy harvesting power supply source when a voltage at a point in the electrical supply system reaches or crosses a connection threshold from above, the connection threshold being indicative that the energy harvesting power supply source is not generating sufficient power to fully power the application load.

An aspect of the present invention may provide the electrical supply system disclosed herein, wherein the control circuitry is configured to connect the application load to the electrical supply system when a voltage at a point in the electrical supply system reaches or crosses a connection threshold from below, the connection threshold being indicative of a successful boot-up of the application load.

An aspect of the present invention may provide the electrical supply system disclosed herein, wherein the control circuitry is further configured to connect an input of the electrical-energy storage system to the electrical supply system and connect the electrical supply system to the application load, when the output voltage of the energy storage unit reaches or crosses a connection threshold from below.

An aspect of the present invention may provide an electronic device as disclosed herein configured to have a first voltage relationship of V1A≥V2A≥V2B>V1B and a second voltage relationship of V3A>V3B>V1A. The voltages may be within 30% of the following values: V1A=3.0V, V1B=2.5V, V2A=2.95V, V2B=2.8V, V3A=3.3V and V3B=3.15V.

An aspect of the present invention may provide an electronic device as disclosed herein configured to have a first voltage relationship of V1A≥V2A≥V2B>V1B and a second voltage relationship of V3A>V3B>V1A and a third voltage relationship of V2B V4A V4B>V1B. The voltages may be within 30% of the following values: V1A=3.0V, V1B=2.5V, V2A=2.95V, V2B=2.8V, V3A=3.3V, V3B=3.15V, V4A=2.6V and V4B=2.55V.

An aspect of the present invention may provide an electronic device as disclosed herein configured to have a first voltage relationship of V1A≥V2A≥V2B>V1B and a second voltage relationship of V3A>V3B>V1A and a third voltage relationship of V2B V4A V1B V4B. The voltages may be within 30% of the following values: V1A=3.0V, V1B=2.5V, V2A=2.95V, V2B=2.8V, V3A=3.3V, V3B=3.15V, V4A=2.6V and V4B=2.2V.

An aspect of the present invention may provide an electronic device as disclosed herein configured to have a first voltage relationship of V2A V1A V2B>V1B and a second voltage relationship of V1A V3A>V3B>V1B. The voltages may be within 30% of the following values: V1A=2.95V, V1B=1.85V, V2A=2.95V, V2B=2.8V, V3A=2.85V and V3B=2.7V.

An aspect of the present invention may provide an electronic device as disclosed herein configured to have a first voltage relationship of V2A V1A V2B>V1B and a second voltage relationship of V1A≥V3A>V3B>V1B and a third voltage relationship of V3B≥V4A≥V4B>V1B. The voltages may be within 30% of the following values: V1A=2.95V, V1B=1.85V, V2A=2.95V, V2B=2.8V, V3A=2.85V, V3B=2.7V, V4A=2.5V and V4B=2.2V.

An aspect of the present invention may provide an electronic device as disclosed herein configured to have a first voltage relationship of V1A≥V2A≥V2B>V1B and a second voltage relationship of V1A V3A>V3B>V1B. The voltages may be within 30% of the following values: V1A=2.0V, V1B=1.1V, V2A=1.8V, V2B=1.7V, V3A=1.6V and V3B=1.5V.

An aspect of the present invention may provide an electronic device as disclosed herein configured to have a first voltage relationship of V1A≥V2A≥V2B>V1B and a second voltage relationship of V3A>V3B V1A>V1B. The voltages may be within 30% of the following values: V1A=4.0V, V1B=3.0V, V2A=3.8V, V2B=3.65V, V3A=4.35V and V3B=4.2V.

An aspect of the present invention may provide an electronic device as disclosed herein configured to have a first voltage relationship of V1A≥V2A≥V2B>V1B and a second voltage relationship of V3A>V3B V1A>V1B and a third voltage relationship of V2B V V4A V4B>V1B. The voltages may be within 30% of the following values: V1A=4.0V, V1B=3.0V, V2A=3.8V, V2B=3.65V, V3A=4.35V, V3B=4.2V, V4A=3.2V and V4B=3.1V.

An aspect of the present invention may provide an electronic device as disclosed herein configured to have a first voltage relationship of V1A≥V2A≥V2B>V1B and a second voltage relationship of V1A V3A>V3B>V1B. The voltages may be within 30% of the following values: V1A=4.0V, V1B=2.8V, V2A=3.8V, V2B=3.65V, V3A=3.8V and V3B=3.65V.

An aspect of the present invention may provide an electronic device as disclosed herein configured to have a first voltage relationship of V1A≥V2A≥V2B>V1B and a second voltage relationship of V1A V3A>V3B>V1B and a third voltage relationship of V2A V4A V4B>V1B. The voltages may be within 30% of the following values: V1A=4.0V, V1B=2.8V, V2A=3.8V, V2B=3.65V, V3A=3.8V, V3B=3.65, V4A=3.0V and V4B=2.9V.

An aspect of the present invention may provide an electronic device as disclosed herein configured to have a first voltage relationship of V1A≥V2A≥V2B>V1B and a second voltage relationship of V3A V1A V3B>V1B. The voltages may be within 30% of the following values: V1A=3.0V, V1B=2.5V, V2A=2.9V, V2B=2.8V, V3A=3.05V and V3B=2.95V.

An aspect of the present invention may provide an electronic device as disclosed herein configured to have a first voltage relationship of V2A V2B V1A>V1B and a second voltage relationship of V3A>V3B V1A>V1B and a third voltage relationship V2A V3A>V3B>V1B. The voltages may be within 30% of the following values: V1A=2.7V, V1B=2.4V, V2A=2.95V, V2B=2.8V, V3A=2.85V and V3B=2.7V.

### BRIEF DESCRIPTION OF THE DRAWINGS

Certain preferred embodiments of the invention will now be described, by way of example only, with reference to the accompanying drawings, in which:

FIG. 1 is a plot showing the 3 different ambient lux ranges;

FIG. 2A is a block diagram of a first example charging/discharging circuit;

FIG. 2B is a block diagram of a second example charging/discharging circuit;

FIG. 3 is a block diagram of a first example energy backup circuit;

FIG. 4 is a block diagram of a second example energy backup circuit;

FIG. 5 is a block diagram of a first example electronic device;

FIG. 6 is a block diagram of a second example electronic device;

FIG. 7 is a block diagram of a third example electronic device;

FIG. 8A is a flow diagram of a charging process for a first, third, fourth and seventh example energy backup circuit;

FIG. 8B is a flow diagram of a discharging process for a first example energy backup circuit;

FIG. 9A is a flow diagram of a charging process for a second, fifth and sixth example energy backup circuit;

FIG. 9B is a flow diagram of a discharging process for a second example energy backup circuit;

FIG. 10A is a block diagram of a third example energy backup circuit;

FIG. 10B is a block diagram of a fourth example energy backup circuit;

FIG. 10C is a block diagram of a fifth example energy backup circuit;

FIG. 10D is a block diagram of a sixth example energy backup circuit;

FIG. 11A is a fourth example electronic device;

FIG. 11B is a fifth example electronic device;

FIG. 12 is a flow diagram of a discharging process for a third, fourth, fifth and sixth example energy backup circuit;

FIG. 13A is a block diagram of a seventh example energy backup circuit;

FIG. 13B is a block diagram of an eighth example energy backup circuit;

FIG. 14A is a block diagram of a sixth example electronic device;

FIG. 14B is a block diagram of a seventh example electronic device;

FIG. 14C is a block diagram of an eighth example electronic device;

FIG. 15 is a flow diagram of a discharging process for a seventh and eighth example energy backup circuit;

FIG. 16 is a flow diagram of a charging process for an eighth example energy backup circuit;

FIG. 17A is a block diagram of a ninth example energy backup circuit;

FIG. 17B is a block diagram of a tenth example energy backup circuit;

FIG. 17C is a block diagram of an eleventh example energy backup circuit;

FIG. 18A is a truth table for an XNOR logic gate used in the ninth, tenth and eleventh energy backup circuits

FIG. 18B is a truth table for an XNOR logic gate used in the eleventh energy backup circuit

FIG. 19A is a flow diagram of a charging process for a ninth example energy backup circuit;

FIG. 19B is a flow diagram of a discharging process for a ninth example energy backup circuit;

FIG. 20A is a flow diagram of a charging process for a tenth example energy backup circuit;

FIG. 20B is a flow diagram of a discharging process for a tenth example energy backup circuit;

FIG. 21A is a flow diagram of a charging process for an eleventh example energy backup circuit;

FIG. 21B is a flow diagram of a discharging process for an eleventh example energy backup circuit;

FIG. 22A is a table comparing cost and energy efficiency of energy backup circuits;

FIG. 22B is a table comparing cost and energy efficiency of energy backup circuits;

FIG. 22C is a table comparing cost and energy efficiency of energy backup circuits;

FIG. 22D is a table comparing cost and energy efficiency of energy backup circuits;

FIG. 22E is a table comparing cost and energy efficiency of energy backup circuits;

FIG. 23 is a table comparing cost and circuit efficiency of electronic devices;

FIG. 24A is a table showing various relationships of various voltages

FIG. 24B is a table showing various relationships of various voltages

### DETAILED DESRIPTION

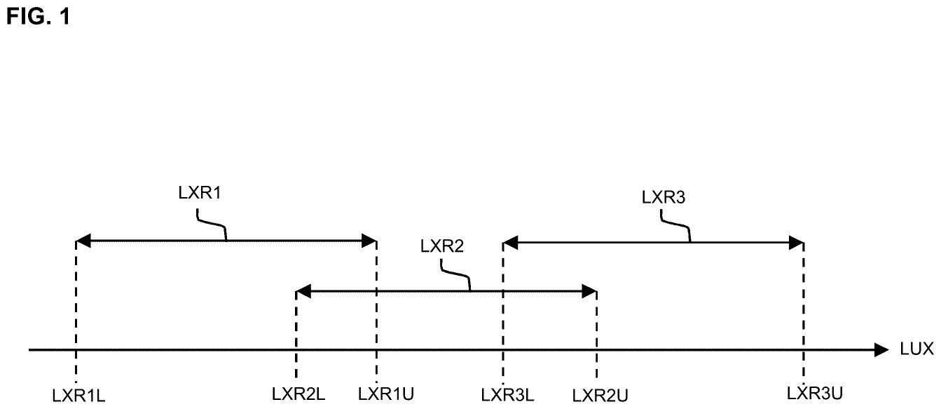

FIG. 1 shows a plot of 3 different ambient lux ranges (i.e., 3 different ambient illumination ranges). LXR1 represents a first range of ambient lux values, with a lower lux value of LXR1L and an upper lux value of LXR1U. LXR2 represents a second range of ambient lux values, with a lower lux value of LXR2L and an upper lux value of LXR2U. LXR3 represents a third range of ambient lux values, with a lower lux value of LXR3L and an upper lux value of LXR3U. The ranges LXR1 and LXR2 may partially overlap. The ranges LXR2 and LXR3 may partially overlap. The ranges of LXR1 and LXR3 do not overlap. The following conditions are also respected: LXR1L<LXR2L<LXR3L and LXR1U<LXR2U<LXR3U. For illustrative discussion purposes herein, LXR1 represents a range of low ambient lux values that may be below ˜200 lux. LXR1 may represent the lux level measured in a corridor, storage room, warehouse, stairwell, elevator etc. For illustrative discussion purposes herein, LXR2 represents a range of medium ambient lux values that may be in the range ˜200 lux to ˜500 lux. LXR2 may represent the lux level measured in a classroom, a conference room, office etc. For illustrative discussion purposes herein, LXR3 represents a range of high ambient lux values that may be above ˜500 lux. LXR3 may represent the lux level measured in a kitchen, laboratory, workshop, supermarket etc. LXR3 may represent the lux level measured in any room designated for medical procedures, such as a surgical theatre etc. The low, medium and high ambient lux ranges may include illumination from man-made light sources (for example, LEDs, fluorescent lights etc.) or from natural light sources (for example, the sun) or any combination thereof.

Various example electronic devices are disclosed herein. The electronic devices comprise an electrical supply system configured to supply electrical power to an application load. The electrical supply system comprises an energy harvesting power supply source and an electrical-energy storage system. The energy harvesting power supply source may comprise an energy harvesting unit that may harvest energy from, but not limited to, light sources (i.e., a photovoltaic unit), electromagnetic sources, thermal sources, wind sources, salinity gradients, kinetic/vibration sources, or any combination thereof. The electrical-energy storage system may be a charging/discharging circuit as described herein or an energy backup circuit as described herein. In general, the application load may be any configuration of component(s) that require electrical power to perform at least one function. The application load may have an activity sequence. Circuit efficiency is a metric that can be used to compare the performance of these electronic devices. For the purposes of this disclosure, circuit efficiency has been defined as being proportional to the average repetition rate of an activity sequence for a given constant level of illumination. An activity sequence is a predetermined routine of useful work that is repeated by the application load. If the activity sequence includes transmitting information to a wireless network, then the average repetition rate of an activity sequence must not exceed the maximum value dictated by standardised protocols. For example, 10 Hz is the maximum repetition rate for a non-connected (i.e. wireless) beacon signal.

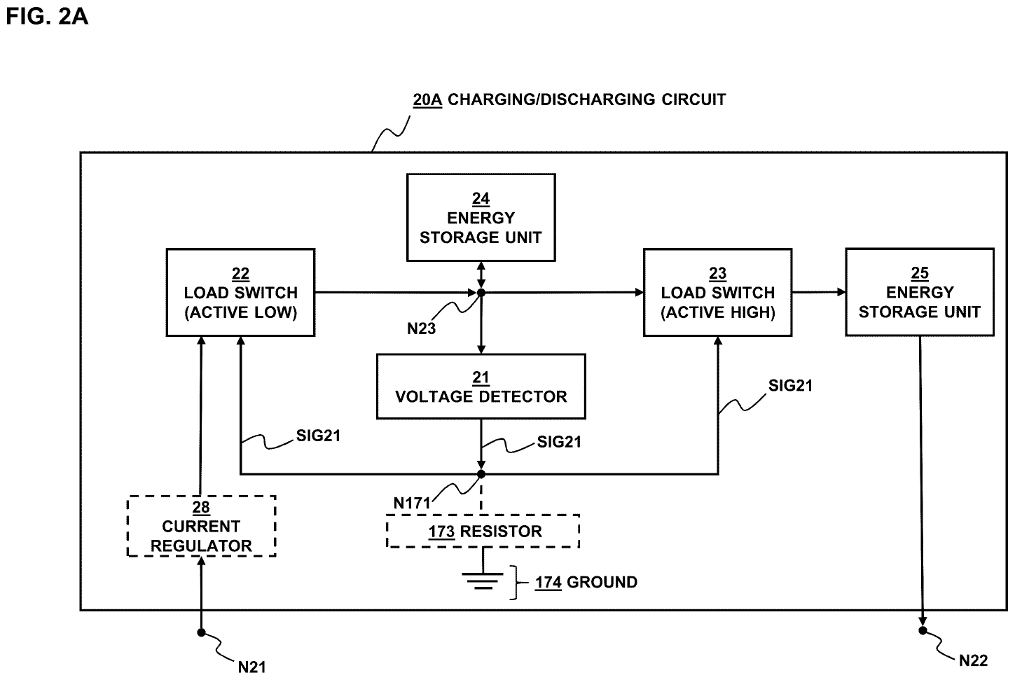

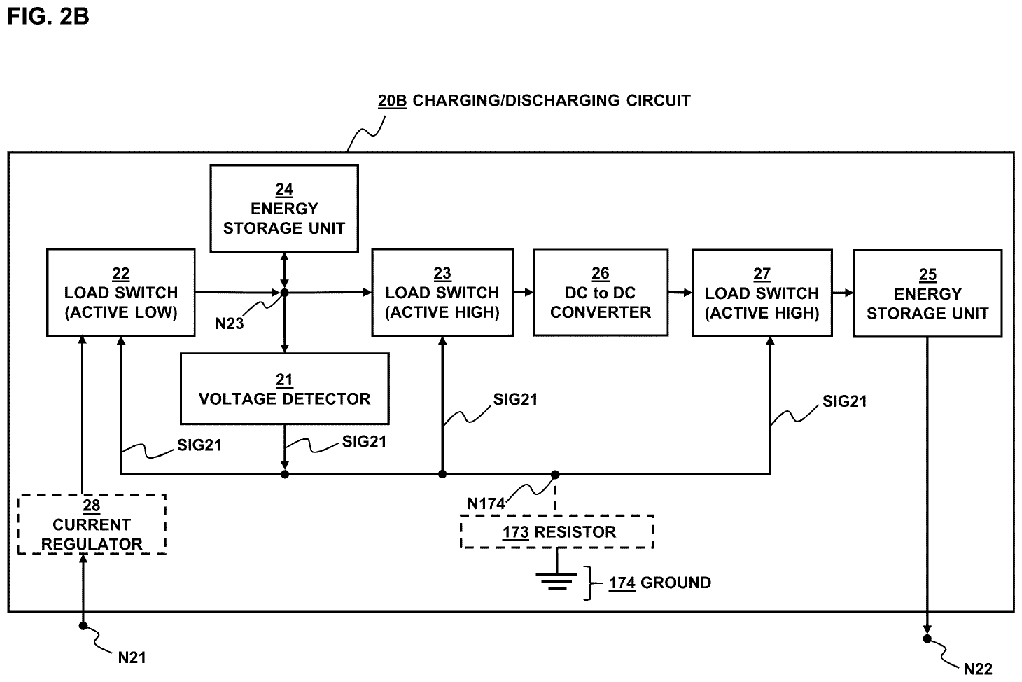

FIG. 2A is a block diagram of a first example charging/discharging circuit 20A that includes voltage detector 21, a load switch 22, a load switch 23, an energy storage unit 24 and an energy storage unit 25. First example charging/discharging circuit 20A may also include current regulator 28. Current regulator 28 is drawn with a dashed line to illustrate that its inclusion is optional. The current regulator 28 may at least partially control the charging rate of the charging/discharging circuit 20A. The charging/discharging circuit 20A may be an electrical-energy storage system. In general, all charging/discharging circuits disclosed herein may be an electrical-energy storage system. For a first set of circuit conditions, charging/discharging circuit 20A may store an excess harvested energy from an associated energy harvesting unit (not shown)—this energy storage process may be known as a charging process. For a second set of circuit conditions, charging/discharging circuit 20A may deliver stored harvested energy to an associated application load (not shown)—this energy delivery process may be known as a discharging process.

All voltage detectors disclosed herein may be known as a “voltage monitor” and/or a “voltage supervisor”. Load switch 22 is coupled to N21 (node 21) either via a direct connection or via current regulator 28. Load switch 22 is connected to N23 (node 23). Load switch 22 is also connected to voltage detector 21 via SIG21. Load switch 23 is connected to N23 (node 23) and energy storage unit 25. Load switch 23 is also connected to voltage detector 21 via SIG21. Energy storage unit 24 is connected to N23. Energy storage unit 25 is connected to load switch 23 and N22 (node 22). N21 and N22 have been drawn outside of the charging/discharging circuit 20A for ease of understanding subsequent circuit augmentations. N21 may be considered an input for the charging/discharging circuit 20A. N22 may be considered an output of the charging/discharging circuit 20A. Voltage detector 21 controls ON and OFF states of both load switch 22 and load switch 23 via SIG21. Load switch 22 is labelled “active low” because load switch 22 is configured to switch ON when it is supplied with a low logic signal via SIG21. Load switch 22 is also configured to switch OFF when it is supplied with a high logic signal via SIG21. Load switch 23 is labelled “active high” because load switch 23 is configured to switch ON when it is supplied with a high logic signal via SIG21. Load switch 23 is also configured to switch OFF when it is supplied with a low logic signal via SIG21. Voltage detector 21 is configured to activate a high logic signal via SIG21 when the voltage measured by voltage detector 21 is greater than or equal to V3A. Once activated, voltage detector 21 is configured to maintain a high logic signal while the voltage measured by voltage detector 21 remains greater than V3B. If the voltage measured by voltage detector 21 becomes less than or equal to V3B, voltage detector 21 is configured to turn back its logic signal to logic low via SIG21. SIG21, load switch 22 and load switch 23 are configured such that when load switch 22 is switched ON by SIG21 then load switch 23 is switched OFF by SIG21. SIG21, load switch 22 and load switch 23 are also configured such that when load switch 22 is switched OFF by SIG21 then load switch 23 is switched ON by SIG21. For all embodiments disclosed herein, during the charging process, if load switch 22 is switched ON then load switch 23 is switched OFF and vice versa. For all embodiments disclosed herein that are associated with charging/discharging circuit 20A and charging/discharging circuit 20B, during the discharging process, if load switch 22 is switched ON then load switch 23 is switched OFF and vice versa. When load switch 22 is switched ON (and load switch 23 is switched OFF) then electrical energy may be transferred from N21 and stored in energy storage unit 24 (i.e., charging/discharging circuit 20A may perform a first part of an energy storage process). When load switch 23 is switched ON (and load switch 22 is switched OFF) then electrical energy may be transferred from energy storage unit 24 to energy storage unit 25 (i.e., charging/discharging circuit 20A may perform a second part of a charging process). When load switch 22 is switched ON (and load switch 23 is switched OFF) then energy may be transferred from energy storage unit 24 to N21 and/or energy storage unit 25 to N22 (i.e., charging/discharging circuit 20A may perform a discharging process). Alternatively, when load switch 23 is switched ON (and load switch 22 is switched OFF) then energy may be transferred from energy storage unit 24 and/or energy storage unit 25 to N22 (i.e., charging/discharging circuit 20A may perform a discharging process).

Energy storage unit 24 may be comprised of at least one of a capacitor, supercapacitor, battery and/or rechargeable battery, or any combination thereof. The term “battery” may refer to a single cell or multiple cells. Preferably, energy storage unit 24 is only comprised of capacitor type energy storage units (i.e., energy storage unit 24 is not comprised of battery type energy storage units) in order to improve the efficiency of energy storage. Energy storage unit 25 may be comprised of at least one a capacitor, supercapacitor, battery and/or rechargeable battery, or any combination thereof. Energy storage unit 24 may have a storage capacity in the range 0.2 μF to 500 μF, or 50 pAh to 150 nAh, and preferably in the range 2 μF to 50 μF, or 500 pAh to 15 nAh. Experiments revealed satisfactory performance was achieved when the energy storage unit 24 was a capacitor with a storage capacity of ˜10 μF. Energy storage unit 25 may have a storage capacity in the range 0.01 F to 1000 F or 2.5 μAh to 1 Ah, and preferably in the range 0.1 F to 1° F. or 25 pAh to 2.5 mAh. Experiments revealed satisfactory performance was achieved when the energy storage unit 24 was a supercapacitor with a storage capacity of ˜1 F. Energy storage unit 25 is always configured to have a larger energy storage capacity than energy storage unit 24.

Energy storage unit 25 may have an energy storage capacity that is at least 10 times larger than energy storage unit 24. Energy storage unit 25 may have an energy storage capacity that is at least 75 times larger than energy storage unit 24. Energy storage unit 25 may have an energy storage capacity that is at least 500 times larger than energy storage unit 24. Experiments revealed it may be desirable for energy storage unit 25 to have an energy storage capacity that is approximately 3 orders of magnitude larger than energy storage unit 24.

In general, energy storage unit 24 may be the first energy storage unit and energy storage unit 25 may be the second energy storage unit. Energy storage unit 25 is larger (i.e., can store more electrical energy) than the energy storage unit 24. Control circuitry (which may include load switches, voltage detectors, logic gates, resistors etc.) associated with an energy backup circuit disclosed herein enable excess electrical energy that has been harvested by an associated electronic device to be stored in said energy backup circuit using a novel 2-stage energy storage process. During the first stage of the energy storage process, excess harvested energy is stored in the energy storage unit 24 (i.e., the first energy storage unit). During the first stage of the energy storage process, the energy storage unit 25 (i.e., the second energy storage unit) is electrically isolated from the energy storage unit 24. During the first stage of the energy storage process, the energy storage unit 25 may also be electrically isolated from an input to an associated energy backup circuit disclosed herein. Therefore, the energy storage unit 25 may also be electrically isolated from an associated energy harvesting unit, such as a photovoltaic unit, during the first stage of the energy storage process. During the second stage of the energy storage process, energy stored in the first energy storage unit is transferred to the second energy storage unit. During the second stage of the energy storage process, an input to an energy backup circuit disclosed herein is electrically isolated from an associated electronic device. Therefore, an energy backup circuit may also be electrically isolated from an associated energy harvesting unit, such as a photovoltaic unit, during the second stage of the energy storage process. After the second stage of the energy storage process is completed, the first stage of the energy storage process may be repeated. In general, many cycles of the novel 2-stage energy storage process may be completed to transition the second energy storage unit from a discharged state to a charged state wherein the charged state has substantially more stored electrical energy than the discharged state. The time required to complete 1 cycle of the novel 2-stage energy storage process may be a function of the amount of excess electrical power generated by an energy harvesting unit associated with an energy backup circuit. The greater the amount of excess electrical power generated by an energy harvesting unit, the shorter the required time to complete 1 cycle of the novel 2-stage energy storage process. The number of cycles of the novel 2-stage energy storage process required to reach said charged state may be a function of the capacity of energy storage unit 24. The larger the capacity of energy storage unit 24, the fewer the number of cycles of the novel 2-stage energy storage process is required to reach said charged state.

The circuit conditions that enable the first stage of the energy storage process may be different to the circuit conditions that enable the second stage of the energy storage process. During both the first and second stages of the energy storage process, the energy storage unit 25 may be electrically isolated from an input to an associated energy backup circuit. Consequently, the energy storage unit 25 may be electrically isolated from an associated energy harvesting unit (e.g., photovoltaic unit 51) during both the first and second stages of the energy storage process. The advantage of electrically isolating energy storage unit 25 from an associated energy harvesting unit (e.g., photovoltaic unit 51) during both the first and second stages of the energy storage process is to prevent a possible reduction in circuit efficiency. If energy storage unit 25 was not electrically isolated from an input to an associated energy backup circuit during both the first and second stages of the energy storage process, then too much power may be diverted away from an associated application load (such as application load 55 disclosed herein) and into the energy storage unit 25. If too much power is diverted to energy storage unit 25 then an associated application load may not have sufficient power to operate, thus circuit efficiency may be reduced. The use of current regulator 28 may also limit the amount of power being diverted away from an application load and into an energy storage unit(s) associated with an energy backup circuit, thus the current regulator 28 may also be used to prevent a reduction in circuit efficiency. Control circuitry (which may include load switches, voltage detectors, logic gates, resistors etc.) associated with an energy backup circuit disclosed herein may be selected so that the cycle frequency of the novel 2-stage energy storage process is sufficiently high in order to prevent a reduction in circuit efficiency.

The energy storage capacity of the energy storage unit 24 is chosen to prevent a possible reduction in circuit efficiency. If the energy storage capacity of energy storage unit 24 is too large, then too much power may be diverted away from an associated application load and into the energy storage unit 24, which may reduce circuit efficiency if said application load does not have sufficient power. In other words, even if there is an excess of harvested energy, if the energy storage capacity of energy storage unit 24 is too large, then circuit efficiency may be reduced because too much energy may be diverted into the energy storage unit 24. If there is a deficit of harvested energy, the energy backup circuit may deliver previously stored energy to an associated application load to prevent a possible reduction in circuit efficiency. However, the energy storage capacity of the energy storage unit 24 is too small to be the only backup energy source for an associated application load when there is a deficit of harvested energy. Consequently, a purpose of energy storage unit 24 is to transfer electrical energy to energy storage unit 25 when there is an excess of harvested energy. The novel arrangement of electrical components within an energy backup circuit disclosed herein combined with the novel 2-stage energy storage process disclosed herein was found to be particularly energy efficient for energy storage when an associated energy harvesting unit, such as a photovoltaic unit, produces an excess of harvested energy. A purpose of energy storage unit 25 is to delivery electrical energy to an associated application load when there is a deficit of harvested energy. The novel arrangement of electrical components within an energy backup circuit disclosed herein was found to be particularly energy efficient for delivery of stored energy to an associated application load when an associated energy harvesting unit, such as a photovoltaic unit, produces a deficit of harvested energy. In general, a first purpose of energy backup circuits disclosed herein is to store excess harvested energy in an energy efficient manner. In general, a second purpose of the energy backup circuits disclosed herein is to deliver, in an energy efficient manner, said stored energy to an associated application load when there is a deficit of harvested energy.

The current regulator 28 may be a resistor or an integrated circuit that limits and/or regulates current. The current regulator 28 may be configured to control the charging rate of an associated energy backup circuit (i.e., the current regulator 28 may control the rate that energy is transferred from an energy harvesting source to an associated energy backup circuit where the energy is then stored). The current regulator 28 may be configured to control the charging rate of an associated energy backup circuit in a manner that is dependent upon the amount power generated by an associated energy harvesting source. The current regulator 28 may be configured so that a specific percentage and/or a maximum percentage of power generated by an energy harvesting source is stored in an associated energy backup circuit. An advantage of the current regulator 28 is to increase the range of ambient illumination conditions that are suitable for charging an associated energy backup circuit. A disadvantage of current regulator 28 is that it may lower the efficiency of the energy storage process because some energy may be lost to non-useful work within current regulator 28. For example, if the current regulator 28 comprises a simple resistor, then Joule heating losses may occur that would lower the efficiency of the energy storage process. If the current regulator 28 comprises an integrated circuit that limits and/or regulates current, Joule heating losses and/or a leakage current may occur that would lower the efficiency of the energy storage process.

First example charging/discharging circuit 20A may also include resistor 173. Resistor 173 is drawn with a dashed line to illustrate that its inclusion is optional. Resistor 173 is connected to node N171 and ground 174. The resistor 173 may have a resistance in the range 10 kΩ to 100 MΩ. Preferably, the resistor 173 may have a resistance in the range 100 kΩ to 10 MΩ. Preferably, the minimum resistance of resistor 173 is 100 kΩ. The advantages of resistor 173 is that it may prevent unstable circuit behaviour, especially during startup and/or bootup phases of operation when the voltage on node N23 is below the minimum operating condition of the voltage detector 21. The disadvantages of resistor 173 is that a small amount of energy may be lost to non-useful work when voltage detector 21 activates a high logic signal via SIG21, thus the inclusion of resistor 173 may slightly lower the circuit efficiency.

FIG. 2B is a block diagram of a second example charging/discharging circuit 20B that includes voltage detector 21, a load switch 22, a load switch 23, an energy storage unit 24, energy storage unit 25, DC to DC converter 26 and load switch 27. Second example charging/discharging circuit 20B may also include current regulator 28. Current regulator 28 is drawn with a dashed line to illustrate that its inclusion is optional. Second example charging/discharging circuit 20B may also include resistor 173. Resistor 173 is drawn with a dashed line to illustrate that its inclusion is optional. Resistor 173 is connected to node N171 and ground 174. The resistor 173 may have a resistance in the range 10 KΩ to 100 MΩ. Preferably, the resistor 173 may have a resistance in the range 100 kΩ to 10 MΩ. Preferably, the minimum resistance of resistor 173 is 100 kΩ. The advantages of resistor 173 is that it may prevent unstable circuit behaviour, especially during startup and/or bootup phases of operation when the voltage on node N23 is below the minimum operating condition of the voltage detector 21. The disadvantages of resistor 173 is that a small amount of energy may be lost to non-useful work when voltage detector 21 activates a high logic signal via SIG21, thus the inclusion of resistor 173 may slightly lower the circuit efficiency.

The charging/discharging circuit 20B may be an electrical-energy storage system. For a first set of circuit conditions, charging/discharging circuit 20B may store an excess harvested energy from an associated energy harvesting unit (not shown)—this energy storage process may be known as a charging process. For a second set of circuit conditions, charging/discharging circuit 20B may deliver stored harvested energy to an associated application load (not shown)—this energy delivery process may be known as a discharging process.

Charging/discharging circuit 20B may be similar to charging/discharging circuit 20A except that the DC to DC converter 26 and the load switch 27 have been inserted between the load switch 23 and the energy storage unit 25. An output of the load switch 23 is connected to an input of the DC to DC converter 26. An output of the DC to DC converter is connected to an input of the load switch 27. An output of the load switch 27 is connected to an input of the energy storage unit 25. The load switch 27 is also connected to SIG21. Load switch 27 is configured switch ON via SIG21 when load switch 23 is switched ON. Load switch 27 is configured switch OFF via SIG21 when load switch 23 is switched OFF. The DC-DC converter 26 may be a step-down converter. The output voltage of the DC to DC converter may be configured to be less than V3A. The output voltage of the DC to DC converter may be configured to be more than or equal to V3B. V3A may be in the range 2V to 5V. V3B may have a value between 0.5V and 0.02V below the value of V3A. Experiments revealed satisfactory results were obtained when V3A=3.3V and V3B=3.15V. Experiments also revealed satisfactory results were obtained when V3A=3.6V and V3B=3.5V.

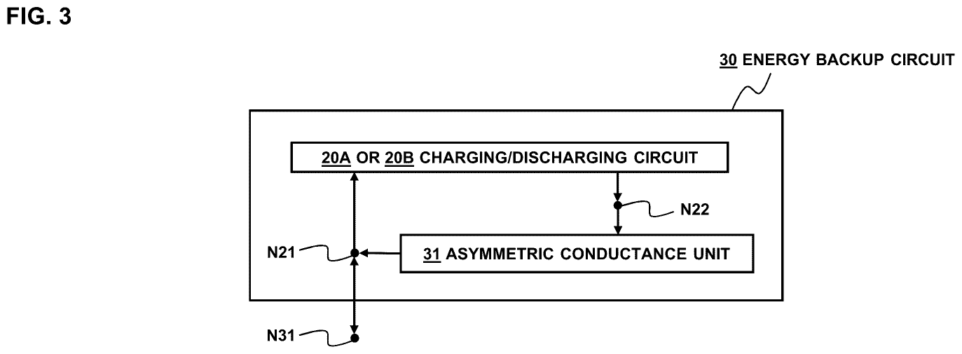

FIG. 3 is a block diagram of a first example energy backup circuit 30 that includes a charging/discharging circuit and an asymmetric conductance unit 31. Said charging/discharging circuit may be the first example charging/discharging circuit 20A or the second example charging/discharging circuit 20B. The energy backup circuit 30 may be an electrical-energy storage system. In general, all energy backup circuits disclosed herein may be an electrical-energy storage system. As previously shown, charging/discharging circuit 20A, 20B is connected to N21 and N22. Asymmetric conductance unit 31 is also connected to N21 and N22. N21 is connected to N31. Although N21 and N31 are electrically equivalent in FIG. 3, these nodes have been drawn in this particular manner for ease of understanding further circuit augmentations. N31 may be an input to the energy backup circuit 30 for a charging process. N31 may be an output of the energy backup circuit 30 for a discharging process. When a first set of circuit conditions are satisfied, electrical energy may be transferred from N31 into the energy backup circuit 30. When a second set of circuit conditions are satisfied, electrical energy may be transferred from the energy backup circuit 30 to N31. N22 is an input to the asymmetric conductance unit 31 and N21 is an output of the asymmetric conductance unit 31. When the voltage at N22 is less than the voltage at N21, the asymmetric conductance unit 31 does not conduct electricity so that no electrical energy can be transferred from N22 to N21. The asymmetric conductance unit 31 may conduct electricity so that electrical energy may be transferred from N22 to N31 via N21 when the voltage measured at N22 plus a threshold voltage 5 is greater than or equal to the voltage at N21. In other words, asymmetric conductance unit 31 may conduct electricity so that electrical energy may be transferred from N22 to N31 via N21 when V(N22)+δ≥V(N21). If the asymmetric conductance unit 31 comprises a diode, the threshold voltage, δ, may be equal to the threshold voltage of said diode. The threshold voltage of a diode may also be known as the “forward voltage” of the diode and may be the voltage that is dropped across a diode.

The asymmetric conductance unit 31 may be a diode. The asymmetric conductance unit 31 may be a silicon diode. The asymmetric conductance unit 31 may be a Schottky diode. The asymmetric conductance unit 31 may be an ideal diode (i.e., an integrated circuit). A silicon diode has the advantage of a relatively small reverse current but the disadvantage of a relatively large voltage drop (i.e., a relatively large value for δ) for a forward current. An ideal diode has the advantage of a relatively small voltage drop (i.e., a relatively small value for δ) for a forward current but the disadvantage of drawing a current (˜100 nA) to ensure correct operation. A Schottky diode has larger reverse current than a silicon diode but a smaller voltage drop than a silicon diode (i.e., the δ value for a Schottky diode is less than the δ value of a silicon diode). A Schottky diode may have the best compromise of features regarding reverse current, forward current voltage drop and power consumption which may render the Schottky diode most suitable for use as the asymmetric conductance unit 31.

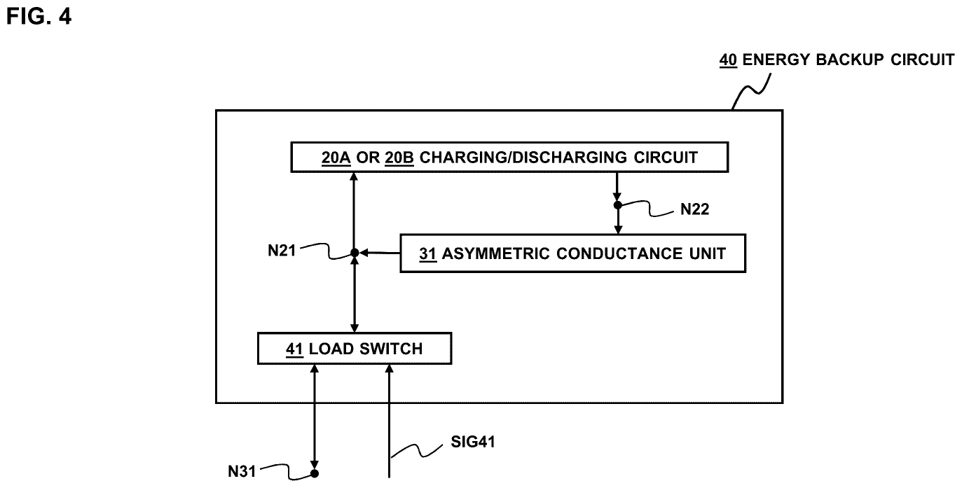

FIG. 4 is a block diagram of a second example energy backup circuit 40 that includes a charging/discharging circuit, an asymmetric conductance unit 31 and a load switch 41. Said charging/discharging circuit may be the first example charging/discharging circuit 20A or the second example charging/discharging circuit 20B. The energy backup circuit 40 may be an electrical-energy storage system. As previously stated, charging/discharging circuit 20A, 20B is connected to N21 and N22. Asymmetric conductance unit 31 is also connected to N21 and N22. N31, N21 and SIG41 are connected to the load switch 41. The load switch 41 is switched ON and OFF via the input SIG41. N31 may be an input to the energy backup circuit 40 and/or N31 may be an output of energy backup circuit 40. When a first set of circuit conditions are satisfied, electrical energy may be transferred from N31 into the energy backup circuit 40. When a second set of circuit conditions are satisfied, electrical energy may be transferred from the energy backup circuit 40 to N31. Load switch 41 may at least partially control a charging process, a discharging process and a null process of energy backup circuit 40. N22 is an input to the asymmetric conductance unit 31 and N21 is an output of the asymmetric conductance unit 31. When the voltage at N22 is less than the voltage at N21, the asymmetric conductance unit 31 does not conduct electricity, therefore electrical energy is not transferred between N22 to N21. As previously stated, when V(N22)+δ≥V(N21), the asymmetric conductance unit 31 may conduct electricity so that electrical energy may be transferred from N22 to N31 via N21. The quantity δ is a positive value corresponding to the voltage drop across the asymmetric conductance unit 31. The asymmetric conductance unit 31 may be a diode. The asymmetric conductance unit 31 may be a Schottky diode. The asymmetric conductance unit 31 may be an ideal diode (Integrated Circuit). When a third set of circuit conditions are satisfied, load switch 41 may be switched OFF so that the energy backup circuit 40 is electrically isolated (i.e., decoupled) from N31. In other words, when load switch 41 is switched OFF, energy backup circuit 40 can neither store electrical energy that is generated by a component(s) within an associated electronic device nor deliver electrical energy to a component(s) within associated electronic device.

An advantage of energy backup circuit 30 over example energy backup circuit 40 is the reduced number of components which may enable lower cost and reduced dimensions. An advantage of energy backup circuit 40 over example energy backup circuit 30 is that for a third set of circuit conditions, more useful work may be performed by an application load associated with energy backup circuit 40 than said application load associated with energy backup circuit 30. This advantage of energy backup circuit 40 over example energy backup circuit 30 occurs because load switch 41 can electrically isolate energy backup circuit 40 from both an associated energy harvesting unit (not shown) and an associated application load (not shown) when a third set of circuit conditions occur that cause a null process (i.e., neither a charging process nor a discharging process). The null process may occur when the energy harvested by an electronic device disclosed herein is the same as, or approximately the same as, the energy required to power all loads associated with said electronic device. The null process may occur when an energy backup circuit is electrically isolated (i.e., decoupled) from other components within an associated electronic device. In general, energy backup circuits disclosed herein that can be electrically isolated from both an associated energy harvesting unit and an associated application load when a third set of circuit conditions occur may enable more useful work to be performed by said application load.

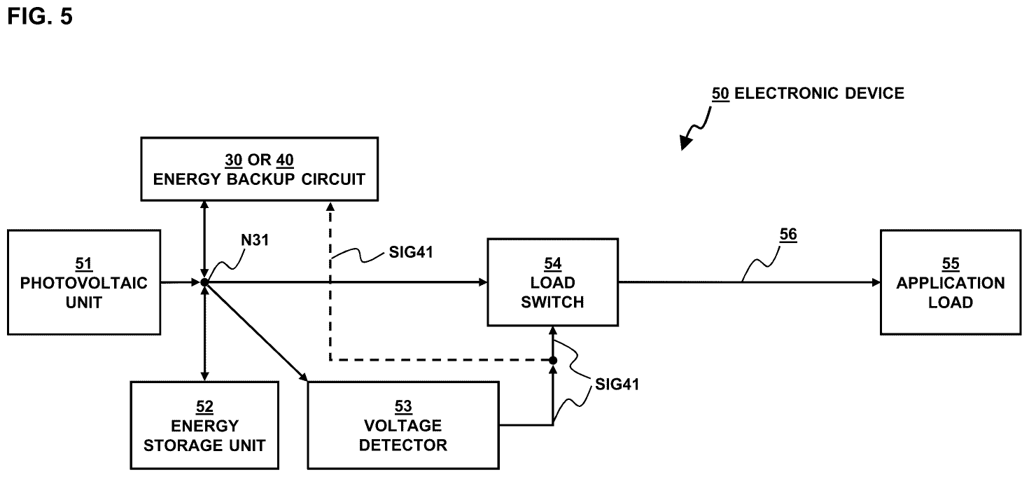

FIG. 5 is a block diagram of a first example electronic device 50 that may be an ultra-low power energy harvesting device. The first example electronic device 50 includes photovoltaic unit 51 (i.e., an energy harvesting unit), an energy storage unit 52, a voltage detector 53, a load switch 54, an application load 55 and an energy backup circuit. The energy backup circuit may be the first example energy backup circuit 30 or the second example energy backup circuit 40. The energy backup circuit 30, 40 is connected to N31 (node 31), however, only energy backup circuit 40 is connected to SIG41 (signal 41) so this connection is shown with a dashed line. N31 (node 31) is a common point. In general, all nodes are connection points shared between at least 2 connections. The voltage detector 53 is connected to N31 and detects the voltage at N31. The voltage detector 53 is also connected to the load switch 54 via SIG41 (signal 41). The voltage detector 53 is configured to turn ON the load switch 54 for voltages greater than or equal to a first voltage V1A. The voltage detector 53 is further configured to turn OFF the load switch 54 for voltages less than or equal to a second voltage V1B wherein the first voltage V1A is greater than the second voltage V1B (i.e., V1A>V1B). The predetermined voltage V1A may be in the range from VMP±20% and preferably in the range from VMP±10% where VMP is the voltage at maximum power point of the photovoltaic unit 21. Power line 56 provides power to all units included within the application load 55. The application load 55 may use power provided by power line 56 to power any units (such as sensors etc.) that are associated with the application load 55. In general, and for a given set of circuit conditions, power line 56 provides power to all units that are within the application load 55 or are connected to the application load 55. The photovoltaic unit 51 is connected to N31. The energy storage unit 52 is connected to N31. The load switch 54 is connected to N31, the application load 55 and SIG41. The load switch 54 is switched ON and OFF via the input SIG41. The photovoltaic unit 51, the energy storage unit 52, the voltage detector 53 and the energy backup circuit 30, 40 are coupled to an input of the load switch 54. In general, an output of the load switch 54 is coupled to the application load 55 via power line 56.

The photovoltaic unit 51 may include at least one photovoltaic cell. The photovoltaic unit 51 may be of general construction but is preferably optimised for optical spectra produced by indoor illuminance conditions if the electronic device is primarily situated indoors. The photovoltaic unit 51 may produce a maximum power of 10 μW at 200 lux. The photovoltaic unit 51 may produce a maximum power of 5 μW at 200 lux. The photovoltaic unit 51 may produce a maximum power of 2 μW at 200 lux.

Voltage detectors disclosed herein may have a hysteresis of less than 600 mV. Voltage detectors disclosed herein less than 400 mV. Voltage detectors disclosed herein may have a hysteresis of less than 200 mV. Load switches disclosed herein may be integrated load switches.

The photovoltaic unit 51 harvests energy from the ambient illumination and may store this energy in at least one of the energy storage units 24, 25 and 52. Energy storage unit 52 does not have a predetermined voltage threshold for activation, therefore energy may be stored in energy storage unit 52 for all non-zero voltages at N31 or N141 (N141 is shown in subsequent embodiments). The electrical components within all energy backup circuits disclosed herein are arranged so that the energy storage unit 24 and energy storage unit 25 have a predetermined voltage threshold for activation. Therefore, energy may only be stored in the energy backup circuits disclosed herein when a specified voltage (for example, the voltage at N31 or N131; N131 is shown in subsequent embodiments) is equal to or greater than the activation threshold; said activation threshold may be equal to V3A. V3A may be in the range 2V to 5V. V3B may have a value between 0.5V and 0.02V below the value of V3A. Experiments revealed satisfactory results were obtained when V3A=3.3V and V3B=3.15V. Experiments also revealed satisfactory results were obtained when V3A=3.6V and V3B=3.5V. Consequently, energy storage unit 52 may begin storing energy before energy is stored in an energy backup circuit as disclosed herein. It may be preferable that the amount of energy that can be stored in any one of the energy backup circuits disclosed herein is greater than the amount of energy that can be stored in the energy storage unit 52. A purpose of energy storage unit 52 may be to optimise power delivery to an associated application load and improve circuit efficiency for relatively short timescales when there is a deficit of harvested energy. A purpose of all energy backup circuits disclosed herein may be to optimise power delivery to an associated application load and improve circuit efficiency for relatively long timescales when there is a deficit of harvested energy. Consequently, example electronic devices with an associated energy backup circuit disclosed herein are more robust to relatively large variations in ambient illumination than similar electronic devices that do not have an associated energy backup circuit.

An energy harvesting power supply source (previously disclosed in the literature) is similar to electronic device 50 but does not have an associated energy backup circuit as disclosed herein. In general, an energy harvesting power supply source includes an energy harvesting unit, such as a photovoltaic unit (for example, photovoltaic unit 51). In general, an energy harvesting power supply source may also include power management circuitry. Said power management circuitry may include at least one of, but not limited to: an energy storage unit (for example, energy storage unit 52), a load switch (for example, load switch 54 or load switch 142) and a voltage detector (for example, voltage detector 53 or voltage detector 141).

The following discussion is to further highlight the advantage of an example electronic device with an associated energy backup circuit as disclosed herein over a similar electronic device that does not have an associated energy backup circuit as disclosed herein. The following discussion is for illustrative purposes only. Let us assume that satisfactory power delivery and satisfactory circuit efficiency are achieved for an electronic device when the ambient illumination level is within the medium lux range of LXR2. In other words, an example electronic device has neither an energy deficit nor an energy surplus in the medium lux range of LXR2. Let us assume said example electronic device has an energy surplus when the ambient illumination level is within the high lux range of LXR3 and an energy deficit when the ambient illumination level is within the low lux range of LXR1. An example electronic device with an associated energy backup circuit is able to store more energy than a similar electronic device without an associated energy backup circuit when the ambient illumination level is within the high lux range of LXR3. Assuming the electronic device with the associated energy backup circuit has at least some energy stored in the associated energy backup circuit, then for a given ambient illumination level within the low lux range of LXR1, an example electronic device with an associated energy backup circuit is able to provide satisfactory power delivery and satisfactory circuit efficiency for a longer period of time than a similar electronic device without an associated energy backup circuit. An example electronic device with an associated energy backup circuit as disclosed herein is therefore more robust to relatively large variations in ambient illumination than a similar electronic device that does not have an associated energy backup circuit.

The energy storage units 24, 25 and 52 may include at least 1 battery and/or 1 rechargeable battery and/or at least 1 capacitor and/or at least 1 super capacitor. For the electronic device to have lower power consumption, reduced size and lower cost, it may be preferable that at least one of the energy storage units 24, 25 and 52 is comprised solely of capacitors. For the electronic device to have even lower power consumption, further reduced size and even lower cost, it may be preferable that all the energy storage units 24, 25 and 52 are comprised solely of capacitors. Energy storage unit 52 may have a storage capacity in the range 10 μF to 1000 μF and preferably in the range 50 μF to 200 μF. Experiments revealed satisfactory performance was achieved when the energy storage unit 52 had a storage capacity of ˜100 μF.

Energy storage unit 25 may store more electrical energy than energy storage unit 24 (i.e., energy storage unit 25 may be larger than energy storage unit 24). Energy storage unit 25 may store more electrical energy than energy storage unit 52 (i.e., energy storage unit 25 may be larger than energy storage unit 52). Energy storage unit 52 may store more electrical energy than energy storage unit 24 (i.e., energy storage unit 52 may be larger than energy storage unit 24). Investigations revealed that preferred circuit performance may be achieved when the following inequality for energy storage capacity is obeyed: energy storage unit 25>energy storage unit 52>energy storage unit 24. If at least one of the energy storage units 24, 25 and/or 52 include at least 1 battery and/or 1 rechargeable battery then the size of the battery may be in the range 50 μAh to 1 Ah and preferably in the range 0.1 mAh to 10 mAh.

Energy storage unit 52 may have an energy storage capacity that is at least 2 times larger than energy storage unit 24. Energy storage unit 52 may have an energy storage capacity that is at least 4 times larger than energy storage unit 24. Energy storage unit 52 may have an energy storage capacity that is at least 8 times larger than energy storage unit 24. Experiments revealed it may be desirable for energy storage unit 52 to have an energy storage capacity that is approximately 1 order of magnitude larger than energy storage unit 24.

The application load 55 may include at least one control unit. The control unit may include at least one field-programmable gate array (FPGA) and/or at least one microcontroller and/or at least one logic unit. The application load 55 may include a wireless communication unit (not shown) which may be a Bluetooth Low Energy (BLE) wireless communication unit or an Ultra Wide Band (UWB) wireless communication unit or a Zigbee wireless communication unit. The application load 55 may be associated with at least 1 sensor. The application load 55 may be associated with at least one sensor that is within the application load 55 (i.e., an internal sensor that is not shown in FIG. 5 and some similar figures) and/or the application load 55 may be associated with at least one sensor that is located outside of the application load 55 but is connected to the application load 55 (i.e., an external sensor that is not shown in FIG. 5 and some similar figures). All sensors associated with the application load (i.e. internal sensors and external sensors) may collect data related to at least one of the following items: orientation, acceleration, temperature, humidity, air pressure, light (illuminance, lux), magnetic field, sound, infra-red radiation, ultra-violet radiation, gas (such as CO, CO2, methane etc.), proximity, images (i.e. a camera). The application load 55 may provide power to at least one associated sensor. When power is provided to the application load 55, the application load 55 performs a complete boot-up sequence followed by at least one complete activity sequence. If the application load 55 does not have an associated sensor, then the maximum current drawn by the application load 55 during the boot-up sequence may be less than 50 mA and is preferably less than 1 mA. If the application load 55 does not have an associated sensor, then the maximum energy consumed by the application load 55 in order to complete the boot-up sequence may be less than 100 μJ and is preferably less than 10 μJ. If the application load 55 does not have an associated sensor, then the maximum current drawn by the application load 55 during the activity sequence may be less than 50 mA and is preferably less than 1 mA. If the application load 55 does not have an associated sensor, then the maximum energy consumed by the application load 55 in order to complete a single activity sequence may be less than 50 μJ and is preferably less than 20 μJ. An activity sequence may include sending a signal via a wireless transmitter associated with the application load to a remote wireless receiver (not shown).

In general, all energy backup circuits disclosed herein may perform a charging process (i.e., an energy storage process) for a first set of circuit conditions or a discharging process (i.e., energy delivery process) for a second set of circuit conditions or a null process for a third set of circuit conditions. The first set of circuit conditions may be different from both the second and third set of circuit conditions. The second set of circuit conditions may be different from the third set of circuit conditions. The null process may occur when neither a charging process nor a discharging process is performed. In general, all example electronic devices disclosed herein have an associated energy backup circuit wherein said associated energy backup circuit may perform a charging process and a discharging process. In general, all example electronic devices discussed herein may have an associated energy storage unit in addition to the energy backup circuit. In general, all example electronic devices discussed herein may be an ultra-low power energy harvesting device with an energy backup circuit.

The charging process enables energy storage in a manner that minimises energy loss (i.e., efficient energy storage) when there is an excess of harvested energy. An excess of harvested energy may occur when the power generated by the photovoltaic unit 51 of an example electronic device disclosed herein is greater than the power consumed by all loads associated with said example electronic device. In other words, when an example electronic device as described herein generates more power than it consumes at a given moment in time, the excess energy may be efficiently stored in the energy backup circuit associated with said example electronic device. During the charging process, excess energy generated by photovoltaic unit 51 may be stored in the energy storage unit 24 and/or energy storage unit 25. Energy storage unit 24 and energy storage unit 25 are associated with an example energy backup circuit described herein. During a first part of a charging process, excess energy generated by photovoltaic unit 51 is stored in the energy storage unit 24. During a second part of a charging process, energy is transferred from the energy storage unit 24 to the energy storage unit 25.

The discharging process enables efficient delivery of stored energy to loads within an example electronic device disclosed herein when there is a deficit of harvested energy. A deficit of harvested energy may occur when the power generated by the photovoltaic unit 51 of an example electronic device as disclosed herein is less than the power consumed by all loads associated with said example electronic device. In other words, when an example electronic device disclosed herein generates less power than it consumes at a given moment in time, the energy deficit may be efficiently satisfied by an energy backup circuit disclosed herein, thus enabling the correct operation of all loads associated with said example electronic device. During the discharging process, energy stored in the energy storage unit 24 and/or energy storage unit 25 is delivered to loads associated an example electronic device disclosed herein. Energy storage unit 24 and energy storage unit 25 are associated with an example energy backup circuit described herein.

In general, all energy backup circuits disclosed herein may prevent premature termination of an activity sequence when there is a deficit of harvested energy. Therefore, energy backup circuits disclosed herein may improve circuit efficiency by preventing the premature termination of an activity sequence.

In the long term, all energy backup circuits disclosed herein may reduce the number of boot-up sequences performed by an associated application load. Reducing the number of boot-up sequences performed by an associated application load enables more useful work to be performed by the harvested energy. Therefore, energy backup circuits disclosed herein may improve circuit efficiency by reducing the number of boot-up sequences performed in the long term.

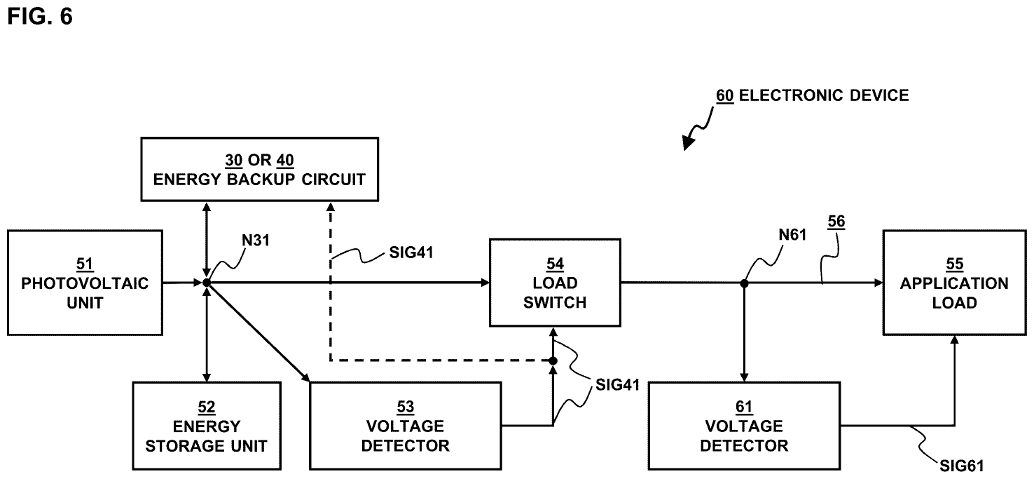

FIG. 6 is a block diagram of a second example electronic device 60 that may be an ultra-low power energy harvesting device. The second example electronic device 60 may be similar to the first example electronic device 50 except that the second example electronic device 60 has a further voltage detector 61. Voltage detector 61 is connected to N61 (node 61) and detects the voltage at N61. Voltage detector 61 is also connected to the application load 55 via SIG61 (signal 61). The second voltage detector 61 is configured to activate (i.e. perform) at least one activity sequence (SIG61=ACTIVE) for voltages greater than or equal to a third voltage V2A. In general, for example electronic devices disclosed herein, whenever an activity sequence is “activated”, the electronic device has been configured to have enough energy to perform an activity sequence to completion. In other words, whenever an activity sequence is “activated”, the electronic device has been configured to perform a positive integer number of activity sequences. Completing a positive integer number of activity sequences contributes to the optimisation of useful work performed by the harvested energy. The second voltage detector 61 is configured to deactivate the activity sequence for voltages not greater than a fourth voltage V2B. The third voltage V2A may be greater than the fourth voltage V2B. In general, for example electronic devices disclosed herein, when the activity sequence is “deactivated”, a further activity sequence is not performed until a sufficient quantity of energy has subsequently been harvested. In general, for example electronic devices disclosed herein, “deactivating” an activity sequence does not prevent the completion of an activity sequence that has already started. Configuring example electronic devices disclosed herein to complete all started activity sequences may contribute to the optimisation of useful work performed by the harvested energy. In other words, completing a positive integer number of activity sequences may contribute to the optimisation of useful work performed by the harvested energy. Energy backup circuits 30, 40 may prevent an activity sequence deactivating when there is a deficit of harvested energy and therefore prevent a possible reduction of circuit efficiency. In general, all energy backup circuits disclosed herein may prevent an activity sequence deactivating when there is a deficit of harvested energy and therefore prevent a possible reduction of circuit efficiency. For electronic device 60 and all other electronic devices disclosed herein, the following general design rules were found to contribute to optimising both power delivery and circuit efficiency: V1A>V1B, V2A>V1B, V2B>V1B and V2A≥V2B.

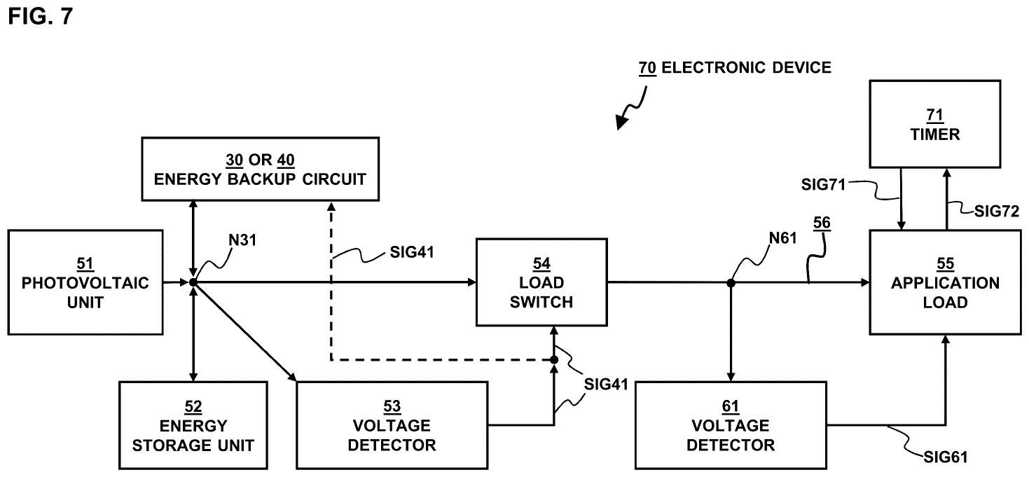

FIG. 7 is a block diagram of a third example electronic device 70 that may be an ultra-low power energy harvesting device. The third example electronic device 70 may be similar to the second example electronic device 60 except that the third example electronic device 70 has an associated timer 71. The timer 71 and the application load 55 are connected by SIG71 (signal 71) and SIG72 (signal 72). FIG. 7 shows the timer 71 external to the application load 55. If the timer 71 is external to the application load 55, the application load 55 may provide power to the timer 71 via SIG71 and/or SIG72. Alternatively, the timer 71 may be an internal peripheral, for example, a Real Time Clock (RTC) timer, that is an integral part of the control unit which in turn is part of the application load 55. In general, the timer may be associated with the application load. The application load 55 is configured to send a signal (SIG72) to the timer 71 in order to start or restart a countdown sequence on the timer 71 during the boot-up sequence. The application load 55 is also configured to send a signal (SIG72) to the timer 71 in order to start or restart the countdown sequence on the timer 71 during the activity sequence. The duration of the countdown time may be predetermined and may be 60s and preferably 30s. If the countdown on the timer 71 finishes, the timer 71 is configured to send a signal (SIG71) to the application load 55 in order to activate (i.e., perform) at least one activity sequence.

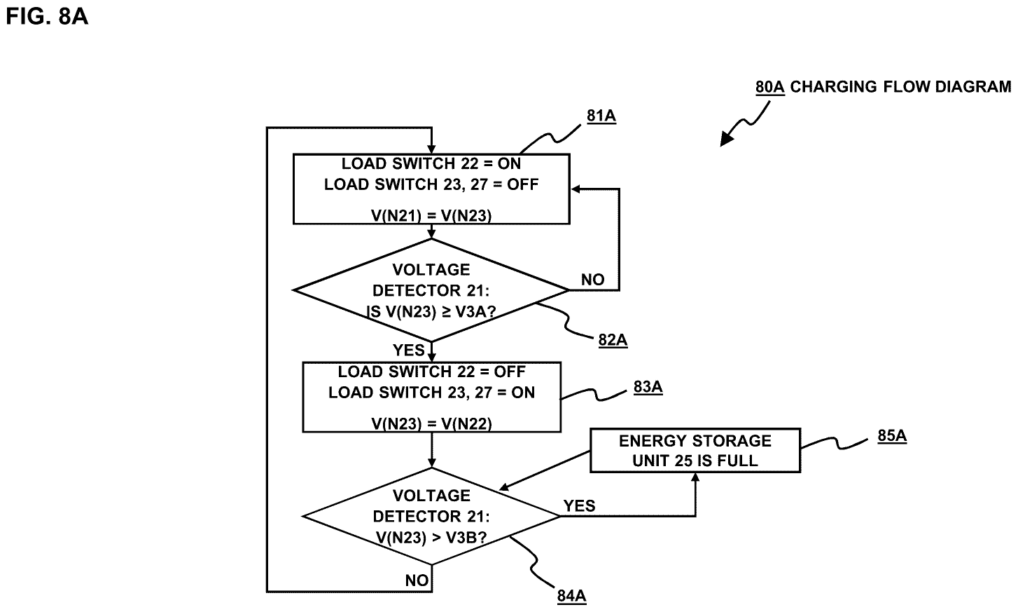

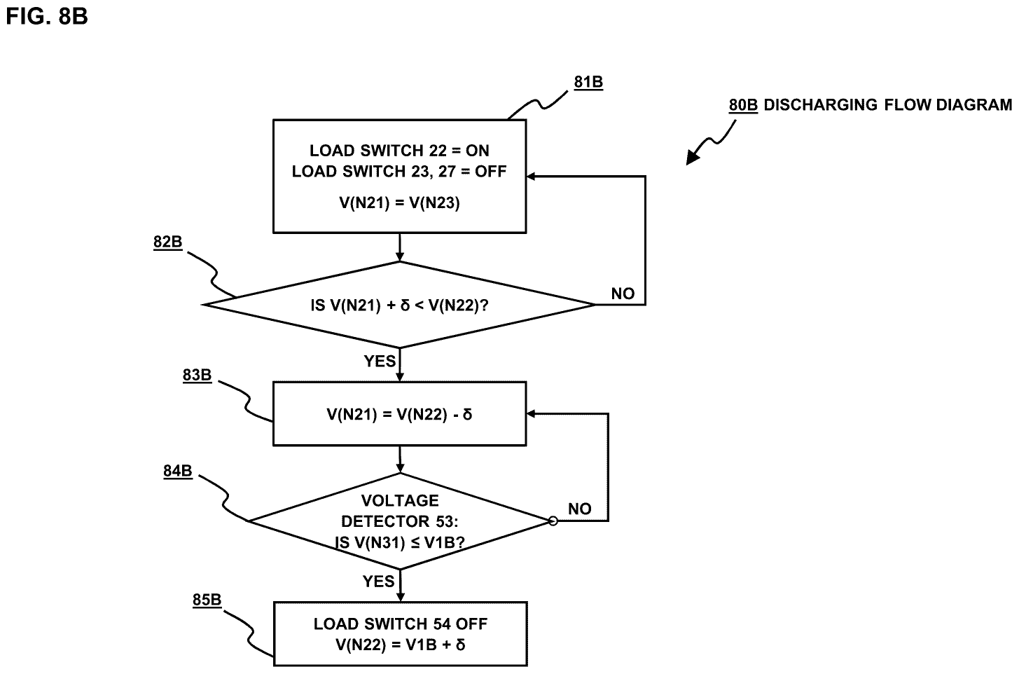

FIG. 8A is a flow diagram 80A of a charging process for the first example energy backup circuit 30 wherein said energy backup circuit 30 is associated with an example electronic device disclosed herein. In general, the voltage at N21 is assumed to be increasing with time during the charging process. Although there may be some small voltage decreases at N21 during the charging process, the overall trend is that the voltage at N21 is increasing with time. Flow diagram item 81A shows load switch 22 is switched ON and load switch 23 is switched OFF and load switch 27 is switched OFF (if applicable) and the voltage at N21 is equal to the voltage at N23 (i.e., V(N21)=V(N23)). Flow diagram item 82A follows flow diagram item 81A. Flow diagram item 82A shows the voltage detector 21 measuring the voltage at N23; if the voltage at N23 is greater than or equal to V3A (i.e., V(N23)>V3A) then flow diagram item 83A becomes active otherwise flow diagram item 81A becomes active. In general, during the charging stage shown by flow diagram item 82A, the voltage at N23 increases until it is greater than or equal to V3A. In other words, this charging condition comprises the voltage at N23 reaching or crossing a threshold from below. Flow diagram item 83A shows load switch 22 is switched OFF and load switch 23 is switched ON and load switch 27 is switched ON (if applicable) and the voltage at N23 is equal to the voltage at N22 (i.e., V(N23)=V(N22)). Flow diagram item 84A follows flow diagram item 83A. Flow diagram item 84A shows the voltage detector 21 measuring the voltage at N23; if the voltage at N23 is greater than V3B (i.e., V(N23)>V3B) then flow diagram item 85A becomes active otherwise flow diagram item 81A becomes active. During the charging stage shown by flow diagram item 84A, the voltage at N23 may be decreasing from V3A until it is less than or equal to V3B; this situation may occur when at least some energy has been previously transferred from energy storage unit 24 to energy storage unit 25. Alternatively, during the charging stage shown by flow diagram item 84A, the voltage at N23 may start with a value that is less than or equal to V3B; this situation may occur when no energy has been previously transferred from energy storage unit 24 to energy storage unit 25 (i.e., when the energy backup circuit associated with flow diagram 80A is first manufactured).

Consequently, owing to the process shown in flow diagram item 84A, flow diagram item 81A may be viewed as a default state of the overall charging process. Flow diagram item 85A shows that energy storage unit 25 is full. In general, the term “full” in relation to storage unit 25 represents that the charging state of energy storage unit 25 is complete to a satisfactory extent. Flow diagram item 84A follows flow diagram item 85A. V3A may be in the range 2V to 5V. V3B may have a value between 0.5V and 0.02V below the value of V3A. Experiments revealed satisfactory results were obtained when V3A=3.3V and V3B=3.15V. Experiments also revealed satisfactory results were obtained when V3A=3.6V and V3B=3.5V.

FIG. 8B is a flow diagram 80B of a discharging process for the first example energy backup circuit 30 wherein said energy backup circuit 30 is associated with an example electronic device disclosed herein. In general, the voltage at N21 is assumed to be decreasing with time during the discharging process. Although there may be some small voltage increases at N21 during the discharging process, the overall trend is that the voltage at N21 is decreasing with time. Flow diagram item 81B shows load switch 22 is switched ON and load switch 23 is switched OFF and load switch 27 is switched OFF (if applicable) and the voltage at N21 is equal to the voltage at N23 (i.e. V(N21)=V(N23)). Flow diagram item 82B follows flow diagram item 81B. Flow diagram item 82B shows that if the voltage at N21 plus δ is less than the voltage at N22 (i.e., V(N21)+δ<V(N22)) then flow diagram item 83B becomes active, otherwise flow diagram item 81B becomes active. Flow diagram item 83B shows the voltage at N21 equals the voltage at N22 minus δ (i.e., V(N21)=V(N22)−δ). Flow diagram item 84B follows flow diagram item 83B. Flow diagram item 84B shows the voltage detector 53 measuring the voltage at N31; if the voltage at N31 is less than or equal to V1B (i.e., V(N31)≤V1B) then flow diagram item 85B becomes active, otherwise flow diagram item 83B becomes active. Flow diagram item 85B shows that load switch 54 is switched OFF (via SIG41) and the voltage at N22 equals the voltage V1B plus δ (i.e., V(N22)=V1B+δ). When a silicon diode is used for the asymmetric conductance unit 31, the quantity δ may be in the range 200 mV to 1200 mV with a typical value of ˜700 mV. When a Schottky diode is used for the asymmetric conductance unit 31, the quantity δ may be in the range 50 mV to 1000 mV with a typical value of ˜300 mV. When an ideal diode is used for the asymmetric conductance unit 31, the quantity δ may be in the range 10 mV to 150 mV with a typical value of ˜50 mV.

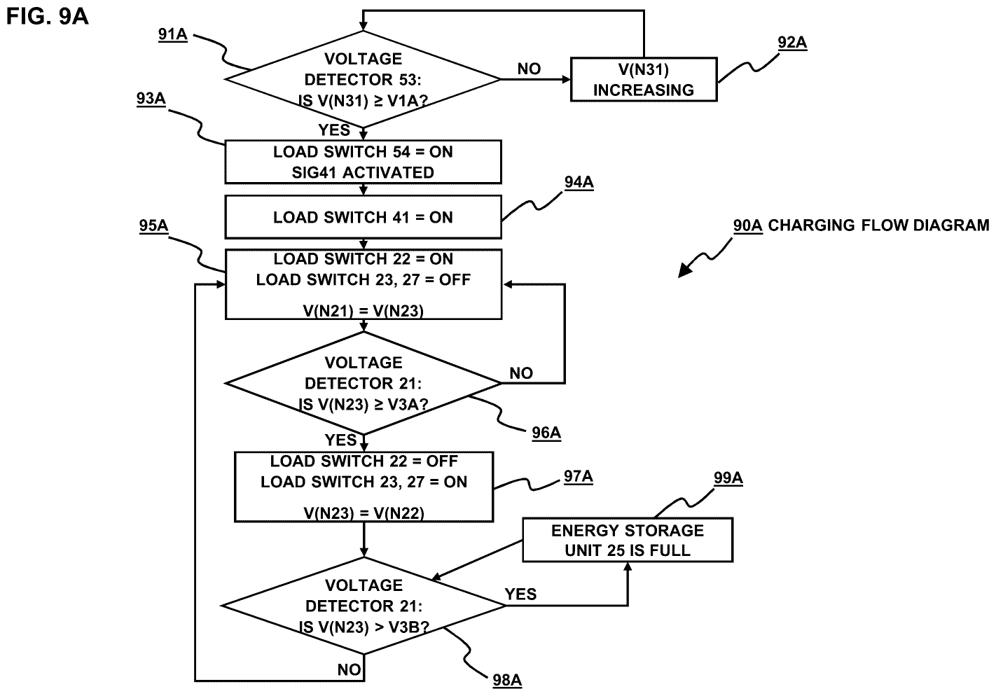

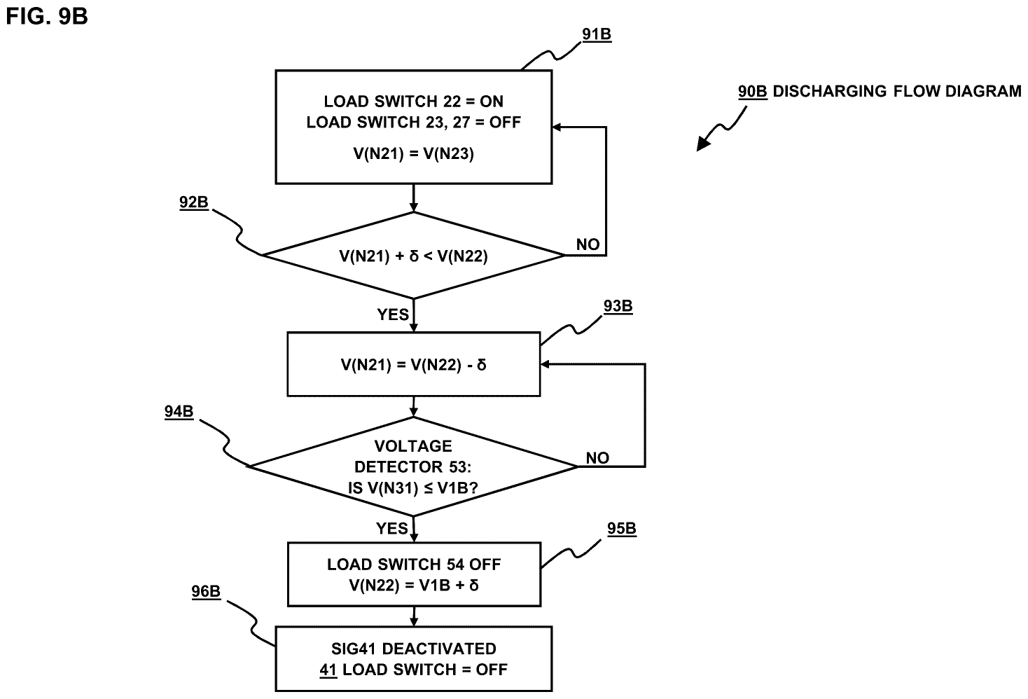

FIG. 9A is a flow diagram 90A of a charging process for the second example energy backup circuit 40 wherein said energy backup circuit 40 is associated with an example electronic device disclosed herein. In general, the voltage at N31 is assumed to be increasing with time during the charging process. Although there may be some small voltage decreases at N31 during the charging process, the overall trend is that the voltage at N31 is increasing with time. Flow diagram item 91A shows the voltage detector 53 measuring the voltage at N31; if the voltage at N31 is greater than or equal to V1A (i.e., V(N31)≥V1A) then flow diagram item 93A becomes active, otherwise flow diagram item 92A becomes active. Flow diagram item 92A shows the voltage at N31 increasing. Flow diagram item 93A shows load switch 54 is switched ON because SIG41 is activated. Flow diagram item 94A follows flow diagram item 93A. Flow diagram item 94A shows load switch 41 is switched ON (SIG41 is activated), so that energy may be transferred into the energy backup circuit 40. Flow diagram item 95A follows flow diagram item 94A. Flow diagram item 95A shows load switch 22 is switched ON and load switch 23 is switched OFF and load switch 27 is switched OFF (if applicable) and the voltage at N21 is equal to voltage at N23 (i.e., V(N21)=V(N23)). Flow diagram item 96A follows flow diagram item 95A. Flow diagram item 96A shows the voltage detector 21 measuring the voltage at N23; if V(N23)≥V3A then flow diagram item 97A becomes active otherwise flow diagram 95A becomes active. Flow diagram item 97A shows load switch 22 is switched OFF and load switch 23 is switched ON and load switch 27 is switched ON (if applicable) and the voltage at N23 is equal to voltage at N22 (i.e., V(N23)=V(N22)). Flow diagram item 98A follows flow diagram item 97A. Flow diagram item 98A shows voltage detector 21 measuring the voltage at N23; if the voltage at N23 is greater than V3B (i.e., V(N23)>V3B) then flow diagram 99A becomes active, otherwise flow diagram item 95A becomes active. Flow diagram item 99A shows that the energy storage unit 25 is full. Flow diagram item 98A follows flow diagram item 99A.

FIG. 9B is a flow diagram 90B of a discharging process for the second example energy backup circuit 40 wherein said energy backup circuit 40 is associated with an example electronic device disclosed herein. In general, the voltage at N31 is assumed to be decreasing with time during the discharging process. Although there may be some small voltage increases at N31 during the discharging process, the overall trend is that the voltage at N31 is decreasing with time. Flow diagram item 91B shows load switch 22 is switched ON and load switch 23 is switched OFF and load switch 27 is switched OFF (if applicable) and the voltage at N21 is equal to the voltage at N23 (i.e. V(N21)=V(N23)). Flow diagram item 92B follows flow diagram item 91B. Flow diagram item 92B shows that if the voltage at N21 plus δ is less than the voltage at N22 (i.e., V(N21)+δ<V(N22)) then flow diagram item 93B becomes active, otherwise flow diagram item 91B becomes active. Flow diagram item 93B shows the voltage at N21 equals the voltage at N22 minus δ (i.e., V(N21)=V(N22)−δ). Flow diagram item 94B follows flow diagram item 93B. Flow diagram item 94B shows the voltage detector 53 measuring the voltage at N31; if the voltage at N31 is less than or equal to V1B (i.e., V(N31)≥V1B) then flow diagram item 95B becomes active, otherwise flow diagram item 93B becomes active. Flow diagram item 95B shows that load switch 54 is switched OFF (via SIG41) and the voltage at N22 equals the voltage V1B plus δ (i.e., V(N22)=V1B+δ). Flow diagram 96B follows flow diagram 95B. Flow diagram 96B shows load switch 41 switched OFF by SIG41 (SIG41 is deactivated) so that electrical energy may not be transferred into the energy backup circuit 40.

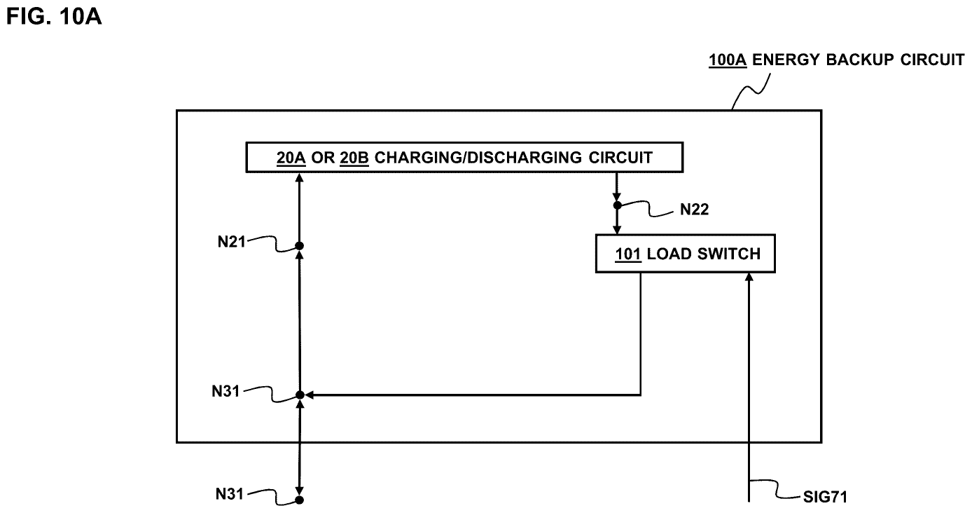

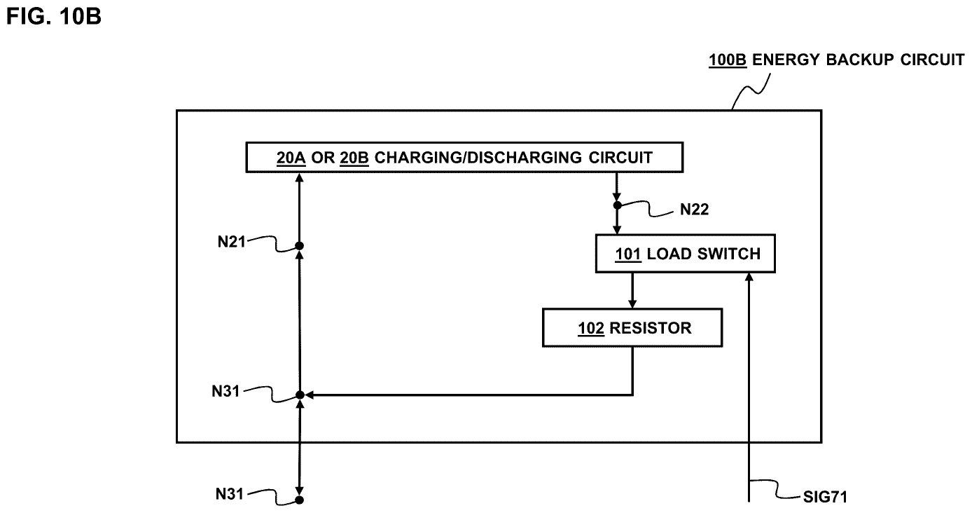

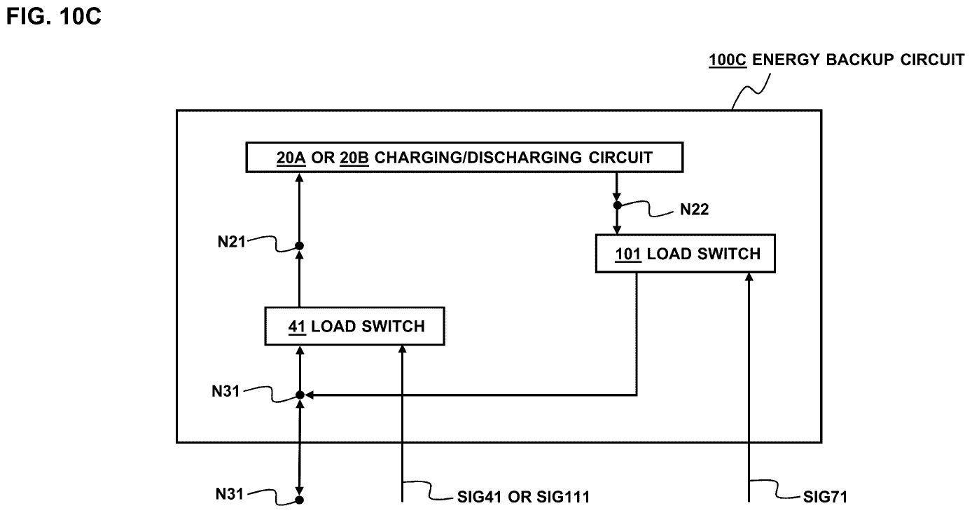

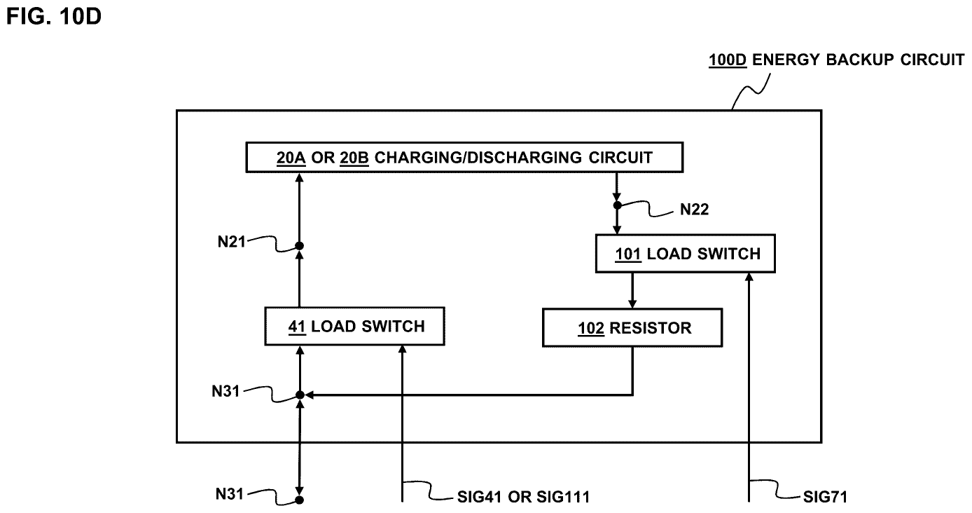

FIG. 10A is a block diagram of a third example energy backup circuit 100A that includes a charging/discharging circuit and a load switch 101. Said charging/discharging circuit may be the first example charging/discharging circuit 20A or the second example charging/discharging circuit 20B. The energy backup circuit 100A may be an electrical-energy storage system. As previously shown, charging/discharging circuit 20A, 20B is connected to N21 and N22. Load switch 101 is connected to N22, N31 and SIG71. Load switch 101 may at least partially control a discharging process of energy backup circuit 100A. Although N31 is drawn in two positions in FIG. 10A, both positions are electrically equivalent. One of the N31 positions has been drawn outside of the energy backup circuit 100A for ease of understanding subsequent circuit augmentations. N21 is connected to N31. Although N21 and N31 are electrically equivalent in FIG. 10A, these nodes have been drawn in this particular manner for ease of understanding further circuit augmentations. N31 may be an input to the energy backup circuit 100A for a charging process. N31 may be an output of the energy backup circuit 100A for a discharging process. When a first set of circuit conditions are satisfied, electrical energy may be transferred from N31 into the energy backup circuit 100A. When a second set of circuit conditions are satisfied, electrical energy may be transferred from the energy backup circuit 100A to N31. Load switch 101 may control when energy is transferred from the energy backup circuit 100A to N31 (i.e., load switch 101 may control when energy is delivered to an associated application load). The flow diagram 80A previously shown in FIG. 8A also shows a charging process for the third example energy backup circuit 100A wherein said energy backup circuit 100A is associated with an example electronic device disclosed herein. In other words, the same charging flow diagram 80A is applicable to both the first example energy backup circuit 30 and the third example energy backup circuit 100A.

FIG. 10B is a block diagram of a fourth example energy backup circuit 100B that includes a charging circuit, a load switch 101 and a resistor 102. Said charging/discharging circuit may be the first example charging/discharging circuit 20A or the second example charging/discharging circuit 20B. The energy backup circuit 100B may be an electrical-energy storage system. Energy backup circuit 100B may be similar to energy backup circuit 100A except that a resistor 102 is now positioned between the load switch 101 and N31. The resistor 102 reduces the current flow during the discharging process which may enable an increase in the total amount of energy that can be delivered from an associated energy backup circuit. Consequently, the resistor 102 may increase the efficiency of the energy backup circuit 100B and therefore further optimise power delivery to an associated application load in order to optimise the amount of useful work performed by the harvested energy in an associated electronic device. The resistor 102 may be used when the energy storage unit 25 inside the charging/discharging circuit 20A or 20B has an associated overcurrent limit. Exceeding an overcurrent limit may damage components (such as a battery, supercapacitor, capacitor etc.) that comprise the energy storage unit 25. Resistor 102 may ensure this overcurrent limit is not exceeded, therefore resistor 102 may prevent damage to the energy storage unit 25. The resistor 102 may be used with energy storage unit 25 having a low ESR (equivalent series resistor) or a low internal resistance to limit the current to a value such that Joule heating losses are reduced while still maintaining sufficient current magnitude for stable operation of the application load. In other words, resistor 102 may be used to maintain high circuit efficiency while preventing any damage to the energy storage unit 25. The value of the resistor 102 may be in the range 100 to 100kΩ. The value of the resistor 102 may preferably be in the range 5kΩ to 50kΩ. Experiments/simulation satisfactory circuit performance was achieved when the value of the resistor 102 was 50kΩ.

The flow diagram 80A previously shown in FIG. 8A also shows a charging process for the fourth example energy backup circuit 100B wherein said energy backup circuit 100B is associated with an example electronic device disclosed herein. In other words, the same charging flow diagram 80A is applicable to both the first example energy backup circuit 30 and the fourth example energy backup circuit 100B.

FIG. 10C is a block diagram of a fifth example energy backup circuit 1000 that includes a charging circuit, a load switch 41 and a load switch 101. Said charging/discharging circuit may be the first example charging/discharging circuit 20A or the second example charging/discharging circuit 20B. The energy backup circuit 1000 may be an electrical-energy storage system. Energy backup circuit 1000 may be similar to energy backup circuit 100A except that a load switch 41 is now positioned between N31 and N21. The load switch 41 is switched ON and OFF by SIG41 when the energy backup circuit 1000 is associated with electronic device 110A. Alternatively, the load switch 41 is switched ON and OFF by SIG111 when the energy backup circuit 1000 is associated with electronic device 110B. Load switch 41 may at least partially control a charging process and a null process of energy backup circuit 1000. Load switch 101 may at least partially control a discharging process and a null process of energy backup circuit 1000. The advantage of energy backup circuit 1000 over example energy backup circuit 100A is that the combination of load switch 41 and load switch 101 can be used to electrically isolate (i.e., decouple) energy backup circuit 1000 from N31 which may enable better power delivery and/or better energy efficiency so that more useful work is performed by the harvested energy. When load switch 41 and load switch 101 are both switched OFF, energy backup circuit 1000 cannot store electrical energy that is generated by energy harvesting unit within an associated electronic. When load switch 41 and load switch 101 are both switched OFF, energy backup circuit 1000 cannot deliver electrical energy to an application load within an associated electronic.

FIG. 10D is a block diagram of a sixth example energy backup circuit 100D that includes a charging/discharging circuit, a load switch 41, a load switch 101 and a resistor 102. Said charging/discharging circuit may be the first example charging/discharging circuit 20A or the second example charging/discharging circuit 20B. The energy backup circuit 100D may be an electrical-energy storage system. Energy backup circuit 100D may be similar to energy backup circuit 1000 except that a resistor 102 is now positioned between load switch 101 and N31. The resistor 102 reduces the current flow during the discharging process which may enable an increase in the total amount of energy that can be delivered from the energy backup circuit. Consequently, the resistor 102 may increase the efficiency of the energy backup circuit 100D and therefore further optimise power delivery to an associated application load in order to optimise the amount of useful work performed by the harvested energy in an associated electronic device. The resistor 102 may be used when the energy storage unit 25 inside the charging/discharging circuit 20A or 20B has an associated overcurrent limit. Exceeding an overcurrent limit may damage components (such as a battery, supercapacitor, capacitor etc.) that comprise the energy storage unit 25. Resistor 102 may ensure this overcurrent limit is not exceeded, therefore resistor 102 may prevent damage to the energy storage unit 25. The resistor 102 may be used with energy storage unit 25 having a low ESR (equivalent series resistor) or a low internal resistance to limit the current to a value such that Joule heating losses are reduced while still maintaining sufficient current magnitude for stable operation of the application load. In other words, resistor 102 may be used to maintain high circuit efficiency while preventing any damage to the energy storage unit 25.

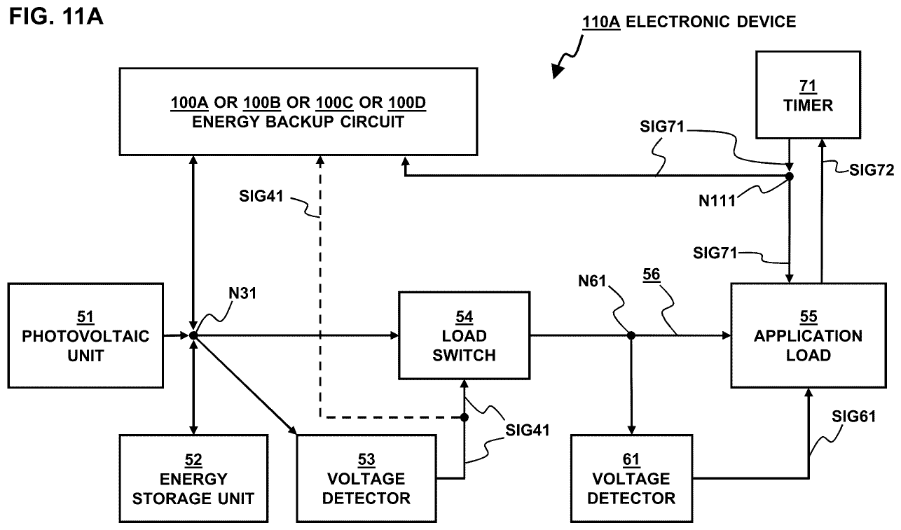

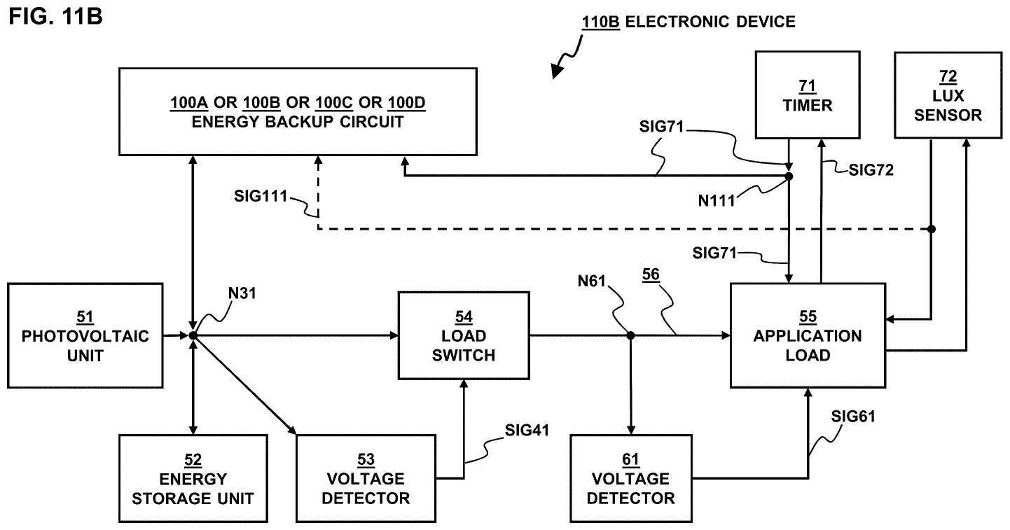

FIG. 11A is a block diagram of a fourth example electronic device 110A that may be an ultra-low power energy harvesting device. The fourth example electronic device 110A may be similar to the third example electronic device 70 except that SIG71 is also connected to N111 (node 111) and an energy backup circuit. The energy backup circuit associated with example electronic device 110A may be energy backup circuit 100A, energy backup circuit 100B, energy backup circuit 1000 or energy backup circuit 100D. The energy backup circuit 1000 and energy backup circuit 100D are connected to SIG41 (signal 41) but SIG41 is not connected to energy backup circuit 100A or energy backup circuit 100B, therefore the SIG41 connection is shown with a dashed line in FIG. 11A. The load switch 41 in energy backup circuit 1000 and energy backup circuit 100D may be switched ON and OFF via SIG41.

FIG. 11B is a block diagram of a fifth example electronic device 110B that may be an ultra-low power energy harvesting device. The fifth example electronic device 110B may be similar to the fourth example electronic device 110A except that electronic device 110B also includes a lux sensor 72. The lux sensor 72 connected to the application load 55 via an input and an output. In general, the lux sensor 72 is associated with the application load. The energy backup circuit 1000 and energy backup circuit 100D are connected to the lux sensor 72 via SIG111 (signal 111) but SIG111 is not connected to energy backup circuit 100A or energy backup circuit 100B, therefore the SIG111 connection is shown with a dashed line in FIG. 11B. The load switch 41 in energy backup circuit 1000 and energy backup circuit 100D may be switched ON and OFF via SIG111.

The flow diagram 80A shown previously in FIG. 8A is also a charging process for the third example energy backup circuit 100A and the fourth example energy backup circuit 100B wherein said energy backup circuits 100A, 100B may be associated with example electronic device(s) disclosed herein. The flow diagram 90A shown previously in FIG. 9A is also a charging process for the fifth example energy backup circuit 1000 and the sixth example energy backup circuit 100D wherein said energy backup circuits 1000, 100D are associated with an example electronic device disclosed herein.

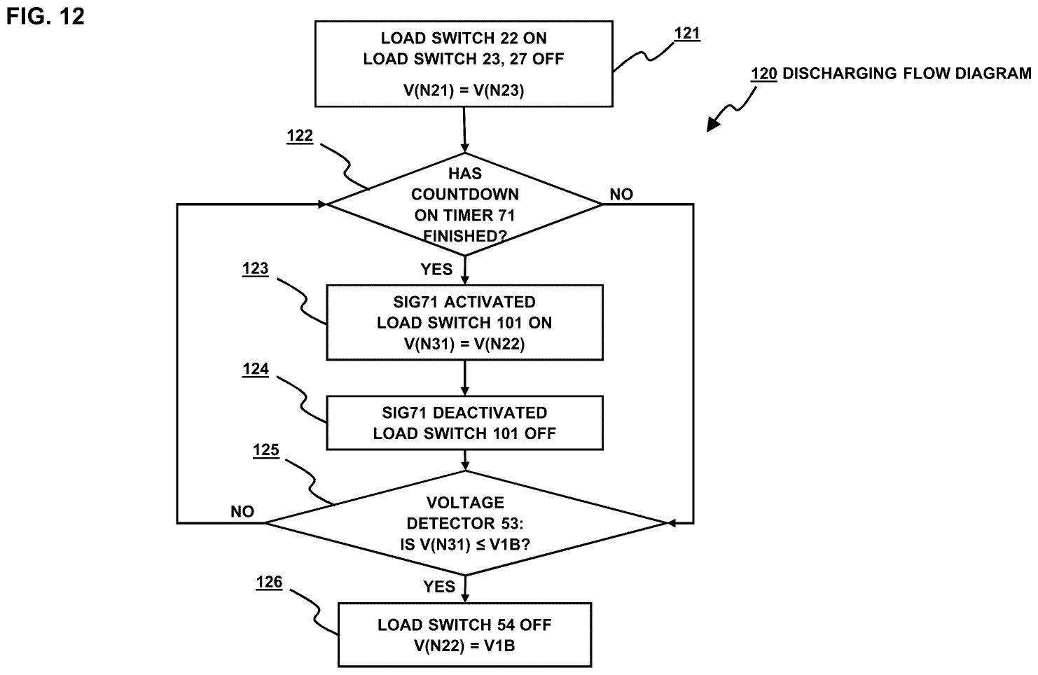

FIG. 12 is a flow diagram 120 of a discharging process for the third example energy backup circuit 100A, the fourth example energy backup circuit 100B, the fifth example energy backup circuit 1000 and the sixth example energy backup circuit 100D wherein said energy backup circuits 100A, 100B, 1000 and 100D may be associated with example electronic device(s) disclosed herein. In general, the voltage at N21 is assumed to be decreasing with time during the discharging process. Although there may be some small voltage increases at N21 during the discharging process, the overall trend is that the voltage at N21 is decreasing with time. Flow diagram item 121 shows load switch 22 is switched ON and load switch 23 is switched OFF and load switch 27 is switched OFF (if applicable) and the voltage at N21 is equal to the voltage at N23 (i.e., V(N21)=V(N23)). Flow diagram item 122 follows flow diagram item 121. Flow diagram item 122 shows that if the countdown on timer 71 has finished then flow diagram item 123 becomes active otherwise flow diagram item 125 becomes active. Flow diagram item 123 shows that because the countdown on timer 71 has finished, SIG71 is activated for a predetermined time that is in range from 1 ms to 150 ms and has a typical value of ˜15 ms. When SIG71 is activated, load switch 101 is switched ON so that the voltage at N31 becomes equal to the voltage at N22 (i.e., V(N31=V(N22)). Flow diagram 124 follows flow diagram 123. Flow diagram 124 shows that SIG71 is deactivated after said predetermined time. When SIG71 is deactivated, load switch 101 is switched OFF. Flow diagram item 125 follows flow diagram item 124. Flow diagram item 125 shows the voltage detector 53 measuring the voltage at N31; if the voltage at N31 is less than or equal to V1B (i.e., V(N31)≤V1B) then flow diagram 126 becomes active, otherwise flow diagram item 122 becomes active. Flow diagram item 126 shows load switch 54 is switched OFF so that the voltage at N22 is equal to V1B (i.e., V(N22)=V1B).

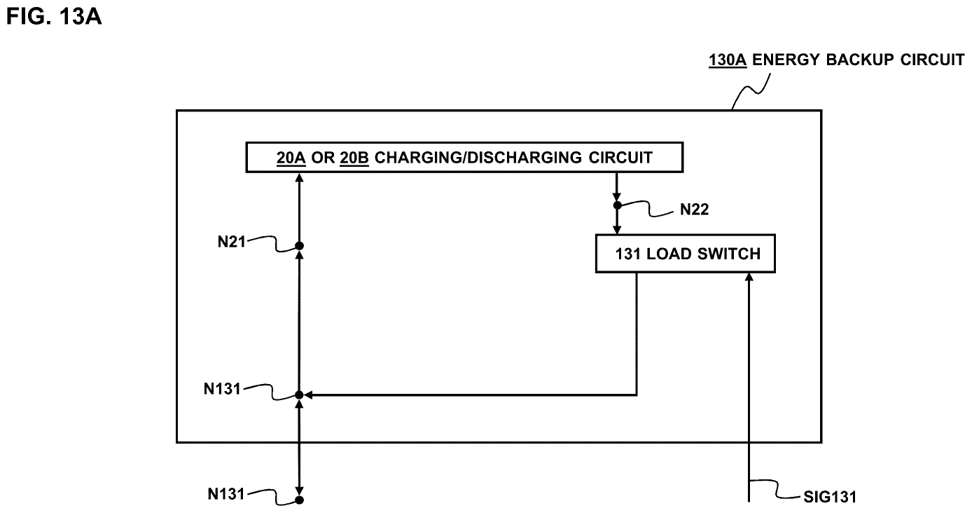

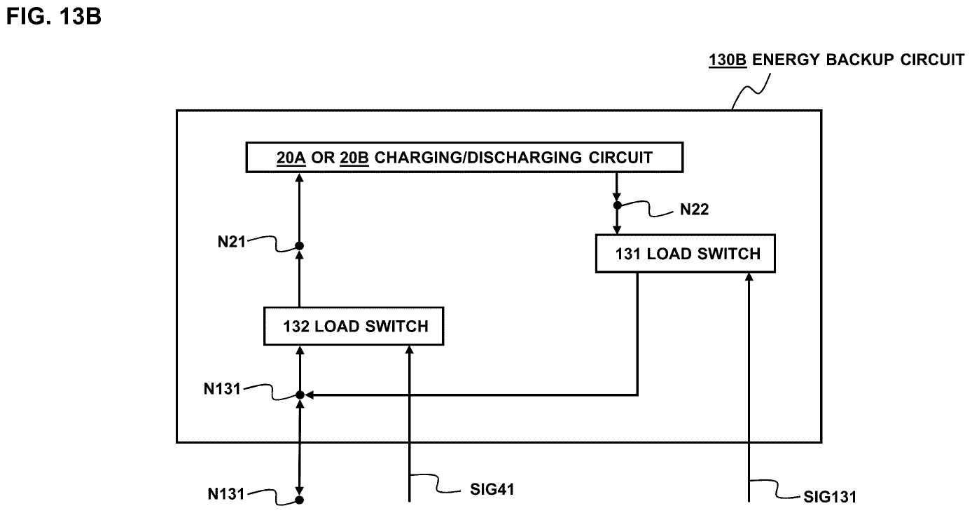

FIG. 13A is a block diagram of a seventh example energy backup circuit 130A that includes a charging/discharging circuit and a load switch 131. Said charging/discharging circuit may be the first example charging/discharging circuit 20A or the second example charging/discharging circuit 20B. The charging/discharging circuit 20A, 20B is connected to N21 and N22. The energy backup circuit 130A may be an electrical-energy storage system. Load switch 131 is connected to N22, N131 and SIG131. Load switch 131 may at least partially control a discharging process of energy backup circuit 130A. Although N131 is drawn in two positions in FIG. 13A, both positions are electrically equivalent. One of the N131 positions has been drawn outside of the energy backup circuit 130A for ease of understanding subsequent circuit augmentations. N21 is connected to N131. Although N21 and N131 are electrically equivalent in FIG. 13A, these nodes have been drawn in this particular manner for ease of understanding further circuit augmentations. N131 may be an input to the energy backup circuit 130A for a charging process. N131 may be an output of the energy backup circuit 130A for a discharging process. When a first set of circuit conditions are satisfied, electrical energy may be transferred from N131 into the energy backup circuit 130A. When a second set of circuit conditions are satisfied, electrical energy may be transferred from the energy backup circuit 130A to N131.

FIG. 13B is a block diagram of an eighth example energy backup circuit 130B that includes a charging/discharging circuit, a load switch 131 and a load switch 132. Said charging/discharging circuit may be the first example charging/discharging circuit 20A or the second example charging/discharging circuit 20B. Energy backup circuit 130B may be similar to energy backup circuit 130A except that a load switch 132 is now positioned between N131 and N21. Load switch 131 may at least partially control a discharging process and a null process of energy backup circuit 130B. Load switch 132 may at least partially control a charging process and a null process of energy backup circuit 130B. The energy backup circuit 130B may be an electrical-energy storage system. The load switch 132 is switched ON and OFF by SIG41. The advantage of energy backup circuit 130B over example energy backup circuit 130A is that load switch 132 can be used to isolate energy backup circuit 130B from an associated example electronic device which may enable better power delivery and/or better energy efficiency so that more useful work is performed by the harvested energy.

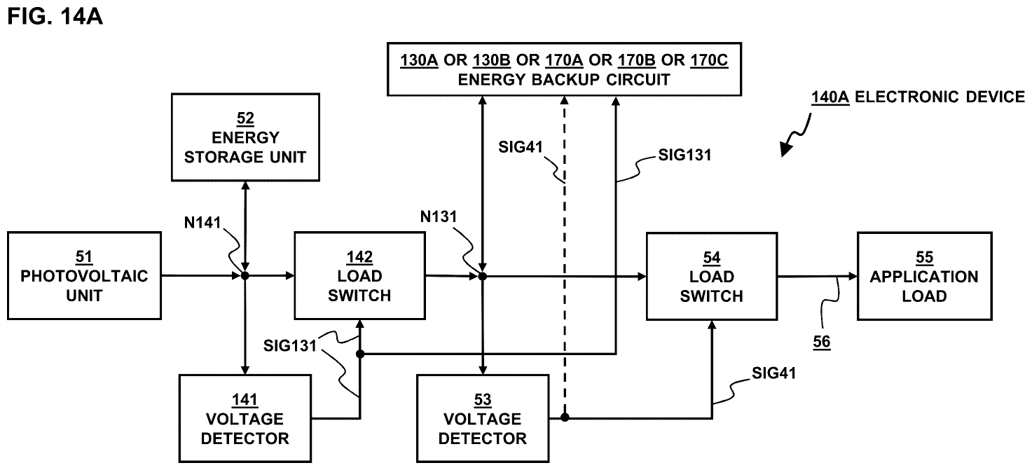

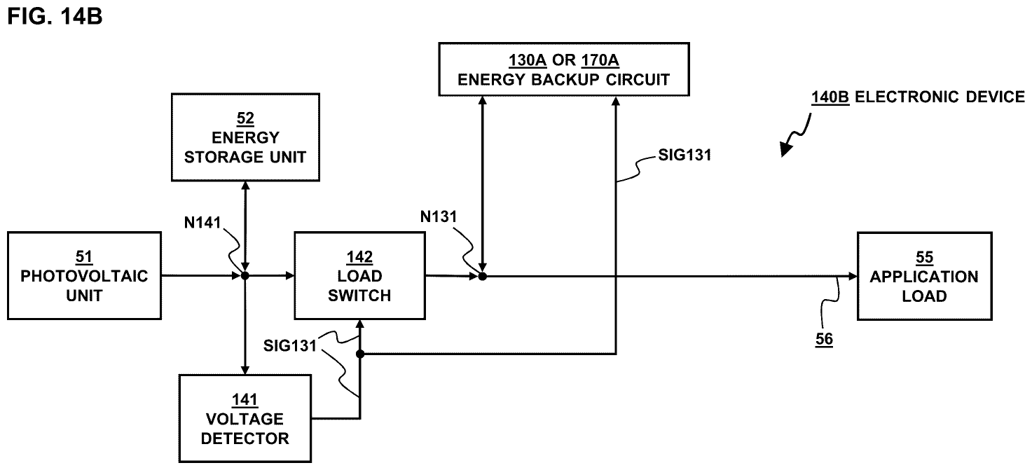

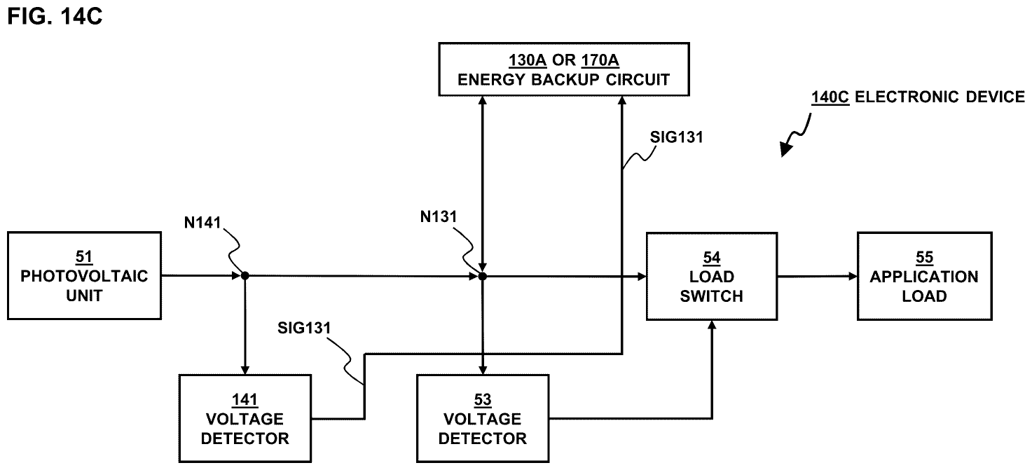

FIG. 14A is a block diagram of a sixth example electronic device 140A that may be an ultra-low power energy harvesting device. The sixth example electronic device 140A includes photovoltaic unit 51 (i.e., an energy harvesting unit), an energy storage unit 52, a voltage detector 53, a load switch 54, an application load 55, a voltage detector 141, a load switch 142 and an energy backup circuit. The energy backup circuit may be the seventh example energy backup circuit 130A or the eighth example energy backup circuit 130B or the ninth example energy backup circuit 170A or the tenth example energy backup circuit 170B or the eleventh example energy backup circuit 170C. The seventh example energy backup circuit 130A and the eighth example energy backup circuit 130B have been disclosed above while the ninth example energy backup circuit 170A the tenth example energy backup circuit 170B and the eleventh example energy backup circuit 170C are disclosed below. The energy backup circuit 130A, 130B, 170A, 170B, 170C is connected to N131 (node 131) and SIG131, however, only energy backup circuits 130B, 170B and 170C are connected to SIG41 (signal 41) so this connection is shown with a dashed line. N131 (node 131) is a common point. The voltage detector 53 is connected to N131 and detects the voltage at N131. The voltage detector 53 is also connected to the load switch 54 via SIG41 (signal 41). The voltage detector 53 is configured to turn ON the load switch 54 for voltages greater than or equal to a first voltage V1A. The voltage detector 53 is further configured to turn OFF the load switch 54 for voltages less than or equal to a second voltage V1B wherein the first voltage V1A is greater than the second voltage V1B (i.e., V1A>V1B). The load switch 54 is connected to N131, the application load 55 and SIG41. The load switch 54 is switched ON and OFF via the input SIG41. The photovoltaic unit 51 is connected to N141 (node 141). The energy storage unit 52 is connected to N141. The voltage detector 141 is connected to SIG131 and N141. The voltage detector 141 detects the voltage at N141. The voltage detector 141 turns load switch 142 ON or OFF using SIG131 and according to the voltage detected at N141. The voltage detector 141 is configured to turn ON the load switch 142 for voltages greater than or equal to V4A. The voltage detector 141 is further configured to turn OFF the load switch 142 for voltages less than or equal to V4B. V4A may be greater than V4B. V1A may be greater than both V4A and V4B. V1B may be less than both V4A and V4B. The quantity V1A minus V1B may be greater than the quantity V4A minus V4B (i.e., (V1A-V1B)>(V4A-V4B)). V4A and V4B may be in the range 1.0V to 5.0V and preferably in the range 1.7V to 3.1V. Experiments revealed satisfactory performance was achieved when V4A=2.6V and V4B=2.2V. The load switch 142 is connected to N131, N141 and SIG131. The load switch 142 is switched ON and OFF via the input SIG131.

FIG. 14B is a block diagram of a seventh example electronic device 140B that may be an ultra-low power energy harvesting device. The seventh example electronic device 140B has a similar arrangement of components to the sixth example electronic device 140A, with notable differences being that the voltage detector 53 and the load switch 54 are not present in the seventh example electronic device 140B. A further difference between the seventh example electronic device 140B and the sixth example electronic device 140A is that only energy backup circuit 130A and energy backup circuit 170A are compatible with the seventh example electronic device 140B. Energy backup circuit 130B and energy backup circuit 170B are not compatible with the seventh example electronic device 140B because the voltage detector 53, and hence SIG41, is not present in the seventh example electronic device 140B.

FIG. 14C is a block diagram of an eighth example electronic device 140C that may be an ultra-low power energy harvesting device. The eighth example electronic device 140C has a similar arrangement of components to the sixth example electronic device 140A, with notable differences being that the energy storage unit 52 and the load switch 142 are not present in the eighth example electronic device 140C. A further difference between the eighth example electronic device 140C and the sixth example electronic device 140A is that only energy backup circuit 130A and energy backup circuit 170A are compatible with the eighth example electronic device 140C. Energy backup circuit 130B and energy backup circuit 170B aren't compatible with the eighth example electronic device 140C because the voltage detector 53, and hence SIG41, is not present in the eighth example electronic device 140C.

As disclosed above, FIG. 8A shows the flow diagram 80A that describes a charging process for various energy backup circuits disclosed herein. Flow diagram 80A also describes a charging process for the seventh example energy backup circuit 130A wherein said energy backup circuit 130A is associated with an example electronic device disclosed herein.

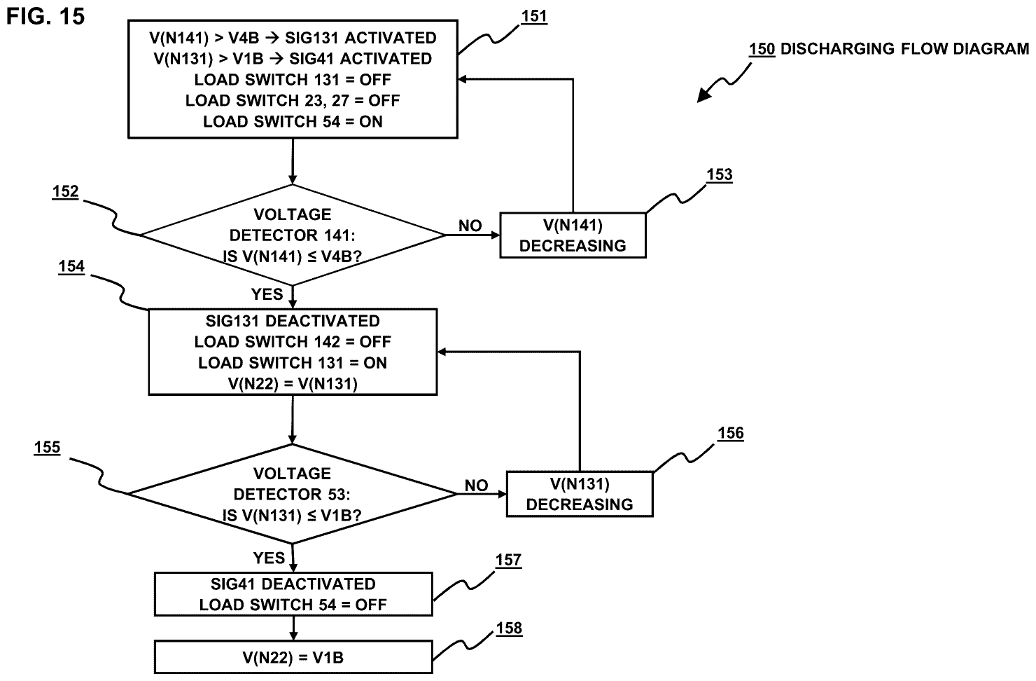

FIG. 15 is a flow diagram 150 of a discharging process for the seventh example energy backup circuit 130A and the eighth example energy backup circuit 130B wherein said energy backup circuits 130A and 130B may be associated with example electronic device(s) disclosed herein. In general, the voltage at N141 and/or N131 are assumed to be decreasing with time during the discharging process. Although there may be some small voltage increases at N141 and/or N131 during the discharging process, the overall trend is that the voltages at N141 and N131 are decreasing with time. Flow diagram item 151 shows the voltage at N141 is greater than V4B (i.e., V(N141)>V4B), therefore SIG131 is activated. Flow diagram item 151 also shows the voltage at N131 is greater than V1B (i.e., V(N131)>V1B), therefore SIG41 is activated (if applicable). Flow diagram item 151 also shows load switch 131 is switched OFF and load switch 23 is switched OFF and load switch 27 is switched OFF (if applicable) and load switch 54 is switched ON (if applicable). Flow diagram item 152 follows flow diagram item 151. Flow diagram item 152 shows the voltage detector 141 measuring the voltage at N141; if the voltage at N141 is less than or equal to V4B (i.e.; V(N141)≤V4B) then flow diagram item 154 becomes active, otherwise flow diagram item 153 becomes active. Flow diagram item 153 shows that the voltage at N141 is decreasing. Flow diagram item 151 follows flow diagram item 153. Flow diagram item 154 shows SIG131 is deactivated. Flow diagram item 154 also shows load switch 142 is switched OFF (if applicable) and load switch 131 is switched ON and the voltage at N22 is equal to the voltage at N131 (i.e., V(N22)=V(N131)). Flow diagram item 155 follows flow diagram item 154. Flow diagram item 155 shows voltage detector 53 (if applicable) measuring the voltage at N131; if the voltage at N131 is less than or equal to V1B (i.e., V(N131)≤V1B) then flow diagram item 157 becomes active, otherwise flow diagram item 156 becomes active. If voltage detector 53 is not applicable, then flow diagram 150 terminates at flow diagram item 154. Flow diagram item 156 shows the voltage at N131 is decreasing. Flow diagram item 154 follows flow diagram item 156. Flow diagram item 157 shows SIG41 deactivated (if applicable) and load switch 54 is switched OFF (if applicable). Flow diagram item 158 follows flow diagram item 157. Flow diagram item 158 shows the voltage at N22 equal to V1B (i.e., V(N22)=V1B).

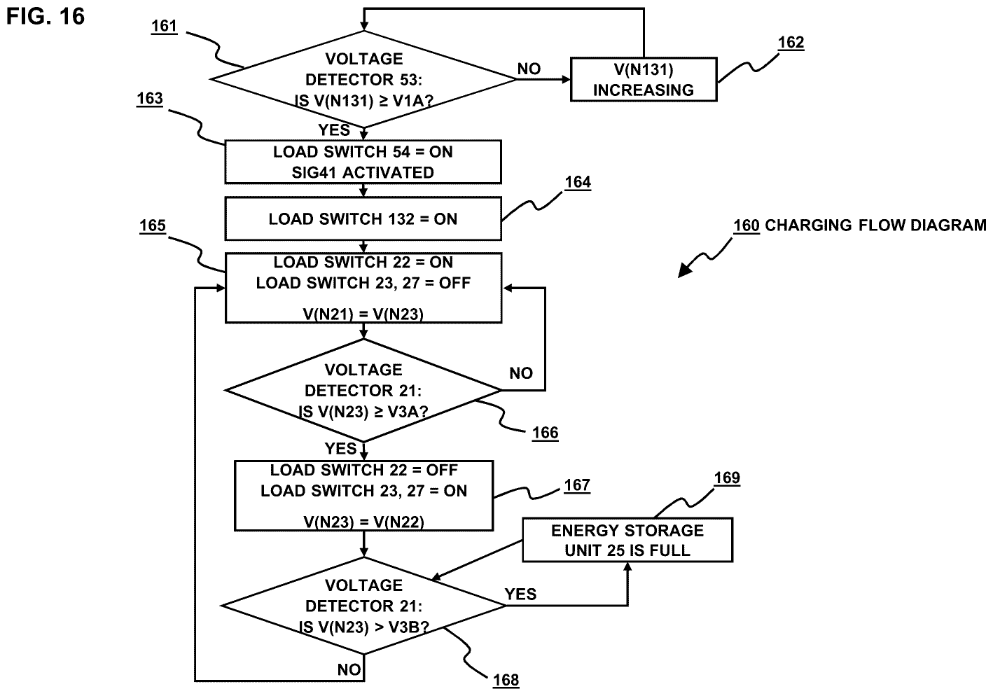

FIG. 16 is a flow diagram 160 of a charging process for the eighth example energy backup circuit 130B wherein said energy backup circuit 130B may be associated with example electronic device(s) disclosed herein. In general, the voltage at N131 is assumed to be increasing with time during the charging process. Although there may be some small voltage decreases at N131 during the charging process, the overall trend is that the voltage at N131 is increasing with time. Flow diagram item 161 shows the voltage detector 53 measuring the voltage at N131; if the voltage at N131 is greater than or equal to V1A (i.e., V(N131)≥V1A) then flow diagram item 163 becomes active, otherwise flow diagram item 162 becomes active. Flow diagram item 162 shows the voltage at N131 increasing. Flow diagram item 161 follows flow diagram item 162. Flow diagram item 163 shows load switch 54 is switched ON because SIG41 is activated. Flow diagram item 164 follows flow diagram item 163. Flow diagram item 164 shows load switch 132 is switched ON (SIG41 is activated), so that electrical energy may be transferred into the energy backup circuit 130B. Flow diagram item 165 follows flow diagram item 164. Flow diagram item 165 shows load switch 22 is switched ON (via SIG 21) and load switch 23 is switched OFF (via SIG 21) and load switch 27 (if applicable) is switched OFF (via SIG 21) and the voltage at N21 is equal to voltage at N23 (i.e., V(N21)=V(N23)). Flow diagram item 166 follows flow diagram item 165. Flow diagram item 166 shows the voltage detector 21 measuring the voltage at N23; if the voltage at N23 is greater than or equal to V3A (i.e., V(N23)≥V3A) then flow diagram item 167 becomes active otherwise flow diagram 165 becomes active. Flow diagram item 167 shows load switch 22 is switched OFF (via SIG 21) and load switch 23 is switched ON (via SIG 21) and load switch 27 (if applicable) is switched ON (via SIG 21) and the voltage at N23 is equal to voltage at N22 (i.e., V(N23)=V(N22)). Flow diagram item 168 follows flow diagram item 167. Flow diagram item 168 shows voltage detector 21 measuring the voltage at N23; if the voltage at N23 is greater than V3B (i.e., V(N23)>V3B) then flow diagram 169 becomes active, otherwise flow diagram item 165 becomes active. Flow diagram item 169 shows that the energy storage unit 25 is full. Flow diagram item 168 follows flow diagram item 169.

With reference to FIG. 5, FIG. 6, FIG. 7, FIG. 11A and FIG. 14B, example electronic devices 50, 60, 70, 110A and 140B that exclude an energy backup circuit as described herein have been previously disclosed in the literature. In other words, the energy backup circuit 30 or energy backup circuit 40 or energy backup circuit 100A or energy backup circuit 100B or energy backup circuit 1000 or energy backup circuit 100D or energy backup circuit 130A or energy backup circuit 170A may be used to augment electronic devices that have been previously disclosed in the literature in order to realise new ultra-low power energy harvesting devices. Said augmentation enables the example electronic devices 50, 60, 70, 110A and 140B to be more robust to larger variations in the ambient illumination conditions than previously disclosed electronic devices that do not include energy backup circuits 30, 40, 100A, 100B, 1000, 100D, 130A and 170A. Said improved robustness enables improved circuit efficiency because energy backup circuits 30, 40, 100A, 100B, 1000, 100D, 130A, and 170A enable efficient storage of energy when there is an excess of harvested energy and efficient delivery of stored energy to the application load 55 when there is a deficit of harvested energy. Consequently, energy backup circuits 30, 40, 100A, 100B, 1000, 100D, 130A, and 170A are particularly versatile since they may be used to enhance the performance of electronic devices previously disclosed in the literature, thus enabling new ultra-low power energy harvesting devices with enhanced robustness to variations in the ambient illumination conditions.

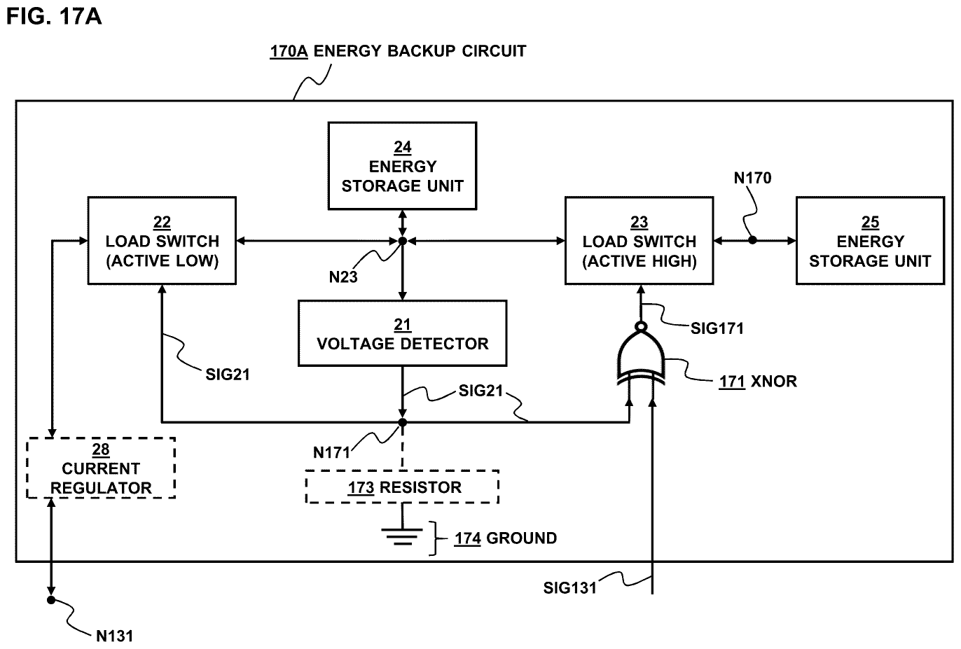

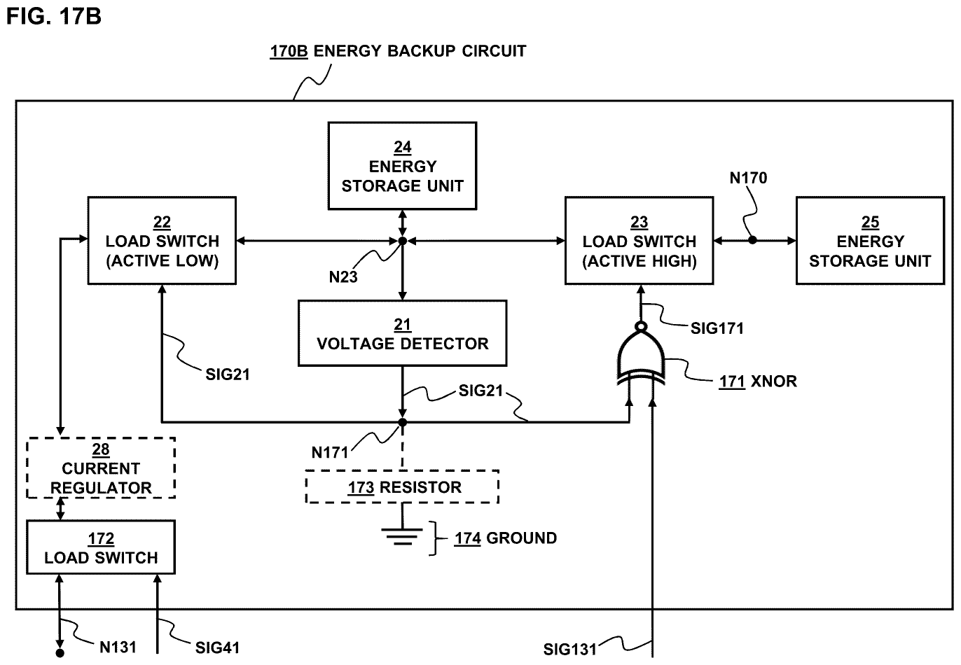

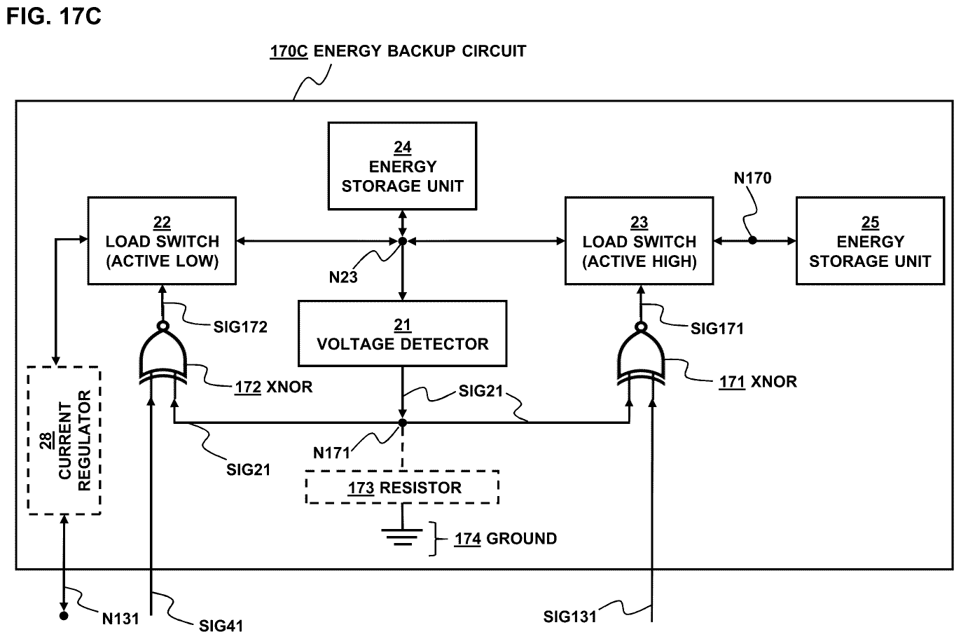

FIG. 17A is a block diagram of a ninth example energy backup circuit 170A that includes voltage detector 21, a load switch 22, a load switch 23, an energy storage unit 24, energy storage unit 25 and an XNOR logic gate 171. Ninth example energy backup circuit 170A may also include current regulator 28. Current regulator 28 is drawn with a dashed line to illustrate that its inclusion is optional. The current regulator 28 may at least partially control the charging rate and/or discharging rate of the energy backup circuit 170A. The current regulator 28 may be configured to control the discharging rate of an associated energy backup circuit (i.e., the current regulator 28 may control the rate that energy is transferred from associated energy backup circuit to an application load). Load switch 22 is coupled to N131 (node 131) either via a direct connection or via current regulator 28. Load switch 22 is connected to N23. Load switch 22 is also connected to voltage detector 21 via SIG21. Load switch 23 is connected to N23 and energy storage unit 25 via node N170. Load switch 23 is also connected to the output of the XNOR 171 via SIG171. Energy storage unit 25 is connected to load switch 23 via node 170. XNOR 171 has inputs SIG21 and SIG131. XNOR 171 has output SIG171. N131 has been drawn outside of the energy backup circuit 170A for ease of understanding subsequent circuit augmentations. N131 may be considered an input to the energy backup circuit 170A for a charging process. N131 may be considered an output of the energy backup circuit 170A for a discharging process. Voltage detector 21 controls ON and OFF states of both load switch 22 and load switch 23 via SIG21. When load switch 22 is switched ON and load switch 23 is switched OFF then electrical energy may be transferred from N131 and stored in energy storage unit 24 (i.e., energy backup circuit 170A is performing a first part of a charging process). When load switch 23 is switched ON and load switch 22 is switched OFF then electrical energy may be transferred from energy storage unit 24 to energy storage unit 25 (i.e., energy backup circuit 170A is performing a second part of a charging process). Unlike all energy backup circuits previously disclosed herein, circuit conditions may arise for energy backup circuit 170A wherein both load switch 22 and load switch 23 are in the same switched state at the same time. When load switch 22 and load switch 23 are both switched ON at the same time, then electrical energy may be transferred from energy storage unit 24 and/or energy storage unit 25 to N131 (i.e., energy backup circuit 170A is performing a discharging process). Ninth example energy backup circuit 170A may also include resistor 173. Resistor 173 is drawn with a dashed line to illustrate that its inclusion is optional. Resistor 173 is connected to node N171 and ground 174. The resistor 173 may have a resistance in the range 10kΩ to 100MΩ. Preferably, the resistor 173 may have a resistance in the range 100kΩ to 10MΩ. Preferably, the minimum resistance of resistor 173 is 100kΩ. The advantages of resistor 173 is that it may prevent unstable circuit behaviour, especially during startup and/or bootup phases of operation when the voltage on node N23 is below the minimum operating condition of the voltage detector 21. The disadvantages of resistor 173 is that a small amount of energy may be lost to non-useful work when voltage detector 21 activates a high logic signal via SIG21, thus the inclusion of resistor 173 may slightly lower the circuit efficiency. The energy backup circuit 170A may be an electrical-energy storage system.

FIG. 17B is a block diagram of a tenth example energy backup circuit 170B that includes voltage detector 21, a load switch 22, a load switch 23, an energy storage unit 24, energy storage unit 25, an XNOR logic gate 171 and a load switch 172. Tenth example charging/discharging circuit 170B may also include current regulator 28. Current regulator 28 is drawn with a dashed line to illustrate that its inclusion is optional. Energy backup circuit 170B may be similar to energy backup circuit 170A except that the load switch 172 is positioned between N131 and either the current regulator 28 (if the current regulator 28 is included) or load switch 22 (if the current regulator 28 is not included). The load switch 172 is switched ON and OFF by SIG41. Load switch 172 may at least partially control a charging process, a discharging process and a null process of energy backup circuit 170B. The advantage of energy backup circuit 170B over example energy backup circuit 170A is that load switch 172 can be used to isolate the energy backup circuit 170B from an associated example electronic device which may enable better power delivery and/or better energy efficiency so that more useful work is performed by the harvested energy. Tenth example energy backup circuit 170B may also include resistor 173. Resistor 173 is drawn with a dashed line to illustrate that its inclusion is optional. Resistor 173 is connected to node N171 and ground 174. The resistor 173 may have a resistance in the range 10KΩ to 100MΩ. Preferably, the resistor 173 may have a resistance in the range 100kΩ to 10MΩ. Preferably, the minimum resistance of resistor 173 is 100kΩ. The advantages of resistor 173 is that it may prevent unstable circuit behaviour, especially during startup and/or bootup phases of operation when the voltage on node N23 is below the minimum operating condition of the voltage detector 21. The disadvantages of resistor 173 is that a small amount of energy may be lost to non-useful work when voltage detector 21 activates a high logic signal via SIG21, thus the inclusion of resistor 173 may slightly lower the circuit efficiency. The energy backup circuit 170B may be an electrical-energy storage system.

FIG. 17C is a block diagram of an eleventh example energy backup circuit 170C that includes voltage detector 21, a load switch 22, a load switch 23, an energy storage unit 24, energy storage unit 25, an XNOR logic gate 171 and an XNOR logic gate 172. Eleventh example energy backup circuit 170C may also include current regulator 28. Current regulator 28 is drawn with a dashed line to illustrate that its inclusion is optional. Load switch 22 is coupled to N131 (node 131) either via a direct connection or via current regulator 28. Energy backup circuit 170C may be similar to energy backup circuit 170B except that the output (SIG172) from the XNOR logic gate 172 now controls ON and OFF switching in load switch 22. SIG21 and SIG41 are inputs to the XNOR logic gate 172. Eleventh example energy backup circuit 170C may also include resistor 173. Resistor 173 is drawn with a dashed line to illustrate that its inclusion is optional. Resistor 173 is connected to node N171 and ground 174. The resistor 173 may have a resistance in the range 10kΩ to 100MΩ. Preferably, the resistor 173 may have a resistance in the range 100kΩ to 10MΩ. Preferably, the minimum resistance of resistor 173 is 100kΩ. The advantages of resistor 173 is that it may prevent unstable circuit behaviour, especially during startup and/or bootup phases of operation when the voltage on node N23 is below the minimum operating condition of the voltage detector 21. The disadvantages of resistor 173 is that a small amount of energy may be lost to non-useful work when voltage detector 21 activates a high logic signal via SIG21, thus the inclusion of resistor 173 may slightly lower the circuit efficiency. The energy backup circuit 170C may be an electrical-energy storage system.

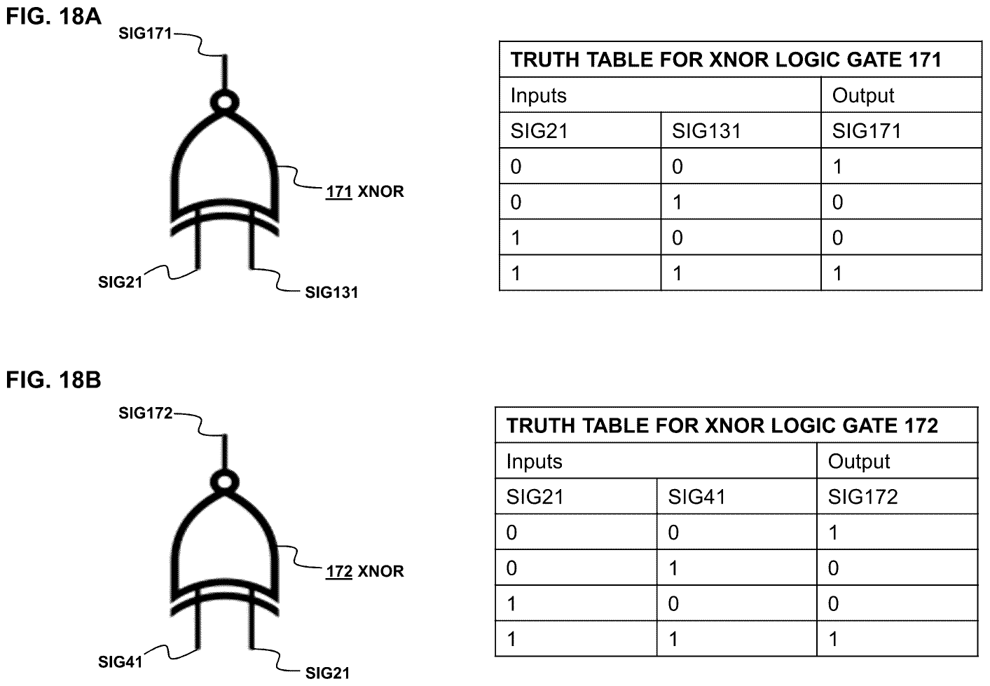

FIG. 18A shows a truth table for the XNOR logic gate 171 used in the ninth energy backup circuit 170A, the tenth energy backup circuit 170B and the eleventh energy backup circuit 170C. The XNOR logic gate 171 is of conventional design, thus the inputs (SIG21 and SIG131) and the resulting output (SIG171) follow conventional logical rules associated with a conventional XNOR logic gate.

FIG. 18B shows a truth table for the XNOR logic gate 172 used in the eleventh energy backup circuit. The XNOR logic gate 172 is of conventional design, thus the inputs (SIG21 and SIG41) and the resulting output (SIG172) follow conventional logical rules associated with a conventional XNOR logic gate.

As previously stated, when load switch 22 and load switch 23 are associated with charging/discharging circuit 20A or charging/discharging circuit 20B, the load switch 22 and load switch 23 are always configured to have the converse switched state (i.e., when load switch 22 is switched ON, then load switch is switched OFF and vice versa). However, when load switch 22 and load switch 23 are both associated with either energy backup circuit 170A or energy backup circuit 170B or energy backup circuit 170C, the load switch 22 and load switch 23 are not always configured to have the converse switched state (i.e., circuit conditions may arise whereby load switch 22 and load switch 23 may both be switched ON at the same time, or, switched OFF at the same time). With reference to energy backup circuits 170A, 170B and 170C, when load switch 22 and load switch 23 are both be switched ON at the same time, the associated energy backup circuit may perform a discharging process (i.e. energy is transferred from the energy backup circuit 170A, 170B and 170C to N131).

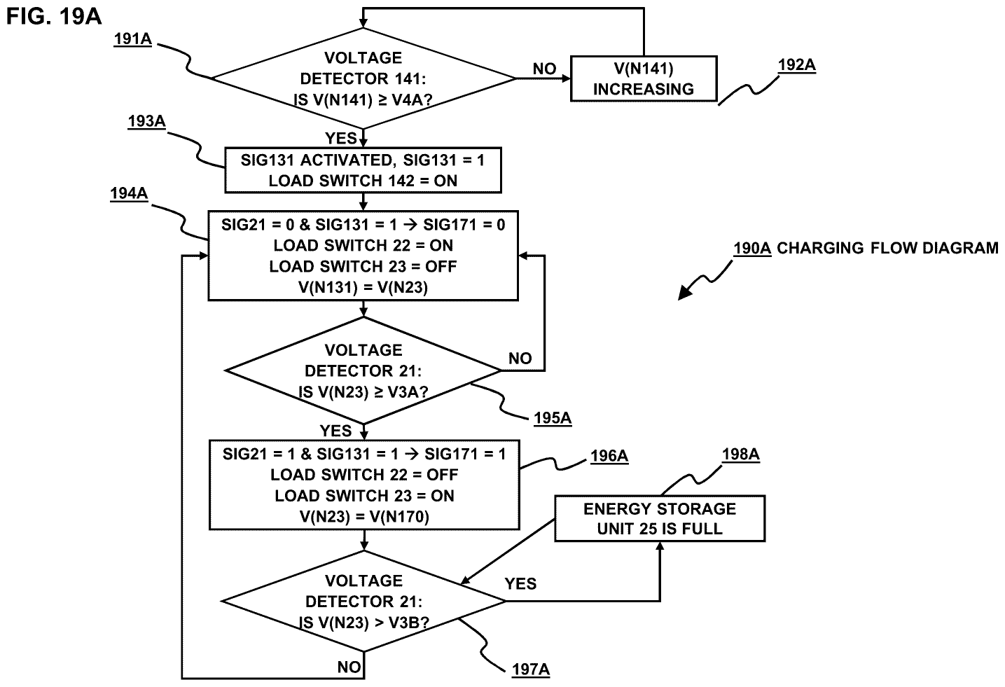

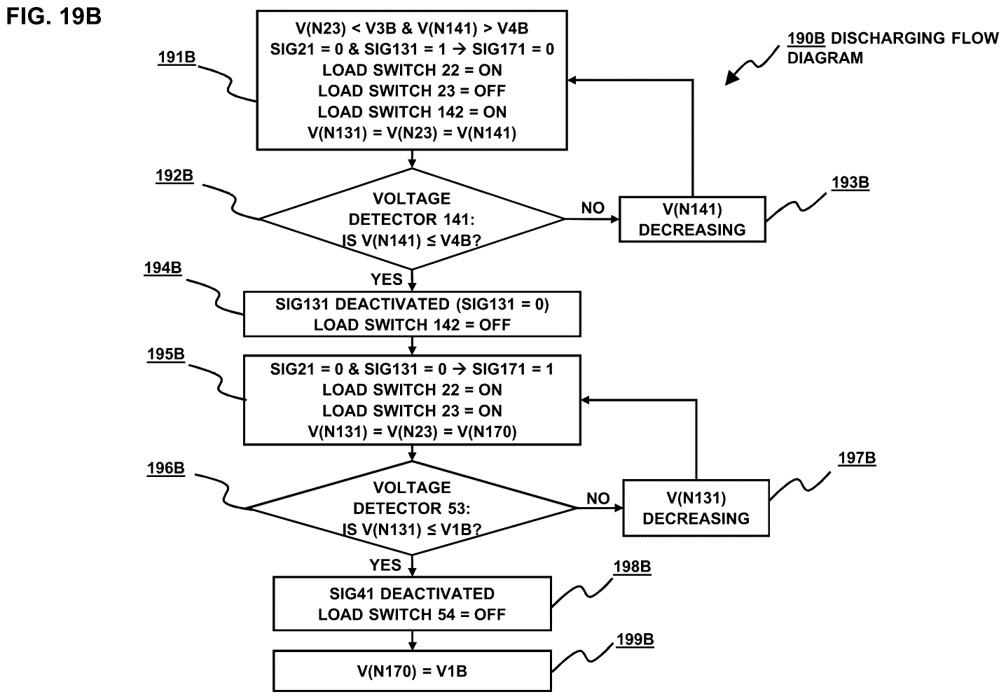

FIG. 19A is a flow diagram 190A of a charging process for the ninth example energy backup circuit 170A wherein said energy backup circuit 170A may be associated with example electronic device(s) disclosed here. In general, the voltage at N141 is assumed to be increasing with time during the charging process. Although there may be some small voltage decreases at N141 during the charging process, the overall trend is that the voltage at N141 is increasing with time. Flow diagram item 191A shows the voltage detector 141 measuring the voltage at N141; if the voltage at N141 is greater than or equal to V4A (i.e., V(N141)≥V4A) then flow diagram item 193A becomes active, otherwise flow diagram item 192A becomes active. Flow diagram item 192A shows the voltage at N141 increasing. Flow diagram 191A follows flow diagram item 192A. Flow diagram item 193A shows SIG 131 is activated and assigned the logic state of 1. Flow diagram item 193A also shows load switch 142 is switched ON. Flow diagram item 194A follows flow diagram item 193A. Flow diagram item 194A shows SIG21 is assigned the logic state of 0 and SIG131 is assigned the logic state of 1, therefore SIG171 is assigned the logic state of 0 (which is in accordance with the Truth Table for XNOR logic gate 171). Flow diagram item 194A also shows load switch 22 is switched ON and load switch 23 is switched OFF. Flow diagram item 194A also shows the voltage at N131 equal to the voltage at N23 (i.e., V(N131)=V(N23)). Flow diagram item 195A follows flow diagram item 194A. Flow diagram item 195A shows voltage detector 21 measuring the voltage at N23; if the voltage at N23 is greater than or equal to V3A (i.e., V(N23)≥V3A) then flow diagram item 196A becomes active otherwise flow diagram item 194A becomes active. Flow diagram item 196A shows SIG21 is assigned the logic state of 1 and SIG131 is assigned the logic state of 1, therefore SIG171 is assigned the logic state of 1 (which is in accordance with the Truth Table for XNOR logic gate 171). Flow diagram item 196A also shows load switch 22 is switched OFF and load switch 23 is switched ON. Flow diagram item 196A also shows the voltage at N23 equal to the voltage at N170 (i.e., V(N23)=V(N170)). Flow diagram item 197A follows flow diagram item 196A. Flow diagram item 197A shows voltage detector 21 measuring the voltage at N23; if the voltage at N23 is greater than V3B (i.e., V(N23)>V3B) then flow diagram item 198A becomes active otherwise flow diagram item 194A becomes active. Flow diagram item 198A shows that the energy storage unit 25 is full. Flow diagram item 197A follows flow diagram item 198A.

FIG. 19B is a flow diagram 190B of a discharging process for the ninth example energy backup circuit 170A wherein said energy backup circuit 170A may be associated with example electronic device(s) disclosed here. In general, the voltage at N141 is assumed to be decreasing with time during the discharging process. Although there may be some small voltage increases at N141 during the discharging process, the overall trend is that the voltage at N141 is decreasing with time. Flow diagram item 191B shows when the voltage at N23 is less than V3B and the voltage at N141 is greater than V4B then SIG21 is assigned the logic state 0 and SIG131 is assigned the logic state 1, therefore SIG171 is assigned the logic state of 0 (which is in accordance with the Truth Table for XNOR logic gate 171). Flow diagram item 191B also shows the load switch 22 is switched ON and the load switch 23 is switched OFF and the load switch 142 is switched ON (if applicable). Flow diagram item 191B also shows the voltage at N131, N23 and N141 are all equal (i.e., V(N131)=V(N23)=V(N141)). Flow diagram item 192B follows flow diagram item 191B. Flow diagram item 192B shows voltage detector 141 measuring the voltage at N141; if the voltage at N141 is less than or equal to V4B (i.e., V(N141)≤V4B) then flow diagram item 194B becomes active otherwise flow diagram item 193B becomes active. Flow diagram item 193B shows the voltage at N141 is decreasing (i.e., V(N141) DECREASING). Flow diagram item 191B follows flow diagram item 193B. Flow diagram item 194B shows SIG131 is deactivated and assigned the logic state of 0. Flow diagram item 194B also shows load switch 142 (if applicable) is switched OFF. Flow diagram item 195B follows flow diagram 194B. Flow diagram item 195B shows SIG21 is assigned the logic state 0 and SIG131 is assigned the logic state 0, therefore SIG171 is assigned the logic state of 1 (which is in accordance with the Truth Table for XNOR logic gate 171). Flow diagram item 195B also shows the load switch 22 is switched ON and the load switch 23 is switched ON. Flow diagram item 195B also shows the voltage at N131, N23 and N170 are all equal (i.e., V(N131)=V(N23)=V(N170)). Flow diagram item 196B follows flow diagram item 195B. Flow diagram item 196B shows voltage detector 53 (if applicable) measuring the voltage at N131; if the voltage at N131 is less than or equal to V1B (i.e., V(N131)≤V1) then flow diagram item 198B becomes active, otherwise flow diagram item 197B becomes active. If voltage detector 53 is not applicable, then flow diagram 190B terminates at flow diagram item 195B. Flow diagram item 197B shows the voltage at N131 is decreasing. Flow diagram item 195B follows flow diagram item 197B. Flow diagram item 198B shows SIG41 (if applicable) deactivated and load switch 54 (if applicable) is switched OFF. Flow diagram item 199B follows flow diagram item 198B. Flow diagram item 199B shows the voltage at N170 equal to V1B (i.e., V(N170)=V1B).

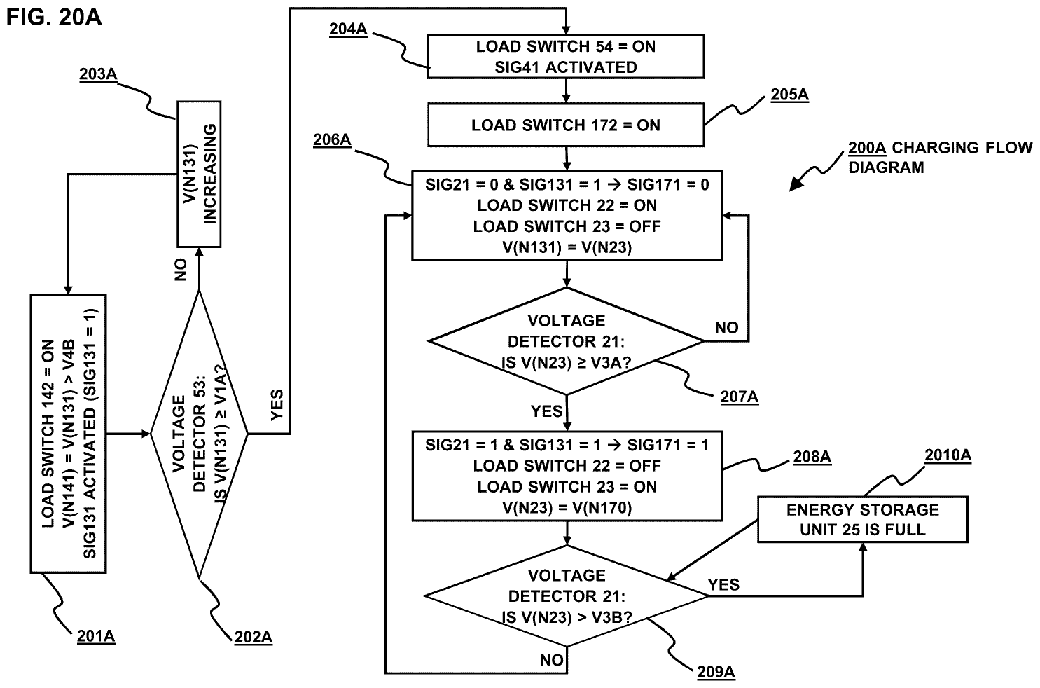

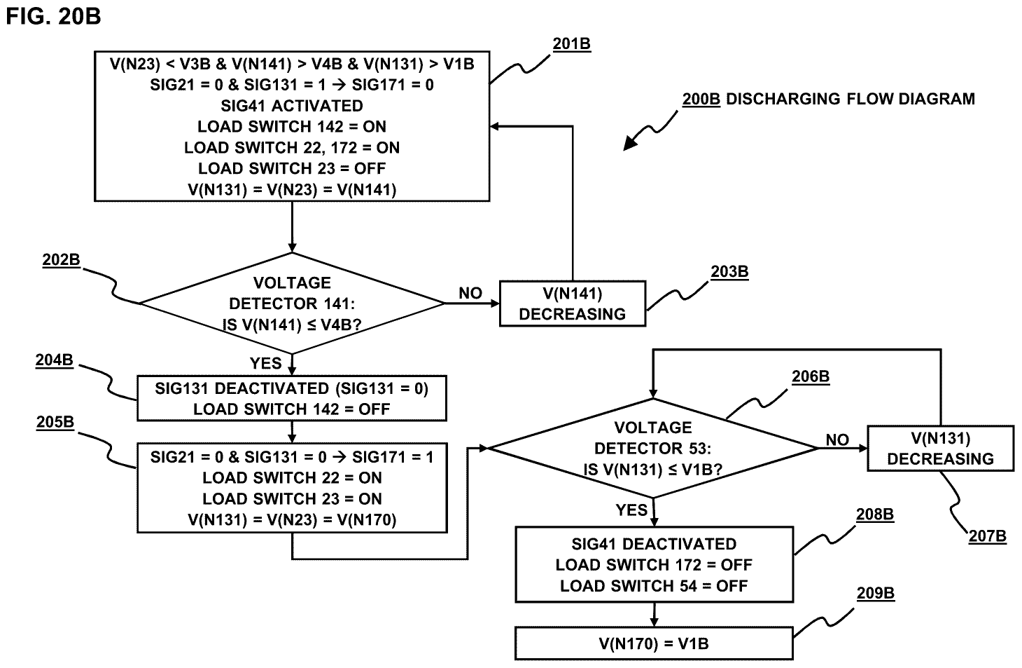

FIG. 20A is a flow diagram 200A of a charging process for the tenth example energy backup circuit 170B wherein said energy backup circuit 170B may be associated with example electronic device(s) disclosed here. In general, the voltage at N131 is assumed to be increasing with time during the charging process. Although there may be some small voltage decreases at N131 during the charging process, the overall trend is that the voltage at N131 is increasing with time. Flow diagram item 201A shows load switch 142 is switched ON. Flow diagram item 201A also shows the voltage at N141 is equal to the voltage at N131 which is greater than V4B (i.e., V(N141)=V(N131)>V4B). Flow diagram item 201A also shows SIG131 activated (i.e., SIG131 is assigned the logic state 1). Flow diagram item 202A follows flow diagram item 201A. Flow diagram item 202A shows voltage detector 53 measuring the voltage at N131; if the voltage at N131 is greater than or equal to V1A (i.e., V(N131)≥V1A) then flow diagram item 204A becomes active otherwise flow diagram item 203A becomes active. Flow diagram item 203A shows the voltage at N131 increasing. Flow diagram 201A follows flow diagram item 203A. Flow diagram item 204A shows the load switch 52 switched ON and SIG41 is activated. Flow diagram item 205A follows flow diagram item 204A. Flow diagram item 205A shows the load switch 172 is switched ON.

Flow diagram item 206A follows flow diagram item 205A. Flow diagram item 206A shows SIG21 is assigned the logic state of 0 and SIG131 is assigned the logic state of 1, therefore SIG171 is assigned the logic state of 0 (which is in accordance with the Truth Table for XNOR logic gate 171). Flow diagram item 206A also shows the load switch 22 is switched ON and the load switch 23 is switched OFF. Flow diagram item 206A also shows the voltage at N131 is equal to the voltage at N23 (i.e., V(N131)=V(N23)). Flow diagram item 207A follows flow diagram item 206A. Flow diagram item 207A shows the voltage detector 21 measuring the voltage at N23; if the voltage at N23 is greater than or equal to V3A (i.e., V(N23)≥V3A) then flow diagram item 208A becomes active otherwise flow diagram item 206A becomes active. Flow diagram item 208A shows SIG21 is assigned the logic state of 1 and SIG131 is assigned the logic state of 1, therefore SIG171 is assigned the logic state of 1 (which is in accordance with the Truth Table for XNOR logic gate 171). Flow diagram item 208A also shows the load switch 22 is switched OFF and the load switch 23 is switched ON.

Flow diagram item 208A also shows the voltage at N23 is equal to the voltage at N170 (i.e., V(N23)=V(N170)). Flow diagram item 209A follows flow diagram item 208A. Flow diagram item 209A shows voltage detector 21 measuring the voltage at N23; if the voltage at N23 is greater V3B (i.e.; V(N23)>V3B) then flow diagram item 2010A becomes active otherwise flow diagram item 206A becomes active. Flow diagram item 2010A shows the energy storage unit 25 is full. Flow diagram item 209A follows flow diagram item 2010A.

FIG. 20B is a flow diagram 200B of a discharging process for the tenth example energy backup circuit 170B wherein said energy backup circuit 170B may be associated with example electronic device(s) disclosed here. In general, the voltages at N141 and/or N131 are assumed to be decreasing with time during the discharging process. Although there may be some small voltage increases at N141 and/or N131 during the discharging process, the overall trend is that the voltages at N141 and/or N131 are decreasing with time. Flow diagram item 201B shows when the voltage at N23 is less than V3B (i.e., V(N23)<V3B) and the voltage at N141 is greater than V4B (i.e., V(N141)>V4B) and the voltage at N131 is greater than V1B (i.e., V(N131)>V1B) then SIG21 is assigned the logic state 0 and SIG131 is assigned the logic state 1, therefore SIG171 is assigned the logic state of 0 (which is in accordance with the Truth Table for XNOR logic gate 171). Flow diagram 201B also shows SIG41 is activated and the load switch 142 is switched ON and the load switch 22 is switched ON and the load switch 172 is switched ON and the load switch 23 is switched OFF. Flow diagram item 201B also shows that the voltage at N131, N23 and N141 are equal (i.e., V(N131)=V(N23)=V(N141). Flow diagram item 202B follows flow diagram item 201B.

Flow diagram item 202B shows the voltage detector 141 measuring the voltage at N141; if the voltage at N141 is less than or equal to V4B (i.e.; V(N141)≤V4B) then flow diagram item 204B becomes active otherwise flow diagram item 203B becomes active. Flow diagram item 203B shows the voltage at N141 is decreasing. Flow diagram item 201B follows flow diagram item 203B. Flow diagram item 204B shows SIG 131 is deactivated and assigned the logic state 0. Flow diagram item 204B also shows load switch 142 is switched OFF. Flow diagram item 205B follows flow diagram item 204B. Flow diagram item 205B shows SIG21 is assigned the logic state 0 and SIG131 is assigned the logic state 0, therefore SIG171 is assigned the logic state of 1 (which is in accordance with the Truth Table for XNOR logic gate 171). Flow diagram item 205B also shows load switch 22 is switched ON and load switch 23 is switched ON. Flow diagram item 205B also shows the voltages at N131, N23 and N170 are equal (i.e., V(N131)=V(N23)=V(N170)). Flow diagram item 206B follows flow diagram item 205B. Flow diagram item 206B shows the voltage detector 53 measuring the voltage at N131; if the voltage at N131 is less than or equal to V1B then flow diagram item 208B becomes active otherwise flow diagram item 207B becomes active. Flow diagram 207B shows the voltage at N131 decreasing. Flow diagram item 206B follows flow diagram 207B. Flow diagram item 208B shows SIG41 is deactivated and load switch 172 is switched OFF and load switch 54 is switched off. Flow diagram item 209B follows flow diagram item 208B. Flow diagram item 209B shows the voltage at N170 equal to the voltage V1B (i.e., V(N170)=V1B).

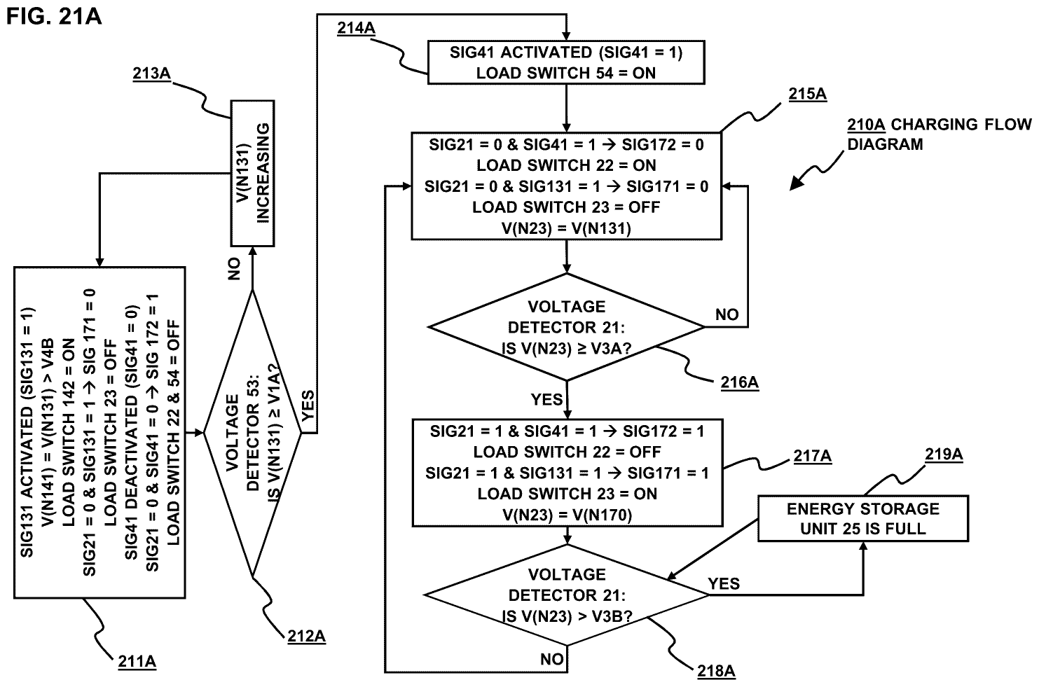

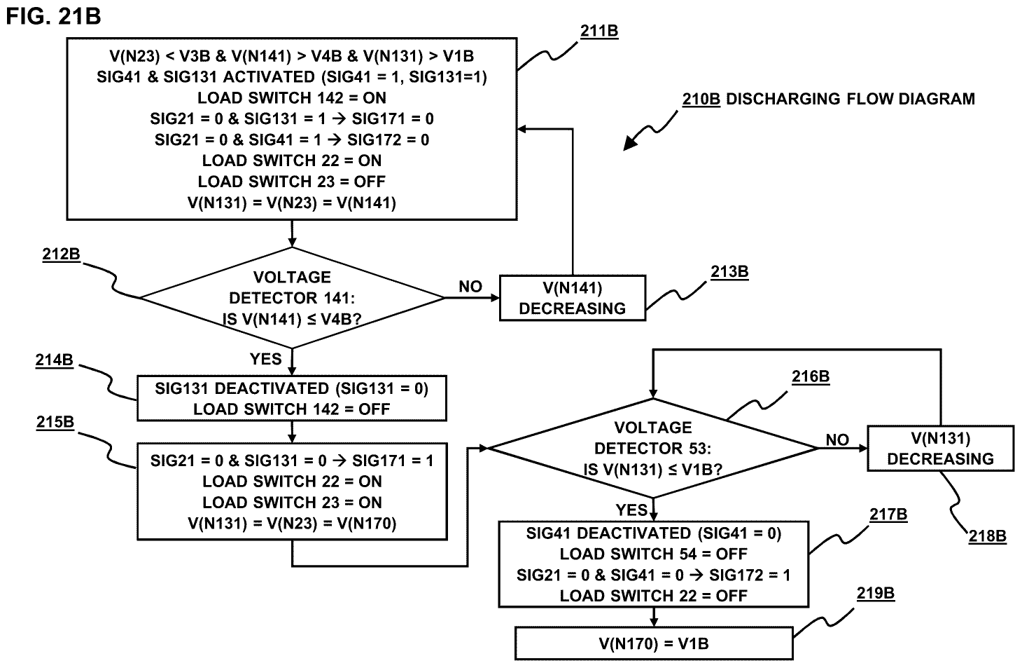

FIG. 21A is a flow diagram 210A of a charging process for the eleventh example energy backup circuit 170C wherein said energy backup circuit 170C may be associated with example electronic device(s) disclosed here. In general, the voltage at N131 is assumed to be increasing with time during the charging process. Although there may be some small voltage decreases at N131 during the charging process, the overall trend is that the voltage at N131 is increasing with time. Flow diagram item 211A shows SIG131 is activated (i.e., SIG131 is assigned the logic value 1). Flow diagram item 211A also shows that the voltage at N141 is equal to the voltage at N131 and that the voltage at both N141 and N131 is greater than the voltage V4B (i.e., V(N141)=V(N131)>V4B). Flow diagram item 211A also shows load switch 142 is switched ON. Flow diagram item 211A also shows SIG21 is assigned the logic state of 0 and SIG131 is assigned the logic state of 1, therefore SIG171 is assigned the logic state of 0 (which is in accordance with the Truth Table for XNOR logic gate 171). Flow diagram item 211A also shows load switch 23 is switched OFF. Flow diagram item 211A shows SIG41 is deactivated and assigned the logic value 0. Flow diagram item 211A also shows SIG21 is assigned the logic state of 0 and SIG41 is assigned the logic state of 0, therefore SIG172 is assigned the logic state of 1 (which is in accordance with the Truth Table for XNOR logic gate 172). Flow diagram item 211A also shows load switch 22 is switched OFF and load switch 54 is switched OFF. Flow diagram item 212A follows flow diagram item 211A. Flow diagram item 212A shows the voltage detector 53 measuring the voltage at N131; if the voltage at N131 is greater than or equal to V1A (i.e., V(N131)≥V1A) then flow diagram item 214A becomes active otherwise flow diagram item 213A becomes active. Flow diagram item 213A shows the voltage at N131 is increasing.

Flow diagram item 211A follows flow diagram item 213A. Flow diagram item 214A shows SIG41 is activated and assigned the logic value 1. Flow diagram 214A also shows load switch 54 is switched ON. Flow diagram item 215A follows flow diagram item 214A. Flow diagram 215A shows SIG21 is assigned the logic state of 0 and SIG41 is assigned the logic state of 1, therefore SIG172 is assigned the logic state of 0 (which is in accordance with the Truth Table for XNOR logic gate 172). Flow diagram 215A also shows load switch 22 is switched ON. Flow diagram 215A also shows SIG21 is assigned the logic state of 0 and SIG131 is assigned the logic state of 1, therefore SIG171 is assigned the logic state of 0 (which is in accordance with the Truth Table for XNOR logic gate 171). Flow diagram item 215A also shows that the voltage at N23 is equal to the voltage at N131 (i.e., V(N23)=V(N131)). Flow diagram item 216A follows flow diagram item 215A. Flow diagram item 216A shows voltage detector 21 measuring the voltage at N23; if the voltage at N23 is greater than or equal to V3A (i.e., V(N23)≥V3A) then flow diagram item 217A become active otherwise flow diagram item 215A become active. Flow diagram 217A shows SIG21 is assigned the logic state of 1 and SIG41 is assigned the logic state of 1, therefore SIG172 is assigned the logic state of 1 (which is in accordance with the Truth Table for XNOR logic gate 172). Flow diagram 217A also shows load switch 22 is switched OFF. Flow diagram 217A also shows SIG21 is assigned the logic state of 1 and SIG131 is assigned the logic state of 1, therefore SIG171 is assigned the logic state of 1 (which is in accordance with the Truth Table for XNOR logic gate 171). Flow diagram item 217A also shows that the voltage at N23 is equal to the voltage at N170 (i.e., V(N23)=V(N170)). Flow diagram item 218A follows flow diagram item 217A. Flow diagram item 218A shows the voltage detector 21 measuring the voltage at N23; if the voltage at N23 is greater than V3B (i.e., V(N23)>V3B) then flow diagram item 215A becomes active otherwise flow diagram item 219A becomes active. Flow diagram 219A shows that the energy storage unit 25 is full. Flow diagram item 218A follows flow diagram item 219A.

FIG. 21B is a flow diagram 210B of a discharging process for the eleventh example energy backup circuit 170C wherein said energy backup circuit 170C may be associated with example electronic device(s) disclosed here. In general, the voltage at N141 is assumed to be decreasing with time during the discharging process. Although there may be some small voltage increases at N141 during the charging process, the overall trend is that the voltage at N141 is decreasing with time. Flow diagram item 211B shows the voltage at N23 is less than V3B and that the voltage at N141 is greater than V4B and that the voltage at N131 is greater than V1B (i.e., V(N23)<V3B and V(N141)>V4B and V(N131)>V1B). Flow diagram item 211B also shows SIG41 and SIG131 are both activated and are both assigned the logic value 1. Flow diagram item 211B also shows load switch 142 is switched ON. Flow diagram item 211B also shows SIG21 is assigned the logic state of 0 and SIG131 is assigned the logic state of 1, therefore SIG171 is assigned the logic state of 0 (which is in accordance with the Truth Table for XNOR logic gate 171). Flow diagram item 211B also shows SIG21 is assigned the logic state of 0 and SIG41 is assigned the logic state of 1, therefore SIG172 is assigned the logic state of 0 (which is in accordance with the Truth Table for XNOR logic gate 172). Flow diagram item 211B also shows load switch 22 is switched ON and load switch 23 is switched OFF. Flow diagram 211B also shows the same voltage at N131, N23 and N141 (i.e., V(N131)=V(N23)=V(N141)). Flow diagram item 212B follows flow diagram item 211B. Flow diagram item 212B shows voltage detector 141 measuring the voltage at N141; if the voltage at N141 is less than or equal to V4B (i.e., V(N141)≤V4B) then flow diagram item 214B becomes active otherwise flow diagram item 213B becomes active. Flow diagram item 231B shows the voltage at N141 is decreasing.

Flow diagram item 211B follows diagram item 213B. Flow diagram item 214B shows SIG131 is deactivated and assigned the logic value of 0. Flow diagram item 214B also shows load switch 142 is switched OFF. Flow diagram items 215B follows flow diagram item 214B. Flow diagram item 215B shows SIG21 is assigned the logic state of 0 and SIG131 is assigned the logic state of 0, therefore SIG171 is assigned the logic state of 1 (which is in accordance with the Truth Table for XNOR logic gate 171). Flow diagram item 215B also shows load switch 22 is switched ON and load switch 23 is switched ON. Flow diagram 215B also shows the same voltage at N131, N23 and N170 (i.e., V(N131)=V(N23)=V(N170)). Flow diagram item 216B follows flow diagram item 215B. Flow diagram item 216B shows voltage detector 53 measuring the voltage at N131; if the voltage at N131 is less than or equal to V1B (i.e., V(N131)≤V1B) then flow diagram item 217B is activated otherwise flow diagram item 218B is activated. Flow diagram item 218B shows the voltage at N131 is decreasing. Flow diagram item 216B follows flow diagram 218B. Flow diagram item 217B shows SIG41 is deactivated and assigned the logic value of 0. Flow diagram item 217B also shows load switch 54 is switched OFF. Flow diagram item 217B also shows SIG21 is assigned the logic state of 0 and SIG41 is assigned the logic state of 0, therefore SIG172 is assigned the logic state of 1 (which is in accordance with the Truth Table for XNOR logic gate 172). Flow diagram item 217B also shows load switch 22 is switched OFF. Flow diagram 219B follows flow diagram item 217B. Flow diagram item 219B shows the voltage at N170 equal to V1B (i.e., V(N170)=V1B).

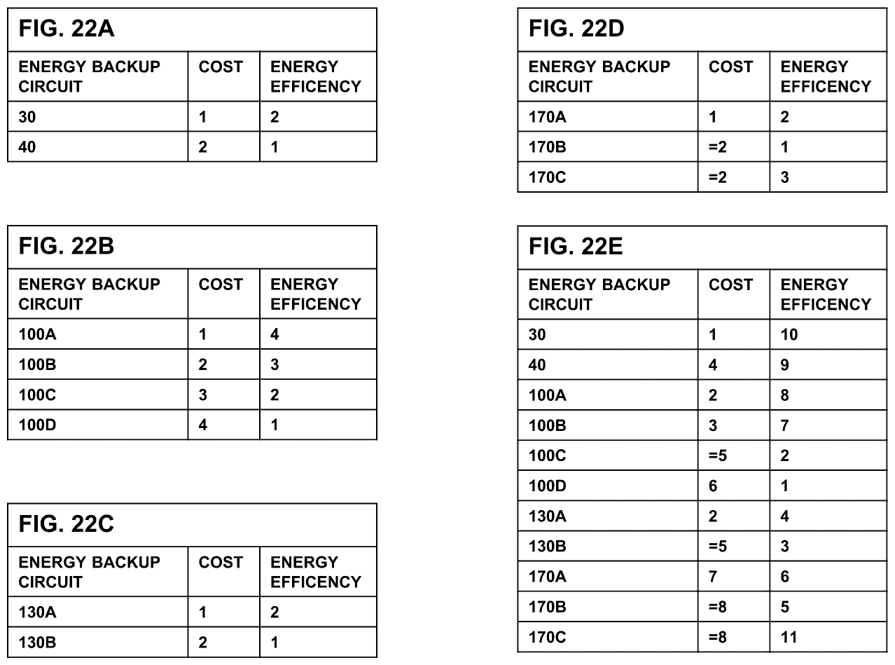

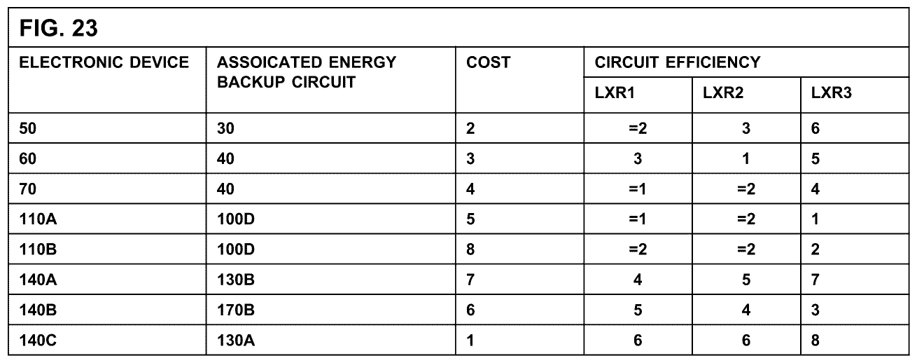

FIG. 22A through FIG. 22E and FIG. 23 illustrate various tables comparing relative characteristics (cost, energy efficiency and circuit efficiency) for energy backup circuits disclosed herein and electronic devices disclosed here. A score of “1” represents the best performance for a given characteristic. A score of “1” for cost represents the lowest cost (i.e., cheapest energy backup circuit or cheapest electronic device). A score of “1” for energy efficiency represents the best energy efficiency (i.e., the least amount of energy is wasted on non-useful work during the charging and discharging processes). A score of “1” for circuit efficiency represents the best circuit efficiency (i.e., the least amount of energy is wasted on non-useful work, so if the electronic device includes a wireless transmitter, an optimised transmission rate of data by the wireless transmitter may be realised).

FIG. 22A is a table comparing relative cost and energy efficiency of the energy backup circuit 30 and the energy backup circuit 40. Said energy efficiency relates to efficient energy storage and efficient delivery of stored energy to load(s) within an example electronic device disclosed herein (for example, the application load 55). Energy backup circuit 30 has the lowest cost (score=1→cheapest) while energy backup circuit 40 has the highest energy efficiency (score=1).

FIG. 22B is a table comparing relative cost and energy efficiency of the energy backup circuits 100A, 100B, 1000 and 100D. Energy backup circuit 100A has the lowest cost (score=1) while energy backup circuit 100D has the highest cost (score=4). Energy backup circuit 100A has the lowest energy efficiency (score=4) while energy backup circuit 100D has the highest energy efficiency (score=1).

FIG. 22C is a table comparing relative cost and energy efficiency of the energy backup circuits 130A and energy backup circuit 130B. Energy backup circuit 130A has the lowest cost (score=1) while energy backup circuit 130B has the highest energy efficiency (score=1).

FIG. 22D is a table comparing relative cost and energy efficiency of the energy backup circuit 170A, energy backup circuit 170B and energy backup circuit 170C. Energy backup circuit 170A has the lowest cost (score=1) while energy backup circuit 170B has the highest energy efficiency (score 1). Energy backup circuit 170B and energy backup circuit 170C have the same cost score of 2, and energy backup 170C has the lowest energy efficiency (score=3).

FIG. 22E is a table comparing relative cost and energy efficiency of the energy backup circuits 30, 40, 100A, 100B, 1000, 100D, 130A, 130B, 170A, 170B and 170C. Energy backup circuit 30 has the lowest cost (score=1) while energy backup circuit 170B and 170C have the highest cost (score=8). Energy backup circuits 1000 and 130B have the same cost score of =5. Energy backup circuit 170C has the lowest energy efficiency (score=11) while energy backup circuit 100D has the highest energy efficiency (score=1).

FIG. 22A to 22D inclusive illustrate a general trend that higher cost enables higher circuit efficiency. However, FIG. 22E illustrates that although energy backup circuit 100D has the highest energy efficiency, energy backup circuit 100D does not have the highest cost. Therefore, energy backup circuit 100D may have particularly good relative characteristics and therefore may be a preferred energy backup circuit.

FIG. 23 is a table comparing relative cost and circuit efficiency of the electronic devices 50, 60, 70, 110A, 110B, 140A, 140B and 140C in association with the energy backup circuits 30, 40, 40, 100D, 100D, 130B, 170B and 130A respectively. Circuit efficiency performance has been rated for the illumination range LXR1 (low illumination), LXR2 (medium illumination) and LXR3 (high illumination). Although some electronic devices disclosed herein may be associated with multiple energy backup circuits disclosed herein, for illustrative purposes in FIG. 23, each electronic device has been associated with just one energy backup circuit. The specific pairing of an electronic device with an associated energy backup circuit in FIG. 23 has been chosen because said pairing may enable relatively good performance characteristics and therefore said pairing may show a preferred configuration for an energy backup circuit. The electronic device 140C has the lowest cost (score=1) while the electronic device 110B has the highest cost (score=8). The electronic devices 70 and 110A both have the highest circuit efficiency (score=1) while the electronic device 140C has the lowest circuit efficiency (score=6) for LXR1 (low illumination). The electronic device 60 has the highest circuit efficiency (score=1) while the electronic device 140C has the lowest circuit efficiency (score=6) for LXR2 (medium illumination). The electronic device 110A has the highest circuit efficiency (score=1) while the electronic device 140C has the lowest circuit efficiency (score=8) for LXR3 (high illumination).

With reference to FIG. 23, the overall relative merit of the fourth example electronic device 110A used in conjunction with energy backup circuit 100D was found to be particularly good in terms of the combination of circuit efficiency and cost. In other words, the fourth example electronic device 110A used in conjunction with energy backup circuit 100D may not be the most expensive embodiment disclosed herein and may also enable more useful work to be performed by the harvested energy and have better circuit efficiency for the widest range of illumination conditions than other embodiments disclosed herein. Therefore, the fourth example electronic device 110A with associated energy backup circuit 100D may be a preferred configuration for an ultra-low power energy harvesting device with energy efficient backup circuit.

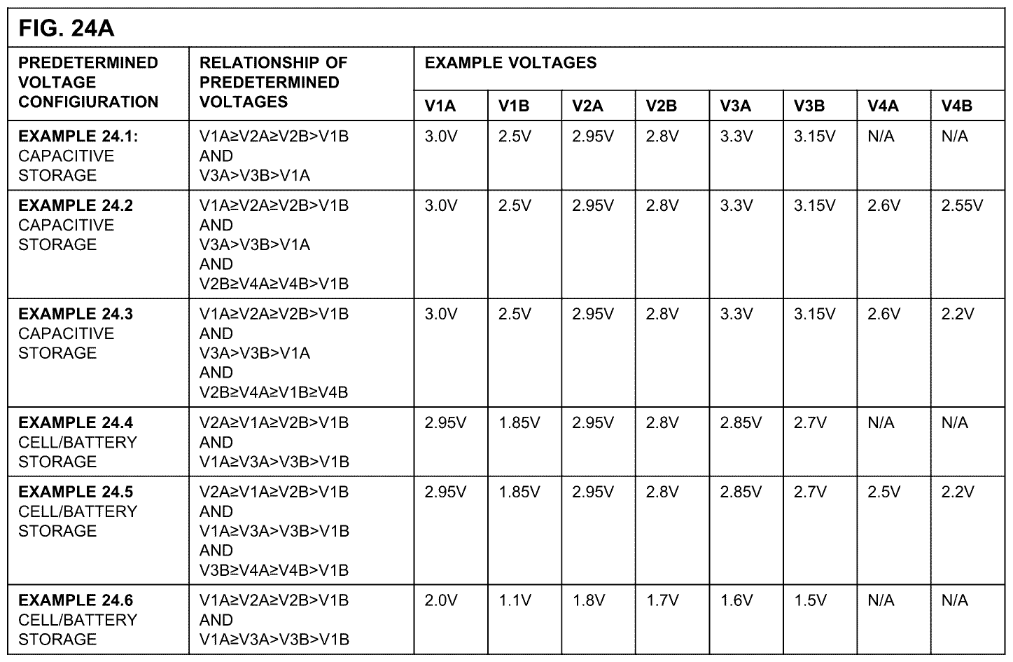

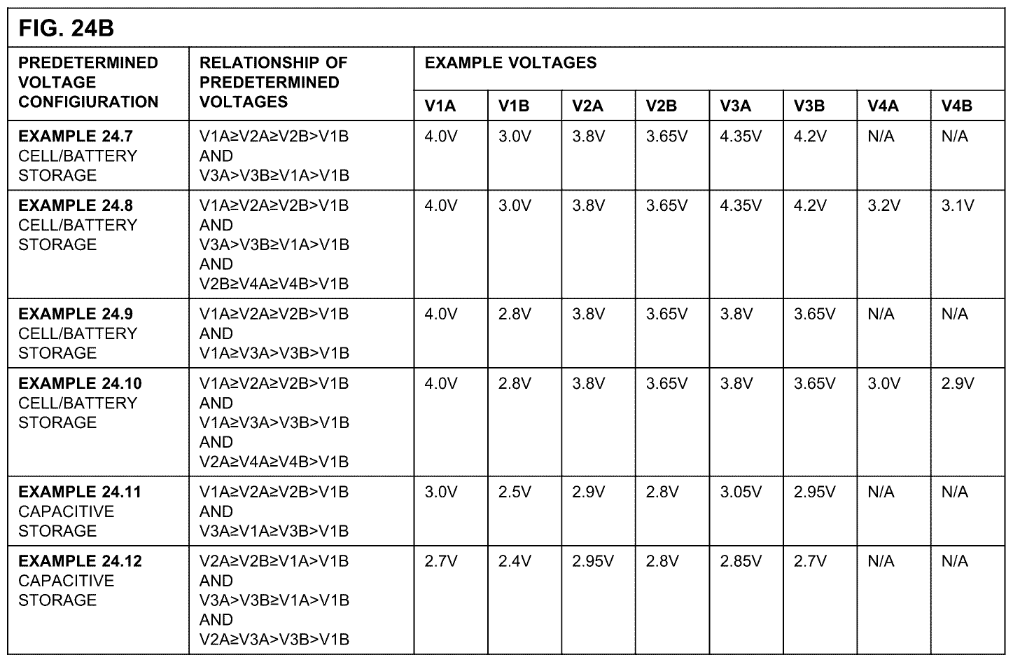

FIG. 24A is a table showing 6 examples of predetermined voltage configurations (Examples 24.1 through 24.6) that may be used to configure electronic devices disclosed herein. FIG. 24B is a table showing 6 further examples of predetermined voltage configurations (Examples 24.7 through 24.12) that may be used to configure electronic devices disclosed herein. Examples 24.1 through 24.12 show the relative relationships of the predetermined voltages V1A, V1B, V2A, V2B, V3A, V3B, V4A and V4B and example voltages for V1A, V1B, V2A, V2B, V3A, V3B, V4A and V4B. The energy storage unit 25 that is associated with embodiments disclosed herein may store energy via a capacitor and/or supercapacitor (i.e., capacitive storage). The energy storage unit 25 that is associated with embodiments disclosed herein may store energy via a cell and/or battery (i.e., cell/battery storage). The energy storage unit 25 that is associated with embodiments disclosed herein may store energy via any combination of capacitive storage and/or cell/battery storage. A variety of different capacitive and cell/battery devices are available for storing energy. It was found that energy efficiency and circuit efficiency for a given example of capacitive storage device or cell/battery storage could be optimised by using a predetermined voltage configuration as disclosed in FIGS. 24A and 24B. Examples 24.1 through 24.12 in combination with the disclosure below show that a variety of different components may comprise the energy storage unit 25 which in turn dictates different relationships for the predetermined voltages and different example voltages. Examples 24.1 through 24.12 also show different relationships for the predetermined voltages and different example voltages that may be required if a current regulator 28 is included in an associated electronic device as disclosed herein. If V3A is configured to be greater than V1A, then it may be preferable to exclude a current regulator 28 from the associated electronic device as disclosed herein. If V3A is configured to be less than V1A, then it may be preferable to include a current regulator 28 in the associated electronic device as disclosed herein.

In general, the example configurations in FIGS. 24A and 24B may optimise the power delivery and hence the useful work performed by the harvested energy for a given level of ambient illumination. In general, the example configurations in FIGS. 24A and 24B may optimise the circuit efficiency for a given level of ambient illumination. In general, the example configurations in FIGS. 24A and 24B may enable efficient storage of excess harvested energy. In general, the example configurations in FIGS. 24A and 24B may enable efficient delivery of energy stored in an energy backup circuit to an associated application load. In general, Examples 24.1 through 24.12 seek to achieve electronic devices that have beneficial features relating to energy efficiency and circuit efficiency.

Example 24.1 shows that an electronic device as disclosed herein may be configured to have a first voltage relationship of V1A≥V2A≥V2B>V1B and a second voltage relationship of V3A>V3B>V1A wherein the example voltages may be V1A=3.0V, V1B=2.5V, V2A=2.95V, V2B=2.8V, V3A=3.3V and V3B=3.15V. Electronic devices associated with Example 24.1 do not include the voltage detector 141 so no values for V4A and V4B are given in Example 24.1.

Example 24.2 shows that an electronic device as disclosed herein may be configured to have a first voltage relationship of V1A≥V2A≥V2B>V1B and a second voltage relationship of V3A>V3B>V1A and a third voltage relationship of V2B V4A V4B>V1B wherein the example voltages may be V1A=3.0V, V1B=2.5V, V2A=2.95V, V2B=2.8V, V3A=3.3V, V3B=3.15V, V4A=2.6V and V4B=2.55V.

Example 24.3 shows that an electronic device as disclosed herein may be configured to have a first voltage relationship of V1A≥V2A≥V2B>V1B and a second voltage relationship of V3A>V3B>V1A and a third voltage relationship of V2B V4A V1B V4B wherein the example voltages may be V1A=3.0V, V1B=2.5V, V2A=2.95V, V2B=2.8V, V3A=3.3V, V3B=3.15V, V4A=2.6V and V4B=2.2V.

Example 24.4 shows that an electronic device as disclosed herein may be configured to have a first voltage relationship of V2A V1A V2B>V1B and a second voltage relationship of V1A V3A>V3B>V1B wherein the example voltages may be V1A=2.95V, V1B=1.85V, V2A=2.95V, V2B=2.8V, V3A=2.85V and V3B=2.7V. Electronic devices associated with Example 24.4 do not include the voltage detector 141 so no values for V4A and V4B are given in Example 24.4.

Example 24.5 shows that an electronic device as disclosed herein may be configured to have a first voltage relationship of V2A V1A V2B>V1B and a second voltage relationship of V1A V3A>V3B>V1B and a third voltage relationship of V3B V4A V4B>V1B wherein the example voltages may be V1A=2.95V, V1B=1.85V, V2A=2.95V, V2B=2.8V, V3A=2.85V, V3B=2.7V, V4A=2.5V and V4B=2.2V.

Example 24.6 shows that an electronic device as disclosed herein may be configured to have a first voltage relationship of V1A≥V2A≥V2B>V1B and a second voltage relationship of V1A V3A>V3B>V1B wherein the example voltages may be V1A=2.0V, V1B=1.1V, V2A=1.8V, V2B=1.7V, V3A=1.6V and V3B=1.5V. Electronic devices associated with Example 24.6 do not include the voltage detector 141 so no values for V4A and V4B are given in Example 24.6.

Example 24.7 shows that an electronic device as disclosed herein may be configured to have a first voltage relationship of V1A≥V2A≥V2B>V1B and a second voltage relationship of V3A>V3B V1A>V1B wherein the example voltages may be V1A=4.0V, V1B=3.0V, V2A=3.8V, V2B=3.65V, V3A=4.35V and V3B=4.2V. Electronic devices associated with Example 24.7 do not include the voltage detector 141 so no values for V4A and V4B are given in Example 24.7.

Example 24.8 shows that an electronic device as disclosed herein may be configured to have a first voltage relationship of V1A≥V2A≥V2B>V1B and a second voltage relationship of V3A>V3B V1A>V1B and a third voltage relationship of V2B V4A V4B>V1B wherein the example voltages may be V1A=4.0V, V1B=3.0V, V2A=3.8V, V2B=3.65V, V3A=4.35V, V3B=4.2V, V4A=3.2V and V4B=3.1V.

Example 24.9 shows that an electronic device as disclosed herein may be configured to have a first voltage relationship of V1A≥V2A≥V2B>V1B and a second voltage relationship of V1A V3A>V3B>V1B wherein the example voltages may be V1A=4.0V, V1B=2.8V, V2A=3.8V, V2B=3.65V, V3A=3.8V and V3B=3.65V. Electronic devices associated with Example 24.9 do not include the voltage detector 141 so no values for V4A and V4B are given in Example 24.9.

Example 24.10 shows that an electronic device as disclosed herein may be configured to have a first voltage relationship of V1A≥V2A≥V2B>V1B and a second voltage relationship of V1A V3A>V3B>V1B and a third voltage relationship of V2A V4A V4B>V1B wherein the example voltages may be V1A=4.0V, V1B=2.8V, V2A=3.8V, V2B=3.65V, V3A=3.8V, V3B=3.65, V4A=3.0V and V4B=2.9V.

Example 24.11 shows that an electronic device as disclosed herein may be configured to have a first voltage relationship of V1A≥V2A≥V2B>V1B and a second voltage relationship of V3A V1A V3B>V1B wherein the example voltages may be V1A=3.0V, V1B=2.5V, V2A=2.9V, V2B=2.8V, V3A=3.05V and V3B=2.95V. Electronic devices associated with Example 24.11 do not include the voltage detector 141 so no values for V4A and V4B are given in Example 24.11.

Example 24.12 shows that an electronic device as disclosed herein may be configured to have a first voltage relationship of V2A V2B V1A>V1B and a second voltage relationship of V3A>V3B V1A>V1B and a third voltage relationship V2A V3A>V3B>V1B wherein the example voltages may be V1A=2.7V, V1B=2.4V, V2A=2.95V, V2B=2.8V, V3A=2.85V and V3B=2.7V. Electronic devices associated with Example 24.12 do not include the voltage detector 141 so no values for V4A and V4B are given in Example 24.12.

With reference to Example 24.1 through Example 24.12, the voltage values for V1A, V1B, V2A, V2B, V3A, V3B, V4A and V4B may be within 30%, and preferably within 15%, of the stated example voltage values providing that the associated predetermined voltage relationships are maintained for each Example 24.1 through Example 24.12.

The energy storage unit 25 associated with Example 24.1, Example 24.2 and Example 24.3 may comprise at least one capacitive storage device, such as a capacitor or a supercapacitor. It may be preferable that the energy storage unit 25 associated with Example 24.1, Example 24.2 and Example 24.3 is a capacitor. The storage capacity of the energy storage unit 25 associated with Example 24.1, Example 24.2 and Example 24.3 may be less than 100 mF. The Example 24.1 may be cheaper to implement than Example 24.2 and 24.3.

The energy storage unit 25 associated with Example 24.4 and Example 24.5 may comprise at least one cell or battery. In particular, it may be preferable that the energy storage unit 25 associated with Example 24.4 and Example 24.5 is a NiMH battery. It may be preferable to use the current regulator 28 in association with an electronic device that accords to Example 24.4 and Example 25.5.

The energy storage unit 25 associated with Example 24.6 may comprise at least one cell or battery. In particular, it may be preferable that the energy storage unit 25 associated with Example 24.6 is a Ni-Cd cell. It may be preferable to use the current regulator 28 in association with an electronic device that accords to Example 24.6.

The energy storage unit 25 associated with Example 24.7 and Example 24.8 may comprise at least one cell or battery. In particular, it may be preferable that the energy storage unit 25 associated with Example 24.7 and Example 24.8 is a Li-Po battery (Lithium Polymer battery).

The energy storage unit 25 associated with Example 24.9 and Example 24.10 may comprise at least one cell or battery. In particular, it may be preferable that the energy storage unit 25 associated with Example 24.9 and Example 24.10 is a LiFePO4 battery (Lithium iron phosphate battery). It may be preferable to use the current regulator 28 in association with an electronic device that accords to Example 24.9 or Example 24.10.

The energy storage unit 25 associated with Example 24.11 may comprise at least one capacitive storage device, such as a capacitor or a supercapacitor. In particular, it may be preferable that the energy storage unit 25 associated with Example 24.11 is a single cell supercapacitor.

The energy storage unit 25 associated with Example 24.12 may comprise at least one capacitive storage device, such as a capacitor or a supercapacitor. In particular, it may be preferable that the energy storage unit 25 associated with Example 24.12 is a double layer supercapacitor. The storage capacity of the energy storage unit 25 associated with Example 24.12 may be more than 100 mF. It may be preferable to use the current regulator 28 in association with an electronic device that accords to Example 24.12.

The electrical supply system disclosed herein, wherein the control circuitry is configured to disconnect the application load from an output of the electrical-energy storage system when a voltage at a point in the electrical supply system reaches or crosses a disconnection threshold from below, the disconnection threshold being indicative that the energy harvesting power supply source is generating sufficient power to fully power the application load.

The electrical supply system disclosed herein, wherein the control circuitry is configured to connect the application load to an output of the electrical-energy storage system and/or to disconnect the application load from the energy harvesting power supply source when a voltage at a point in the electrical supply system reaches or crosses a connection threshold from above, the connection threshold being indicative that the energy harvesting power supply source is not generating sufficient power to fully power the application load.

The electrical supply system disclosed herein, wherein the control circuitry is configured to connect the application load to the electrical supply system when a voltage at a point in the electrical supply system reaches or crosses a connection threshold from below, the connection threshold being indicative of a successful boot-up of the application load.

The electrical supply system disclosed herein, wherein the control circuitry is further configured to connect an input of the electrical-energy storage system to the electrical supply system and connect the electrical supply system to the application load, when the output voltage of the energy storage unit reaches or crosses a connection threshold from below.

1. An electrical-energy storage system for storing electrical energy received from an energy harvesting power supply source and for delivery of stored energy to an application load, the electrical-energy storage system comprising:
an input for receiving electrical energy from an energy harvesting power supply source;
a first electrical-energy storage unit having a first storage capacity;
a second electrical-energy storage unit having a second storage capacity, wherein the second storage capacity is greater than the first storage capacity;
an output for providing electrical energy from the second electrical-energy storage unit to an application load; and
control circuitry,
wherein the control circuitry is configured to:
determine when a first charging condition is met, and, in response to determining that the first charging condition is met, electrically couple the first electrical-energy storage unit to the input, with the first electrical-energy storage unit electrically decoupled from the second electrical-energy storage unit, for passing electrical energy from the input into the first electrical-energy storage unit; and
determine when a second charging condition is met, and, in response to determining that second charging condition is met, electrically couple the first electrical-energy storage unit to the second electrical-energy storage unit, with the first electrical-energy storage unit electrically decoupled from the input, for passing electrical energy from the first electrical-energy storage unit into the second electrical-energy storage unit.

2. The electrical-energy storage system of claim 1, wherein the first charging condition depends at least in part on a first voltage level at a first point within the electrical-energy storage system and/or the energy harvesting power supply source, and wherein the second charging condition depends at least in part on a second voltage level at a second point within the electrical-energy storage system and/or the energy harvesting power supply source, wherein the first and second points may be a common point or different points.

3. The electrical-energy storage system of claim 2, wherein each of the first and second voltage levels is an input voltage from an energy harvesting power supply source and/or is an output voltage of the first electrical-energy storage unit, and/or is a voltage at a respective point between an input from an energy harvesting power supply source and an output of the first electrical-energy storage unit, and/or is an input voltage to the second electrical-energy storage unit, and/or is a voltage at a respective point between an output of the first electrical-energy storage unit and an input to the second electrical-energy storage unit.

4. The electrical-energy storage system of claim 2, wherein the control circuitry comprises a voltage detector for determining the voltage level at the first point and/or the second point.

5. The electrical-energy storage system of claim 2, wherein the first charging condition comprises the first voltage having a value that is less than or equal to a first threshold, and wherein the second charging condition comprises the voltage at the second point having a value that is greater than or equal to a second threshold.

6. The electrical-energy storage system of claim 5, wherein the second threshold is higher than the first threshold.

7. The electrical-energy storage system of claim 1, wherein the control circuitry is configured to start detecting for the first charging condition after electrically coupling the first electrical-energy storage unit to the second electrical-energy storage unit.

8. The electrical-energy storage system of claim 1, wherein the control circuitry is configured to start detecting for the second charging condition after electrically coupling the first electrical-energy storage unit to the input.

9. The electrical-energy storage system of claim 5, wherein an output voltage level of the second electrical-energy storage unit being greater than the first threshold voltage is indicative of a charging of the second electrical-energy storage unit being complete.

10. The electrical-energy storage system of claim 1, wherein the control circuitry comprises one or more switches for performing the electrical coupling and decoupling of the first electrical-energy storage unit to the input and to the second electrical-energy storage unit.

11. The electrical-energy storage system of claim 1, wherein the control circuitry comprises a first switch between the input and first electrical-energy storage unit, and comprises a second switch between the first electrical-energy storage unit and the second electrical-energy storage unit, and wherein the control circuitry is configured so that, at least during a charging state of the electrical-energy storage system, the first switch and the second switch are always in opposite states.

12. The electrical-energy storage system of claim 11, wherein the electrical-energy storage system is switchable between a charging state in which the first switch is in a first state, being either open or closed, and the second switch is in an opposite state to the first switch, and a discharging state in which the first and second switches are both closed or in which the first switch is closed and the second switch is open.

13. The electrical-energy storage system of claim 1, wherein the first electrical-energy storage unit comprises at least one capacitor.

14. The electrical-energy storage system of claim 1, wherein the second electrical-energy storage unit comprises at least one of a capacitor, a supercapacitor, or a rechargeable cell.

15. The electrical-energy storage system of claim 1, comprising a DC-to-DC convertor between the first electrical-energy storage unit and the second electrical-energy storage unit.

16. The electrical-energy storage system of claim 15, wherein the control circuitry is configured to electrically decouple the DC-to-DC convertor from at least one of the first and second electrical-energy storage units in response to determining that the first charging condition is met.

17. The electrical-energy storage system of claim 1, wherein the input and the output of the electrical-energy storage system are provided by a shared conductor.

18. The electrical-energy storage system of claim 17, comprising an asymmetric conductance unit between an output of second electrical-energy storage unit and the shared conductor.

19. The electrical-energy storage system of claim 1, comprising an input isolation switch for decoupling the first electrical-energy storage unit and/or second electrical-energy storage unit from the input, and/or comprising an output isolation switch for decoupling the first electrical-energy storage unit and/or second electrical-energy storage unit from the output, wherein the first and second isolation switches may be a common switch or different switches.

20. The electrical-energy storage system of claim 1, comprising a resistor between the second electrical-energy storage unit and the output for controlling a discharge rate of the second electrical-energy storage unit through the output.

21. The electrical-energy storage system of claim 1, comprising a current regulator between a switch associated with the electrical-energy storage system and the energy harvesting power supply source wherein the current regulator is configured to control the rate that energy is received from the energy harvesting power supply source and/or configured to control the rate that energy is delivered from electrical-energy storage system to the application load.

22. An electrical supply system configured to supply electrical power to an application load wherein the electrical supply system comprises:
the electrical-energy storage system of claim 1 and the energy harvesting power supply source.

23. The electrical supply system of claim 22, wherein the energy harvesting power supply source comprises a photovoltaic unit.

24. The electrical supply system of claim 22, wherein the energy harvesting power supply source comprises an energy storage unit, a load switch and a voltage detector.

25. The electrical supply system of claim 22, comprising control circuitry configured to electrically couple and decouple the application load with an output of the energy harvesting power supply source and/or to electrically couple and decouple the application load with the electrical-energy storage system and/or to electrically couple and decouple an output of the energy harvesting power supply source with the electrical-energy storage system, at least partly in dependence upon a voltage at a point within the electrical supply system.

26. The electrical supply system of claim 25, wherein the control circuitry is configured to disconnect the application load from the electrical supply system when the voltage at the point reaches or crosses a disconnection threshold from above, the disconnection threshold being indicative of the second electrical-energy storage unit of the electrical-energy storage system reaching a discharged state.

27. The electrical supply system of claim 22, comprising control circuitry configured to switch the state of an electrical-energy storage system from one of a charging state, a null state and a discharging state to a different one of a charging state, a null state and a discharging state; wherein said state switching is at least partly dependent upon at least one of: a voltage at a point within the electrical supply system; an output of a timer; or an output of a light meter.

28. A method performed by an electrical-energy storage system to store electrical energy received from an energy harvesting power supply source and deliver stored electrical energy to an application load, wherein the electrical-energy storage system comprises an input for receiving energy from an energy harvesting power supply source, a first electrical-energy storage unit having a first storage capacity, a second electrical-energy storage unit having a second storage capacity that is larger than the first storage capacity, and control circuitry for performing electrical coupling and decoupling processes;
the method comprising:
determining when a first charging condition is met, and, in response to determining that the first charging condition is met, electrically coupling the first electrical-energy storage unit to the input, with the first electrical-energy storage unit electrically decoupled from the second electrical-energy storage unit, for passing electrical energy from the input into the first electrical-energy storage unit; and
determining when a second charging condition is met, and, in response to determining that second charging condition is met, electrically coupling the first electrical-energy storage unit to the second electrical-energy storage unit, with the first electrical-energy storage unit electrically decoupled from the input, for passing electrical energy from the first electrical-energy storage unit into the second electrical-energy storage unit.

29. The method of claim 28, wherein the electrical-energy storage system further comprises an output for delivering stored energy to the application load, the method further comprising:
determining when a discharging condition is met, and, in response to determining that the discharging condition is met, electrically coupling the first electrical-energy storage unit and/or second electrical-energy storage unit to the output for passing electrical energy from the electrical-energy storage system to the application load.
